(19) United States
(12) Patent Application Publication
(10) Pub. No.: US 2026/0026498 A1
(43) Pub. Date: Jan. 29, 2026

(54) AGGLOMERATE

(71) Applicant: BIOTALYS NV, Gent (BE)

(72) Inventors: Rudolph SCHNEIDER, Gent (BE); Huu Son NGUYEN, Gent (BE); Elias Willy Lucien VANDEPUTTE, Gent (BE); Felix Florenciano MONTESINOS, Gent (BE)

(21) Appl. No.: 19/144,088

(22) PCT Filed: Dec. 29, 2023
(86) PCT No.: PCT/EP2023/087990

§ 371 Date: Jun. 27, 2025

(30) Foreign Application Priority Data
Dec. 30, 2022 (EP) 22217341.1
Jul. 12, 2023 (EP) 23185042.1

(51) Int. Cl. A01N 25/14; A01N 63/23; A01N 63/50; A01P 1/00; A01P 7/04

(52) U.S. Cl. CPC A01N 25/14; A01N 63/23; A01N 63/50; A01P 1/00; A01P 7/04

(57) ABSTRACT

The invention relates to a method for producing agglomerates from an aqueous liquid composition. The agglomerates of this invention are suitable for application in agriculture as for example crop protection products. More specifically there are provided methods to produce agglomerates from an aqueous liquid composition wherein the aqueous liquid composition is derived from a microbial fermentation comprising dry matter containing a bioactive protein. The agglomerates prepared by the method of the invention contain a bioactive protein such as for example an immunoglobulin single variable domain. Also, the invention relates to a composition, an agrochemical composition and a process for preparing said agrochemical composition using the agglomerates of the invention. Finally, the invention relates to a method for protecting or treating a plant or a part of the plant from an infection or other biological interaction with a plant pathogen and where said method may be a post-harvest treatment method.

### FIELD OF THE INVENTION

The invention is situated in the field of agricultural formulations. More specifically, the invention relates to agricultural formulations comprising bioactive proteins. More specifically the invention relates to means and methods for the formation of spray dried powders and agglomerates containing bioactive proteins.

### BACKGROUND

Agricultural formulations are generally designed based on customer need and the physicochemical properties of the active ingredient(s). Liquid formulations are sometimes preferred over solid formulations by customers due to their ease of handling in measuring, pumping, diluting and spraying operations. However, liquid formulations come with drawbacks such as higher shipping costs, increased risk of liquid spills, and microbiological contamination problems. An alternative to liquid formulations are spray-dried powders. Spray drying can be executed for example in a fluid bed granulator such as described in Link et al (1997, Fluidized bed spray granulation: Investigation of the coating process on a single sphere. Chemical Engineering and Processing: Process Intensification, 36(6); 443-457). For the production of a solid formulation of liquid compositions containing a bioactive protein such as an immunoglobulin single variable domain or VHH many challenges can be expected in particular towards the stability of the bioactive protein during the drying process. To avoid the addition of heat, which is often detrimental for bioactive proteins, often lyophilization is opted, a process using freezing temperatures, often less detrimental to bioactive proteins, for example EP 3991745, WO 2011/017070, WO 2014/164301 and WO 2015/200027. The process of lyophilization also produces a very fine dry powder.

The use of powders comes with a drawback since the powders tend to form dust clouds when in use with potential health risks for the user. Furthermore, issues with successfully mixing and solubilizing fine powders can be expected. A solution therefore is the formation of larger particles with an increased surface area referred to as agglomerates. Agglomeration processes commonly require heat to evaporate the water content of a liquid composition inside a spray agglomeration apparatus. It was previously shown that immunoglobulin single variable domains can withstand temperature increases up to 56° C. in a lab-scale spray agglomeration apparatus. In this example, a solid carrier, mannitol, was introduced into the spray agglomeration apparatus in order to form the fluidized bed. The solid carrier also served as a support onto which a layer of the liquid composition containing an immunoglobulin single variable domain was applied during the spray agglomeration process and thus allowing the formation of larger particles and or agglomerates in a shorter period of time suitable for pharmaceutical use (described in WO2012130872).

There therefore exists a need to provide improved ways of preparing and formulating agricultural formulations into easy to handle and easily soluble agglomerates. The need specifically exists to develop an industrial scale process that is capable of producing agglomerates suitable for agricultural application.

### SUMMARY OF THE INVENTION

The inventors have developed a method of producing agglomerates from a liquid composition. More specifically, the inventors have developed a method for producing agglomerates from an aqueous liquid composition containing a bioactive protein, more precisely the bioactive protein may be an immunoglobulin single variable domain or VHH. The agglomerates made by the method of the invention are particularly suitable for agricultural use, they are highly soluble, have a high flowability and prevent the formation of dust during use. Importantly the method of producing agglomerates from an aqueous liquid composition maintains the activity of the bio-active protein and increases the shelf-life of the bio-active protein compared to the shelf-life of the liquid composition. Interestingly, the inventors have found a way of producing agglomerates directly from an aqueous liquid composition comprising a bioactive protein by spray drying without the necessity of introducing a solid carrier to facilitate the formation of larger particles and agglomerates. Furthermore, compared to processes developed in the pharmaceutical sector (such as described in WO2012130872) the current process allows for greatly improved processing volumes that are beneficial when producing agglomerates for agricultural use where high product volumes are required.

The methods described herein allow for the formation of agglomerates on a large scale from crude, unpurified aqueous liquid compositions derived from a microbial fermentation comprising dry matter containing a bioactive protein. Production of agglomerates from crude, unpurified compositions prevents a loss of yield associated with purification and reduces time and costs associated with the overall production.

The inventors have developed a method of producing agglomerates from an aqueous liquid composition. The method comprises the steps of spraying an aqueous liquid composition and concomitantly applying heat allowing water present in the aqueous liquid composition to evaporate which results in a spray-dried powder. The spray dried powder is then agitated and heated in a fluidized bed reactor forming a fluidized bed. The aqueous liquid composition is then sprayed onto the spray dried powder in the fluidized bed allowing for the formation of agglomerates from the spray-dried powder. The agglomerates may then be extracted, optionally during the agglomeration process. The aqueous liquid composition used for producing the agglomerates in this invention is derived from a microbial fermentation where the liquid composition comprises dry matter containing a bioactive protein. The fluidized bed may be initiated by introducing spray-dried powder at or before the spraying of the aqueous liquid composition is started. The fluidized bed may be initiated by introducing small or ground agglomerates at or before the spraying of the aqueous liquid composition is started.

The method of the current invention may operate at relatively high process temperatures, for instance the current invention process temperatures are considerably higher than process temperatures used in WO2012130872. Surprisingly in the present invention, said high temperatures even combined with long residence times in the spray drying and agglomeration apparatus, does not result in significant degradation of the bioactive protein. Without wanting to be bound to theory, it may be speculated that the presence of dry matter in the liquid composition may help to shield and protect the bioactive protein during spray drying and agglomeration. This is beneficial since by using higher process temperatures, significantly higher volumes of product can be processed in a reduced amount of time whilst still obtaining agglomerates with a specific beneficial size and shape as described herein further. This is highly beneficial in the production of large quantities of agglomerates required for use in agricultural.

Further provided are an agglomerate comprising a concentrated broth derived from a microbial fermentation containing dry matter in which a bioactive protein is contained.

Further provided are agglomerates obtainable by the methods disclosed herein.

Further provided are agglomerates produced by the methods disclosed herein.

Further provided is the use of the agglomerates according to this invention as a pest control product.

Further provided is an agrochemical composition comprising the agglomerates according to this invention dissolved in water, and optionally one or more tank mix additives.

Further provided is a process of preparing an agrochemical composition comprising the steps of adding agglomerates obtainable by or produced by the methods disclosed herein to a receptacle, such as a spray tank, containing water and optionally allowing the agglomerates to settle prior to mixing the agglomerates and the water by agitation and optionally adding one or more tank mix additives.

Further provided is a method for protecting or treating a plant or a part of the plant from an infection or other biological interaction with a plant pathogen, at least comprising the step of applying directly or indirectly to the plant or to a part of the plant the agglomerates of the present invention. The method may comprise applying directly or indirectly to the plant or to a part of the plant an agrochemical composition comprising agglomerates according to this invention, under conditions effective to protect or treat the plant or a part of the plant against the infection or biological interaction with the plant pathogen.

Further provided is a post-harvest treatment method for protecting or treating a harvested plant or a harvested part of the plant from an infection or other biological interaction with a plant pathogen, at least comprising the step of applying directly or indirectly to the harvested plant or to a harvested part of the plant the agglomerates of the present invention. The method may comprise applying directly or indirectly to the plant or to a part of the plant the agrochemical composition comprising agglomerates according to this invention under conditions effective to protect or treat the harvested plant or a harvested part of the plant against the infection or biological interaction with the plant pathogen.

### BRIEF DESCRIPTION OF THE DRAWINGS

FIG. 1: Example of raspberry shaped agglomerates.

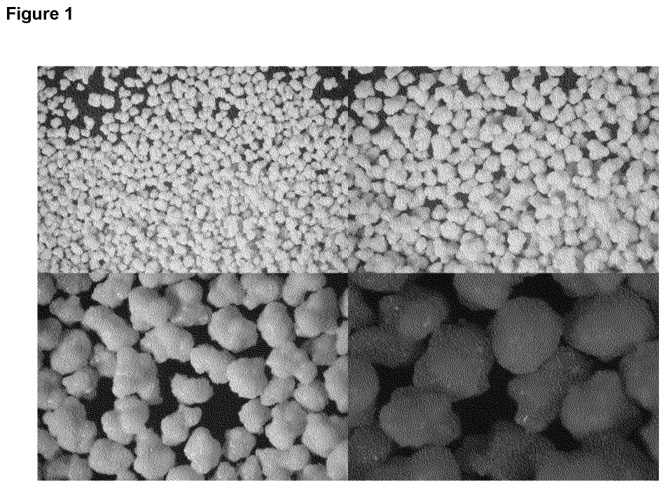

FIG. 2: Overlay chromatogram of a triplicate analysis of the agglomerates produced in Example 1. The analyzed component is the bioactive ingredient, a VHH-protein.

FIG. 3: Overlay chromatogram of a triplicate analysis of the agglomerates produced in Example 2. The analyzed component is the bioactive ingredient, a VHH-protein.

FIG. 4: Overlay chromatogram of a triplicate analysis of the agglomerates produced in the four runs in Example 3. The analyzed component is the bioactive ingredient, a VHH-protein. There is no clear distinction between the main peaks, showing no impact of the increase of temperature in the fluidized bed reactor.

FIG. 5: Overlay of chromatograms of the agglomerates samples analyzed in triplicate from example 4. There is no clear distinction between peaks, showing no impact of evaporation following fluidized bed reactor.

FIG. 6: Overlay of chromatograms of the agglomerates samples analyzed in triplicate from example 5. There is no clear distinction between peaks, showing no impact of evaporation following fluidized bed reactor.

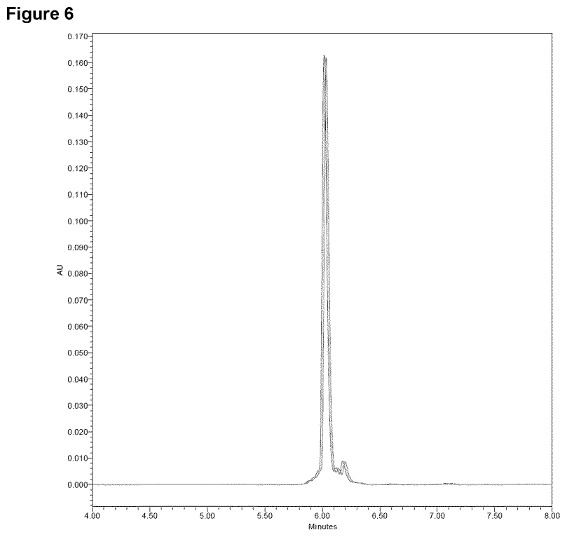

### DESCRIPTION OF THE SEQUENCE LISTING

| Name | SEQ ID | VHH Amino acid sequence |
|---|---|---|
| VHH-1 | 1 | DVQLVESGGGLVQAGGSLRLSCAASRSIFSINAMDWYRQAPGKQREWVAGITRGGTT |
| | | KYADSVKGRFTISRDNAKKKVYLQMNSLKPEDTAVYYCNVLRGEQPWTRDYWGQGTQ |
| | | VTVSS |
| VHH-1Q | 2 | QVQLVESGGGLVQAGGSLRLSCAASRSIFSINAMDWYRQAPGKQREWVAGITRGGTT |
| | | KYADSVKGRFTISRDNAKKKVYLQMNSLKPEDTAVYYCNVLRGEQPWTRDYWGQGTQ |
| | | VTVSS |
| VHH-1 | 3 | RSIFSINAMD |
| CDR1 | | |
| VHH-1 | 4 | GITRGGTTK |
| CDR2 | | |
| VHH-1 | 5 | LRGEQPWTRDY |
| CDR3 | | |
| VHH-2 | 6 | QVQLQESGGGLVQAGGSLRLSCAASGTIFRPTAMGWYRQAPGKERELVATITTGGSTK |
| | | YADSVKGRFTISRGNAKNTVYLQMSSLKPEDTAVYYCNAQWGVRTRDYWGQGTQVTV |
| | | SS |
| VHH-2 | 7 | GTIFRPTAMG |
| CDR1 | | |
| VHH-2 | 8 | TITTGGSTK |
| CDR2 | | |
| VHH-2 | 9 | QWGVRTRDY |
| CDR3 | | |
| VHH-3 | 10 | QVQLQESGGGLVQAGDSLRLSCAASISDRAFSRHVMGWFRQPPGKEREFVAAIGWTG |
| | | RRTYYADSVKGRFTISRDNAMNTVYLQMNSLKPEDTAVYYCAASHFYSVSFEINDYDY |
| | | WGQGTQVTVSS |
| VHH-3 | 11 | ISDRAFSRHV |
| CDR1 | | |
| VHH-3 | 12 | AIGWTGRRTY |
| CDR2 | | |
| VHH-3 | 13 | SHFYSVSFEINDYDY |
| CDR3 | | |
| VHH-2D | 14 | DVQLQESGGGLVQAGGSLRLSCAASGTIFRPTAMGWYRQAPGKERELVATITTGGSTK |
| | | YADSVKGRFTISRGNAKNTVYLQMSSLKPEDTAVYYCNAQWGVRTRDYWGQGTQVTV |
| | | SS |
| VHH-3D | 15 | DVQLQESGGGLVQAGDSLRLSCAASISDRAFSRHVMGWFRQPPGKEREFVAAIGWTG |
| | | RRTYYADSVKGRFTISRDNAMNTVYLQMNSLKPEDTAVYYCAASHFYSVSFEINDYDY |
| | | WGQGTQVTVSS |
| VHH-4 | 16 | QVQLQESGGGLVQAGGSLRLSCVASGTTFSSYTMGWYRQAPGKQRELLASIEGGGNTDYADSV |
| | | KGRFTISRDNARNTVYLQMNSLKTEDTAVYYCNAARTWSIFRNYWGQGTQVTVSS |
| VHH-5 | 17 | QVQLQESGGGLVQAGGSLRLSCAASGRTFSRYGMGWFRQLPGKQRELVTSITRGGTTTYADSV |
| | | KGRFTISRDNAKNTVYLQMNSLKPEDTAVYYCNARSIWRDYWGQGTQVTVSS |
| VHH-6 | 18 | QVQLQESGGGLVQAGGSLRLSCAASGGIFGINAMRWYRQAPGKQRELVASISSGGNTNYSESVK |
| | | GRFTISRDDANYTVYLQMNSLKPEDTAVYYCNFVRLWFPDYWGQGTQVTVSS |
| VHH-7 | 19 | QVQLQESGGGLVQPGGSLTLSCAATKTGFSINAMGWYRQAPGKQREMVATITSGGTTNYADSV |
| | | KGRFAISRDNAKNTVSLQMNTLKPEDTALYYCNTEARRYFTRASQVYWGQGTQVTVSS |
| VHH-8 | 20 | QVQLQESGGGLVQPGGSLRLSCAASGGIFSINAMGWYRQDPGKQREMVATITSGANTNYTDSVK |
| | | GRFTISRDNAKNTVYLQMNSLKPEDTAVYYCNAVGRRWYGGYVELWGQGTQVTVSS |
| VHH-9 | 21 | QVQLQESGGGLVQPGGSLRLSCAASGSIFSTYVMGWYRQAIGKQRELVATITSSGKTNYAASVK |
| | | GRFTVSRDITKNTMYLQMNSLKPEDTAVYYCGADRWVLTRWSNYWGQGTQVTVSS |
| VHH-10 | 22 | QVQLQESGGGLVQPGGSLRLSCAASGSISSLGWYRQAPGKQREFVASATSGGDTTYADSVKGR |
| | | FTISRDNSKNTVYLQMNSLKPEDTAVYYCKGQRGVAWTRKEYWGQGTQVTVSS |
| VHH-11 | 23 | QVQLQESGGGLVQPGGSLRLSCAASGSIFSTYAMGWYRQAIGKQRELVATITSSGKTNYAASVK |
| | | GRFTISRDITKNTMYLQMNSLKPEDTAVYYCGADRWVLTRWSNYWGQGTQVTVSS |
| VHH-12 | 24 | QVQLQESGGGLVQPGGSLRLSCTASGNIVNIRDMGWYRQVPGKQRELVATITSDQSTNYADSVK |
| | | GRFTTTRDNAKKTVYLQMDSLKPEDTAGYYCNARVRTVLRGWRDYWGQGTQVTVSS |
| VHH-13 | 25 | QVQLQESGGGLVQPGGSLRLSCAASGSIFSINAMGWYRQAPGKQRELVAAITSDGSTNYADSVK |
| | | GRFTISRDNAKNTAYLQMNSLKPEDTAVYYCNLRRRTFLKSSDYWGQGTQVTVSS |
| VHH-14 | 26 | QVQLQESGGGLVQAGDSLRLSCAASGRRFGSYAMGWFRQVPGKERELVAGISSGGSTKYADSV |
| | | RGRFTISRDNAKNTVSLQMKSLKPEDTAVYYCNAKYGRWTYTGRPEYDSWGQGTQVTVSS |
| VHH-15 | 27 | QVQLQESGGGLVQPGGSLRLSCAASGSIFSSDTMGWYRRAPGKQRELVAAITTGGNTNYADSVK |
| | | GRFTISRDNAKNTVYLQMNSLQPEDTAVYYCNCRRRWSRDFWGQGTQVTVSS |
| VHH-16 | 28 | QVQLQESGGGLVQPGGSLRLSCAASGTIFSIKTMGWYRQAPGKQRELVATISNGGSTNYADSVK |
| | | GRFTISRDNAKNTVYLQMNSLKPEDTAVYYCNARQQFIGAPYEYWGQGTQVTVSS |
| VHH-17 | 29 | QVQLQESGGGLVQAGGSLRLSCTASGAITFSLGTMGWYRQAPGKQRELVASISTGSTNYADSVK |
| | | GRFTISRDIIKNILYLQMNSLKPEDTAVYSCNARLLWSNYWGQGTQVTVSS |
| VHH-18 | 30 | QVQLQESGGGLVQAGESLRLSCAASGSTFSINVMGWYRQAPGEQRELVATISRGGSTNYADSVK |
| | | GRFTISRDNAKVTVYLQMDSLKPEDTAVYYCNAAGWVGVTNYWGQGTQVTVSS |
| VHH-19 | 31 | QVQLQESGGGLVQAGGSLRLSCAASGSTGSISAMGWYRQAPGKQRELVASITRRGSTNYADSV |
| | | KDRFTISRDNAWNTVYLQMNSLKPEDTAVYYCNARRYYTRNDYWGQGTQVTVSS |
| VHH-20 | 32 | QVQLQESGGGLGQAGGSLRLSCEVSGTTFSINTMGWHRQAPGKQRELVASISSGGWTNYADSV |
| | | KGRFTISRDNAKKTVYLQMNNLKPEDTAVYYCRWGAIGNWYGQGTQVTVSS |
| VHH-21 | 33 | QVQLQESGGGLVQPGGSLRLSCAASVRIFGLNAMGWYRQGPGKQRELVASITTGGSTNYAEPV |
| | | KGRFTISRDNANNTVYLQMNNLKPEDTAVYYCNAERRWGLPNYWGQGTQVTVSS |
| VHH-22 | 34 | QVQLQESGGGLVEAGGSLRLSCAASGRTFSRYGMGWFRQAPGKEREFVAANRWSGGSTYYAD |
| | | SVRGRFTISRDNAKNTVYLQMNSLKPEDTAVYYCAAYAHITAWGMRNDYEYDYWGQGTQVTVS |
| | | S |
| VHH-23 | 35 | QVQLQESGGGLVQAGGSLRLSCAATGRTFSRYTMGWFRQAPGKERDFVAGITWTGGSTDYADS |
| | | VKGRFTISRDNAKNTVYLQMNSLKPEDTAVYYCAAGNLLRLAGQLRRGYDSWGQGTQVTVSS |
| VHH-24 | 36 | QVQLQESGGGLVQAGGSLRLSCAASGRTGSRYAMGWFRQAPGKEREFVAAISWSGGSTYYAD |
| | | SVKDRFTISRDNAKNTVYLQMHSLKPEDTAVYYCATRNRAGPHYSRGYTAGQEYDYWGQGTQV |
| | | TVSS |
| VHH-25 | 37 | QVQLQESGGGLVQPGGSLRLSCAASGRIFSINAMGWYRQGPGKERELVVDMTSGGSINYADSV |
| | | SGRFTISRDNAKNTVYLQMNSLKPEDTAVYYCHANLRTAFWRNGNDYWGQGTQVTVSS |
| VHH-26 | 38 | QVQLQESGGGLVQPGGSLRLSCAASGSISSINAMGWYRQAPGKQRELVASITSGGSTNYADSVK |
| | | GRFTISRDNAKNTVNLQMNSLKPEDTAVYYCSAGPWYRRSWGRGTQVTVSS |
| VHH-27 | 39 | QVQLQESGGGLVQPGESLRLSCAASASIFWVNDMGWYRQAPGKQRELVAQITRRGSTNYADSV |
| | | KGRFTISRDNAKDEVYLQMNSLKPEDTAVYYCNADLAVRGRYWGQGTQVTVSS |
| VHH-28 | 40 | QVQLQESGGGLVQPGGSLRLSCAASGSFFPVNDMAWYRQALGNERELVANITRGGSTNYADSV |
| | | KGRFTISRDNAKNTVYLQMNTLKPEDTAVYYCNVRIGFGWTAKAYWGQGTQVTVSS |
| VHH-29 | 41 | QVQLQESGGGLVQPGGSLRLSCAASGGIFGINAMRWYRQAPGKQRELVASISSGGNTNYSESVK |
| | | GRFTISRDDANYTVYLQMNSLKPEDTAVYYCNFVRLWFPDYWGQGTQVTVSS |
| VHH-30 | 42 | QVQLQESGGGLVQPGGSLRLSCAASGSTIRINAMGWYRQAPGKQRELVATITRGGITNYADSVK |
| | | GRFTISRDNAKFTVYLQMNSLKPEDTAVYYCNARSWVGPEYWGQGTQVTVSS |
| VHH-31 | 43 | QVQLQESGGGLVQPGGSLRLSCAASGMTYSIHAMGWYRQAPGKERELVAITSTSGTTDYTDSVK |
| | | GRFTISRDGANNTVYLQMNSLKSEDTAVYYCHVKTRTWYNGKYDYWGQGTQVTVSS |
| VHH-32 | 44 | QVQLQESGGGLVQPGGSLRLSCTASGSIFSINPMGWYRQAPGKQRELVAAITSGGSTNYADYVK |
| | | GRFTISRDNAKNVVYLQMNSLKPEDTAVYYCNGRSTLWRRDYWGQGTQVTVSS |
| VHH-33 | 45 | QVQLQESGGGLVQPGGSLRLSCAASGSIFSINTMGWYRQAPGKQRELVAAITNRGSTNYADFVK |
| | | GRFTISRDNAKNTVYLQMNSLKPDDTAVYYCNAHRSWPRYDSWGQGTQVTVSS |
| VHH-34 | 46 | QVQLQESGGGLVQPGGSLRLSCAASGSIFSFNAMGWYRQAPGKQRELVAAITRGGSTNYADSV |
| | | KGRFTISRDNANNTVYLQMNSLKPEDTAVYYCNAESRIFRRYDYWGPGTQVTVSS |
| VHH-35 | 47 | QVQLQESGGGLVQPGGSLRLSCVTSGSIFGLNLMGWYRQAPGKQRELVATITRGGSTNYADSVK |
| | | GRFTISRDNAKKTVYLQMNSLKPEDTAVYYCNVDRGWSSYWGQGTQVTVSS |
| VHH-36 | 48 | QVQLQESGGGLVQPGGSLRLSCVTSGSIRSINTMGWYRQAPGNERELVATITSGGTTNYADSVK |
| | | NRFTISRDNAKNTVYLQMNSLKPEDTAVYYCNLHQRAWARSYVYWGQGTQVTVSS |
| VHH-37 | 49 | QVQLQESGGGSVQPGGSLRLSCAASGSIFAVNAMGWYRQAPGHQRELVAIISSNSTSNYADSVK |
| | | GRFTISRDNAKNTVYLQMNSLKPEDTAVYFCYAKRSWFSQEYWGQGTQVTVSS |
| VHH-38 | 50 | QVQLQESGGGLVQPGGSLRLSCAASGSIFSFNLMGWYRQAPGKQRELVAAITSSSNTNYADSVK |
| | | GRFTISRDNAKNTVYLQMNSLKPEDTAVYYCNAQYTITPWGIKKDYWGQGTQVTVSS |
| VHH-39 | 51 | QVQLQESGGGLMQPGGSLRLSCTASGNIVNIRDMGWYRQVPGKQRELVATITSDQSTNYADSVK |
| | | GRFTTTRDNAKKTVYLQMDSLKPEDTAGYYCNARVRTVLRGWRDYWGQGTQVTVSS |
| VHH-40 | 52 | QVQLQESGGGLVQPGESLRLSCVGSGSIFNINSMNWYRQASGKQRELVADMRSDGSTNYADSV |
| | | KGRFTISRDNARKTVYLQMNSLKPEDTAVYYCHANSIFRSRDYWGQGTQVTVSS |
| VHH-41 | 53 | QVQLQESGGGVVQAGDSLRLSCAASGRTFGGYTVAWFRQAPGKEREFVARISWSGIMAYYAES |
| | | VKGRFTISRDNAKNTVYLQMNSLKPEDTAVYYCASRSQIRSPWSSLDDYDRWGQGTQVTVSS |
| VHH-42 | 54 | QVQLQESGGGLVQPGGSLRLSCVVSGSISSMKAMGWHRQAPGKERELVAQITRGDSTNYADSV |
| | | KGRFTISRDNAKNTVYLQMNSLKPDDTGVYYCNADRFFGRDYWGKGTQVTVSS |
| VHH-43 | 55 | QVQLQESGGGLVQPGGSLRLSCAASRSILSISAMGWYRQGPGKQREPVATITSAGSSNYSDSVK |
| | | GRFTISRDNAKNTAYLQMNSLKPEDTAVYYCKTVYSRPLLGPLEVWGQGTQVTVSS |
| VHH-44 | 56 | QVQLQESGGGLVQTGGSLRLSCVASGSMFSSNAMAWYRQAPGKQRELVARILSGGSTNYADSV |
| | | KGRFTISRGNAKNTVYLQMNSLKPEDTAVYYCNAVRYLVNYWGQGTQVTVSS |
| VHH-45 | 57 | QVQLQESGGGSVQVGDSLTLSCVASGRSLDIYGMGWFRQAPGKEREFVARITSGGSTYYADSV |
| | | KGRFTLSRDNAKNTVYLQMNSLKPEDTAVYYCAAGVVVATSPKFYAYWGQGTQVTVSS |
| VHH-46 | 58 | QVQLQESGGGLVQAGGSLRLSCAASKRIFSTYTMGWFRQAPGKEREFVAAIIWSGGRTRYADSV |
| | | KGRFTISRDNARNTVHLQMNSLEPEDTAVYYCYTRRLGTGYWGQGTQVTVSS |
| VHH-47 | 59 | QVQLQESGGGLVQAGGSLRLSCAASGSTFSIQTIGWYRQAPGKQRDRVATISSGGSTNYADSVK |
| | | GRFTISRDNAKKTVYLQMNNLKPEDTAVYYCNLRYWFRDYWGQGTQVTVSS |
| VHH-48 | 60 | QVQLQESGGGLVQPGGSLRLSCAASGSTFSINVRGWYRQAPGKQRELVATITSDGSTNYADSVK |
| | | GRFTISRDNAKNTAYLQMNSLKPEDTAVYYCNAVRLFRQYWGQGTQVTVSS |
| VHH-49 | 61 | QVQLQESGGGLVQPGGSLRLSCAASGSIFRLNAMGWYRQAPGKQRELVAAITPGGGNTTYADS |
| | | VKGRFTISRDNALNTIYLQMNSLKPEDTAVYYCNAGGSSRWYSSRYYPGGYWGQGTQVTVSS |
| VHH-50 | 62 | QVQLQESGGGLVQAGGSLRLSCATSGGTFSRYAMGWFRQAPGKERELVATIRRSGSSTYYLDS |
| | | TKGRFTISRDNAKNTVYLQMNSLKLEDTAVYYCAADSSARALVGGPGNRWDYWGQGTQVTVSS |
| VHH-51 | 63 | QVQLQESGGGLVQPGGSLRLSCAASGSIGSINVMGWYRQYPGKQRELVAFITSGGITNYTDSVK |
| | | GRFAISRDNAQNTVYLQMNSLTPEDTAVYYCHLKNAKNVRPGYWGQGTQVTVSS |
| VHH-52 | 64 | QVQLQESGGGLVQPGGSLRLSCRASGGIFGINAMRWYRQAPGKQRELVASISSGGTTDYVESVK |
| | | GRFTISRDNATNTVDLQMSALKPEDTAVYYCNFVRFWFPDYWGQGTQVTVSS |
| VHH-53 | 65 | QVQLQESGGGLVQAGGSLRLSCAASGITFMSNTMGWYRQAPGKQRELVASISSGGSTNYADSV |
| | | KGRFTISRDNAKKTVYLQMNSLKPEDTAVYYCNARRNVFISSWGQGTQVTVSS |
| VHH-54 | 66 | QVQLQESGGGLVQPGGSLRLSCVASGSISVYGMGWYRQAPGKQRELVARITNIGTTNYADSVKG |
| | | RFTISRDNAKNTVYLQMNSLQPEDTAVYYCNLRRLGRDYWGQGTQVTVSS |
| VHH-55 | 67 | QVQLQESGGGLVQPGGSLRLSCAASRTALRLNSMGWYRQAPGSQRELVATITRGGTTNYADSV |
| | | KGRFTISREIGNNTVYLQMNSLEPEDTAVYYCNANFGILVGREYWGKGTQVTVSS |
| VHH-56 | 68 | QVQLQESGGGLVQAGGSLRLSCAVSGSIFSILSMAWYRQTPGKQRELVANITSVGSTNYADSVK |
| | | GRFTISRDIAKKTLYLQMNNLKPEDTAIYYCNTRMPFLGDSWGQGTQVTVSS |
| VHH-57 | 69 | QVQLQESGGGLVQAGGSLRLSCAVSAFSFSNRAVSWYRQAPGKSREWVASISGIRITTYTNSVK |
| | | GRFIISRDNAKKTVYLQMNDLRPEDTGVYRCYMNRYSGQGTQVTVSS |
| VHH-58 | 70 | QVQLQESGGGSVQPGGSLRLSCAASGTVFFSISAMGWYRQAPGKQRELVAGISRGGSTKYGDF |
| | | VKGRFTISRDNGKKTIWLQMNNLQPEDTAIYYCRLTSITGTYLWGQGTQVTVSS |
| VHH-59 | 71 | QVQLQESGGGLVQPGGSLRLSCAASGSIFSMKVMGWYRQGPGKLRELVAVITSGGRTNYAESV |
| | | KGRFTISRDNAKNTVSLQMNSLQPEDTAVYYCYYKTIRPYWGQGTQVTVSS |
| VHH-60 | 72 | QVQLQESGGGLVQAGGSLRLSCAASGITFRITTMGWYRQAPGKQRELVASSSSGGTTNYASSVK |
| | | GRFTISRDNAKNTVYLQMNSLRPEDTAVYYCNARKFITTPWSTDYWGQGTQVTVSS |
| VHH-61 | 73 | QVQLQESGGGLVQPGDSLRLSCTPSGSIFNHKATGWYRQAPGSQRELVAKITTGGTTNYADSVK |
| | | GRFTISRDNAKNTVYLQMSSLKPEDTAVYYCNAERYFATTLWGQGTQVTVSS |
| VHH-62 | 74 | QVQLQESGGGLVQAGGSLRLSCAASGITFSNNAGGWYRQAPGQQRELVARISSGGNTNYTDSV |
| | | KGRFTISRDITKNTLSLQMNNLKPEDSAVYYCNAQRRVILGPRNYWGQGTQVTVSS |
| VHH-63 | 75 | QVQLQESGGGLVQAGGSLRLSCAASGNIFRINDMGWYRQAPGNQRELVATITSANITNYADSVK |
| | | GRFTISRDNAKNTVYLQMNSLNPEDTAVYYCTAQAKKWRIGPWSDYWGQGTQVTVSS |
| VHH-64 | 76 | QVQLQESGGGLVQPGGSLRLSCAASGRIFSINDMAWYRQAPGKQRELVAIITNDDSTTYADSVKG |
| | | RFTISRDNAKNTVYLQMNSLKPEDTAVYYCNADINTAIWRRKYWGQGTQVTVSS |
| VHH-65 | 77 | QVQLQESGGGLVQSGGSLRLSCVHSKTTFTRNAMGWYRQALGKERELVATITSGGTTNYADSVK |
| | | GRFTISMDSAKNTVYLQMNSLKPEDTAVYYCNVNTRRIFGGTVREYWGQGTQVTVSS |
| VHH-66 | 78 | QVQLQESGGGLVQPGGSLRLSCAVSGSRIFIHDMGWHRQAPGEPRELVATITPFGRRNYSEYVK |
| | | GRFTVSRDIARNTMSLQMSNLKAEDTGMYYCNVRVNGVDYWGQGTQVTVSS |
| VHH-67 | 79 | QVQLQESGGGLVQAGGSLRLSCAISGITFRRPFGISRMGWYRQAPGKERELVATLSRAGTSRYV |
| | | DSVKGRFTISRDDAKNTLYLQMVSLNPEDTAVYYCYIAQLGTDYWGQGTQVTVSS |
| VHH-68 | 80 | QVQLQESGGGLVQAGGSLRLSCVASGITLRMYQVGWYRQAPGKQRELVAEISSRGTTMYADSV |
| | | KGRFTISRDGAKNIVYLQMNSLEPEDTAVYYCNARAFAFGRNSWGQGTQVTVSS |
| VHH-69 | 81 | QVQLQESGGGSVQAGGSLRLSCAVSGGTFSNKAMGWYRQSSGKQRALVARISTVGTAHYADSV |
| | | KGRFTVSKDNAGNTLYLQMNSLKPEDTAVYYCNAQAGRLYLRNYWGQGTQVTVSS |
| VHH-70 | 82 | QVQLQESGGGLVQPGESLRLSCVAAASTSITTFNTMAWYRQAPGKQRELVAQINNRDNTEYADS |
| | | VKGRFIISRGNAKNTSNLQMNDLKSEDTGIYYCNAKRWSWSTGFWGQGTQVTVSS |
| VHH-71 | 83 | QVQLQESGGGLVQAGGSLRLSCTASGLTFALGTMGWYRQAPGKQRELVASISTGSTNYADSVK |
| | | GRFTISRDIIKNILYLQMNSLKPEDTAVYSCNARLWWSNYWGQGTQVTVSS |
| VHH-72 | 84 | QVQLQESGGGLVQAGGSLRLSCTASGRTSSVNPMGWYRQAPGKQRELVAVISSDGSTNYADSV |
| | | KGRFTVSRDNAKNTLYLQMNSLKPEDTAVYYCNANRRWSWGSEYWGQGTQVTVSS |
| VHH-73 | 85 | QVQLQESGGGLVQAGGSLRLSCAASGITFTNNAGGWYRQAPGQQRELVARISSGGNTNYTDSV |
| | | KGRFTISRDITKNTLSLQMNNLKPEDSAVYYCNAQRRVILGPRNYWGQGTQVTVSS |
| VHH-74 | 86 | QVQLQESGGGLVQAGGSLRLSCEAPVSTFNINAMAWYRQAPGKSRELVARISSGGSTNYADSVK |
| | | GRFTISRDNAKNTVYLQMNSLKPEDTAVYICYVNRHWGWDYWGQGTQVTVSS |
| VHH-75 | 87 | QVQLQESGGGLVQPGGTLRLSCVASGSFRSINAMGWYRQAPGKQRELVATVDSGGYTNYADSV |
| | | KGRFTISRDNAKNTVYLQMSSLTPEDTAVYYCYAGIYKWPWSVDARDYWGQGTQVTVSS |
| VHH-76 | 88 | QVQLQESGGGLVQAGGSLRLSCAASGSSISMNSMGWYRQAPGKERERVALIRSSGGTYYADSV |
| | | KGRFTISRDNAKNTVYLQMNNLKPEDTAVYYCQARRTWLSSESWGQGTQVTVSS |
| VHH-77 | 89 | QVQLQESGGGLVQAGGSLRLSCAVSGSTFGINTMGWYRQAPEKQRELVASISRGGMTNYADSV |
| | | KGRFIISRDNAKNTVYLQMNSLKPEDTAVYVCNAGIRSRWYGGPITTYWGQGTQVTVSS |
| VHH-78 | 90 | QVQLQESGGGLVQAGGSLRLSCAASGSTGSINAMGWYRQGPGKQRDLVASISSGGATNYADSV |
| | | KGRFTISRDNSKNTVYLQMSSLKPEDTAVYYCNAKKSRWSWSIVHDYWGQGTQVTVSS |
| VHH-79 | 91 | QVQLQESGGGSVQTGGSLTLSCTTSGSIFGRSDMGWYRQAPGKQRELVATITRRSRTNYAEFVK |
| | | GRFTISRDSAKNLVTLQMNSLKPEDTNVYYCNARWGAGGIFSTWGQGTQVTVSS |
| VHH-80 | 92 | QVQLQESGGGLVQPGESLRLSCAASGSMSIDAMGWYRQAPGDQRELVASITTGGSTNYADSVK |
| | | GRFTISRDNAKNTVWLQMNSLKPEDTAVYYCNAKVRLRWFRPPSDYWGQGTQVTVSS |
| VHH-81 | 93 | QVQLQESGGGLVQPGGSLRLSCAASGRLLSISTMGWYRRTPEDQREMVASITKDGTTNYADSVK |
| | | GRLTISRDNAKNTVYLQMNSLKPDDTAVYVCNARATTWVPYRRDAEFWGQGTQVTVSS |
| VHH-82 | 94 | QVQLQESGGGLVQAGGSLRLSCAASGSIFGINDMGWYRQAPGKQRDLVADITRSGSTHYVDSVK |
| | | GRFTISRDNAKNTVYLQMNSLKPEDTAVYYCNADSGSHWWNRRDYWGQGTQVTVSS |
| VHH-83 | 95 | QVQLQESGGGLVQPGGSLKLSCAASGFTFSINTMGWYRQAPGKQRELVARISRLRVTNYADSVK |
| | | GRFTISRDNAKNTVYLQMNSLKPEDTAVYYCNAANWGLAGNEYWGQGTQVTVSS |
| VHH-84 | 96 | QVQLQESGGGLVQAGGSLRPSCTASGSTLLINSMGWYRQAPGKQRELVATISNSGTTNYVDAVK |
| | | GRFAISRDNANHTVYLQMNSLEPEDTAVYYCNAQTFWRRNYWGQGTQVTVSS |
| VHH-85 | 97 | QVQLQESGGGLVQAGGSLRLSCAVSGSTSRINAMGWYRQAPGKKRESVATIRRGGNTKYADSV |
| | | KGRFTISRDNANNTVYLQLNSLKPEDTAVYYCNAHSWLDYDYWGRGTQVTVSS |
| VHH-86 | 98 | QVQLQESGGGLVQAGGSLRLSCASRRRINGITMGWYRQAPGKQRELVATIDIHNSTKYADSVKG |
| | | RFIISRDNGKSMLYLQMNSLKPEDTAVYYCNRIPTFGRYWGQGTQVTVSS |
| VHH-87 | 99 | QVQLQESGGGLVQAGGSLRLSCVASGSTFYTFSTKNVGWYRQAPGKQRELVAQQRYDGSTNY |
| | | ADSLQGRFTISRDNAKRTVYLQMNSLKPEDTAVYICNVNRGFISYWGQGTQVTVSS |

### DETAILED DESCRIPTION OF THE INVENTION

Reference to any prior art in this specification is not, and should not be taken as, an acknowledgment or any form of suggestion that this prior art forms part of the common general knowledge in any country.

All documents cited in the present specification are hereby incorporated by reference in their entirety. Unless otherwise defined, all terms used in disclosing the invention, including technical and scientific terms, have the meaning as commonly understood by one of ordinary skill in the art to which this invention belongs.

The present invention will be described with respect to particular embodiments but the invention is not limited thereto but only by the claims. Any reference signs in the claims shall not be construed as limiting the scope.

Where the term “comprising” is used in the present description and claims, it does not exclude other elements or steps.

Where an indefinite or definite article is used when referring to a singular noun e.g. “a” or “an”, “the”, this includes a plural of that noun unless something else is specifically stated.

The term “about” as used herein when referring to a measurable value such as a parameter, an amount, a temporal duration, and the like, is meant to encompass variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier ‘about’ refers is itself also specifically, and preferably, disclosed.

The following terms or definitions are provided solely to aid in the understanding of the Invention. Unless specifically defined herein, all terms used herein have the same meaning as they would to one skilled in the art of the present invention.

The definitions provided herein should not be construed to have a scope less than understood by a person of ordinary skill in the art. Unless indicated otherwise, all methods, steps, techniques and manipulations that are not specifically described in detail can be performed and have been performed in a manner known per se, as will be clear to the skilled person. Reference is for example again made to the standard handbooks, to the general background art referred to above and to the further references cited therein.

The present invention provides a method for the formation of agglomerates from an aqueous liquid composition. The method of the invention comprises the steps of spraying an aqueous liquid composition and concomitantly applying heat to the sprayed aqueous liquid composition allowing the water present in the liquid composition to evaporate resulting in a spray dried powder. The spray-dried powder is then agitated and heated in a fluidized bed reactor to produce a fluidized bed. The term “spray agglomeration apparatus” as used herein may be used interchangeably with the term “fluidized bed reactor” or “fluid bed agglomerator”. In some embodiments the fluidized bed may be initiated by introducing spray dried powder derived from a previous spray run, derived from ground agglomerates, small agglomerates or agglomerates produced from the aqueous liquid composition. Importantly the spray dried powder used to optionally initiate the fluidized bed is composed of the same compounds as the aqueous liquid composition, i.e. no additional solid compounds or carriers having a composition different than the composition of the aqueous liquid compositions are added to the spray agglomeration apparatus. Ground agglomerates are formed by grinding agglomerates from a previous spray agglomeration run, for example agglomerates that were too large and were reduced in size by grinding. Small agglomerates are likewise derived from a previous spray agglomeration run and recovered during the separation of suitably sized agglomerates as too small. Small agglomerates may have a diameter of for example smaller than 200 μm. Agglomerates that were found too large may have a diameter of larger than for example 800 μm. In some embodiments the fluidized bed may be nucleated or initiated by introducing spray-dried powder in the spray agglomeration apparatus. This may be advantageous when no previous small or ground agglomerates are available. Introducing spray-dried powder into the fluidized bed reactor is a commonly used operating procedure and allows for a quicker buildup of the fluidized bed. In a more preferred embodiment no solid particles derived from previously spray dried or agglomerated material are added to initiate or buildup the fluidized bed. As used herein, the term “particles” refers to particles containing the same active ingredients and excipients as the liquid composition (e.g. spray dried particles produced from the liquid composition). As used herein “carriers” refers to another compound, not from the liquid composition. In this preferred embodiment, the fluidized bed is formed in a first stage of spray-drying to build up the fluidized bed. The first stage is followed by the stage of formation of agglomerates. It is understood that the first stage of spray-drying and the stage of formation of agglomerates in practice form a continuum and are essentially performed at the same time and in the same reactor of the spray agglomeration apparatus. Where, when starting from an empty fluidized bed reactor, initially spray-dried powder is formed, and is brought into a fluidized bed this may quickly progress to a stage of formation of agglomerates even though a higher percentage of spray-dried powder is still being formed. Likewise, during the agglomeration stage, some percentage of spray-dried powder may be formed as well. In a preferred embodiment the parameters for the spray-drying step and the agglomeration step are the same. In some embodiments the parameters are changed between the first stage of spray-drying to build up the fluidized bed and the spray agglomeration stage of formation of agglomerates. The fluidized bed comprising the spray dried powder is formed by agitation and heating the spray dried powder. The aqueous liquid composition is sprayed into the fluidized bed reactor allowing for the formation of agglomerates from the spray-dried powder. During this process smaller particles are gathered into larger permanent masses in which the original particles can still be identified as agglomerates. More specifically, agglomerates are formed when particles of spray-dried powder are contacted with a droplet of sprayed aqueous liquid composition allowing agglomerates to be formed when the particles contacted by droplets of sprayed aqueous liquid composition collide in the fluidized bed reactor. In addition, the droplet of sprayed aqueous liquid composition will spread over the surface of the particle of spray dried powder. When the remaining water evaporates, the solid compounds in the aqueous liquid composition are deposited onto the particle, increasing the particle in size. In some embodiments, the method of the invention leads to agglomerates with an irregular shape. In some embodiments, the method of the invention leads to agglomerates with a non-uniform shape. In some embodiments, the method of the invention leads to agglomerates with an aggregate drupelet shape. In some embodiments the agglomerates are shaped like a raspberry, or the agglomerates have a raspberry-like shape. The formation of raspberry-like particles occurs by the agglomeration of smaller particles. This occurs when smaller particles that were contacted with a droplet of sprayed liquid composition collide before the water present in the droplet of sprayed liquid composition has evaporated. This causes the particles to stick together, clump or agglomerate. The person skilled in the art will understand that in order to successfully form irregular shaped agglomerates, conditions need to be precisely set to achieve this. The skilled person will appreciate that many physical processes are at play during the formation of agglomerates.

### OBJECTIVES OF THE INVENTION

The object of this invention is to provide methods and compositions that promote and facilitate the formation of irregularly shaped agglomerates, for instance raspberry-like shaped agglomerates, as opposed to spherical or near spherical agglomerates or agglomerates with a relatively smooth surface. One advantage of irregularly shaped agglomerates, for instance raspberry-like shaped agglomerates, is the increased solubility and/or dissolution compared to spherical or near spherical agglomerates or agglomerates with a relatively smooth surface.

Another objective of this invention is to provide methods and composition that allow for the formulation of bioactive proteins into an agglomerate and as such increasing the shelf life of the bioactive protein as opposed to the shelf life of the bioactive protein in a liquid formulation.

Another objective of this invention is to provide methods and compositions that allow for the formulation of a bioactive protein into an agglomerate and as such lead to an enhanced user experience and the decreased formation of dust during use compared to the use of a powder.

Another objective of this invention is to provide methods and compositions that allow for the formulation of a bioactive protein at relatively high process temperatures allowing the processing of large amounts of liquid fermentation broth such that the process is suitable for production of agricultural formulations comprising bioactive proteins.

Another objective of this invention is to provide agglomerates comprising a bioactive protein that have an optimal wettability and/or solubility and/or dissolution.

### [Agglomeration Process]

For the agglomeration process, liquid composition is sprayed into a fluidized bed formed in a spray agglomeration apparatus. Spray agglomeration apparatuses used for spray agglomeration of a liquid composition are widely known. The spray may enter the apparatus from the bottom, the top, or any other suitable orientation. The term spray agglomeration apparatus used herein refers to set-ups that are capable of spray drying a liquid composition and preferably also maintaining a fluidized bed or fluid bed. A spray agglomeration apparatus suitable for this invention commonly comprises a vessel in which the processes here described can be executed. When referring herein to a vessel or the vessel, it is understood to indicate the vessel that is comprised in a spray agglomeration apparatus. The vessel as used herein may refer to the fluidized bed reactor. The parameters used in a spray agglomeration apparatus need to be carefully controlled. For example, the amount of liquid has to be properly controlled, as over-wetting may cause the agglomerates to be too hard and under-wetting may cause them to be too soft and friable. Thus, the amount of liquid and the rate of addition will influence the agglomeration process, as is widely known.

“Fluid bed” and “fluidized bed” are used synonymously. These terms describe a state wherein particulate solid matter is agitated to behave like a liquid. It can be achieved e.g. by a gas stream, which suspends the particulate solid matter. The gas stream is also referred to as “fluidization medium”. In fluidized beds, there is good thermal transport inside the fluidized bed and good heat transfer between the bed and its container. Fluidized beds promote high levels of contact between gases and solids. They are characterized by a very high interface area between fluidization medium and solid per unit bed volume, a high relative velocity between the fluidization medium and the dispersed solid phase, a high level of intermixing of the particulate phase, and frequent particle-particle and particle sidewall collisions.

An agglomeration process will comprise at least the steps of (a) spraying an aqueous liquid compositions comprising a bioactive protein and applying heat to evaporate the water, (b) the formation of a heated fluidized bed with the spray-dried liquid and (c) continuing the application of the liquid composition in conditions suitable for the formation of agglomerates. However, the process may optionally also comprise further steps, e.g. a pre-heating phase to bring the liquid composition feed to an appropriate temperature or pre-concentrating the liquid composition to increase the concentration of solids in the liquid composition. Thus, by increasing the amount of solids in the liquid composition, the amount of liquid in the form of water is reduced.

The agglomeration process described herein is a wet agglomeration process. The terms “agglomeration process”, “agglomeration”, “wet agglomeration process” or “wet agglomeration” are used herein interchangeably.

The agglomeration process can be continuous or discontinuous. In a discontinuous process, the fluidized bed reactor would need to be stopped to extract the agglomerates. A discontinuous process does not allow for the continual removal of agglomerates from the vessel during fluidization. A discontinuous process may be referred to as a “batch process”. In a continuous process, the agglomerates can be extracted without the need for stopping the fluidized bed reactor. A screw, such as a conveyor screw, allows for the continual removal of the agglomerates during the agglomeration process. In a continuous process, the agglomerates can be extracted from the fluidized bed reactor at the same time as spraying of the liquid composition. In a preferred embodiment a continuous process is used where agglomerates of a suitable size are extracted from the bottom of the spray agglomeration apparatus during the agglomeration process. Optionally, the agglomerates are continuously extracted from the spray agglomeration apparatus. Agglomerates of a suitable size can be extracted using for example an Archimedes screw located at the bottom of the vessel. Agglomerates of a suitable size will fall to the bottom of the vessel due to their size and weight. Alternatively, the agglomerates may be extracted using for example, a conveyer screw. The skilled person will know how to adjust the agitation parameters in order to capture the correct sized agglomerates at the bottom of the vessel.

In the preferred embodiment where the agglomeration process is continuous (i.e. agglomerates can be extracted without stopping the fluidized bed and/or spraying process), the steps of spraying the aqueous liquid composition into the fluidized bed reactor with a continuous extraction of preferably sized agglomerates by for example a conveyer screw or Archimedes screw are performed continuously. In preferred embodiments the agglomeration process is run continuously for over about 2 to 3 hours or longer. In more preferred embodiments, the agglomeration process is run continuously for over about 1 day or longer. In even more preferred embodiments, the agglomeration process is run for over a week. In even more preferred embodiments, the agglomeration process is run for over a month. In even more preferred embodiments, the process is run continuously for multiple months. The optimization of the process allows for a continuous flow of liquid composition into preferably sized agglomerates which is greatly advantageous in process where large quantities of product need to be prepared, such as for example where the product is a crop protection product. Where the agglomeration process is discontinuous, no extraction of agglomerates of a suitable size is performed. In such a process, the agglomeration process is stopped when sufficient amounts of suitable sized agglomerates are formed, and the agglomerates are removed from the spray agglomeration apparatus.

During a continuous agglomeration process the residence time of a single theoretical unit, such as the content of a single droplet sprayed into the vessel or a single bioactive protein, can be over 8 hours. The term “residence time” refers to the time-span between the time the liquid composition containing a single theoretical unit enters the fluidized bed until the agglomerate containing said theoretical unit has reached the required size and can be removed from the vessel. In some embodiments the residence time is 10 hours or less. In other preferred embodiments the residence time is 8 hours or less. In more preferred embodiments the residence time is 6 hours or less. In even more preferred embodiments, the residence time is 4 hours or less. In more preferred embodiments the residence time is 2 hours or less. In some set-ups the residence time can even decrease to less than 1 hour or even less than 30 minutes. The skilled person will know that a reduced residence time has the advantage of speeding up the process and potentially further improving the integrity of the bioactive protein in the agglomerates. However, a trade-off is presented between residence time and the time that is required to form the preferred sized agglomerates. The residence time will also depend on the characteristics of the liquid composition, for instance a high water content will require increased drying time for sufficient water to evaporate. The residence time will also vary according to the fluid bed temperature, with higher temperatures leading to faster evaporation and faster agglomeration times and thus decreased residence times. Furthermore, residence time can also be decreased by including multiple spray nozzles to spray the liquid compositions into the vessel. Examples of these are industrial size spray agglomeration apparatuses containing 2, 3, 4 or more spray nozzles in different orientation, increasing the throughput of liquid composition, and at the same time allowing for faster agglomeration and thus a reduced residence time. Obviously, the residence time is also influenced by the extraction rate of the agglomerates. The faster agglomerates are extracted, the lower the residence time.

In a discontinuous process, a separate phase of drying may ensue, following the formation and extraction of the agglomerates. In this case, no additional liquid is added to the reaction vessel where application of heat continues until a desired residual content of liquid is achieved. The drying phase may not be necessary, e.g. in case the liquid content is continuously kept below the desired level by adjusting the process parameters appropriately. In a discontinuous process, where the water content of the agglomerates is too high, an extra heating step can be applied at the end of the agglomeration process to ensure appropriate water content in the final product.

In the preferred continuous process, for example the preferred sized agglomerates extracted from the vessel could be subjected to an extra drying process in a further downstream dryer or oven if needed. In a preferred embodiment, the preferred sized agglomerates extracted from the vessel contain the preferred water content and do not require an additional drying step.

Process parameters that can be readily adjusted by the skilled person include the rate of adding the liquid, the form and intensity of applying heat, e.g. the volume and temperature of a heated gas streamed through the reaction vessel, the intensity and form of physical agitation, e.g. mixing or fluidizing by use of a gas stream, and the overall duration of the process. The skilled person can derive guidance on suitable process parameters from his common knowledge in agglomeration processes and will find additional guidance in the experimental section of this description. Heat can be applied by any means available to the skilled person, e.g. by heating the reaction vessel, by applying radiation such as microwaves, or by applying a heated gas stream. In a preferred embodiment the fluidized bed and the aqueous liquid composition are contacted with a heated gas stream, e.g. heated air, to evaporate the liquid. The skilled person knows many alternative gases that are compatible with the materials and active agents used in the process, including inert gases such as nitrogen or noble gases, and air. In one preferred embodiment the gas is air.

The form of agitation is not limited, and includes one or more of mixing, stirring, shaking, applying a gas stream, or combinations thereof. Such agitation can be applied by using a fluid bed apparatus, pan, drum and/or mixer granulators. Preferably, agitation is sustained during the entire agglomeration process. In principle the invention also encompasses low shear or, high shear granulation processes. Low shear granulation processes use very simple mixing equipment and can take considerable time to achieve a uniformly mixed state. High shear wet granulation processes use equipment that mixes the particulate solid feed and liquid at a very fast rate, and thus speeds up the manufacturing process. However, the amount of liquid that can be mixed with solid carriers in low or high shear granulation processes, without causing the solid carriers to dissolve or disintegrate, typically is limited.

In several embodiments of this invention heat is applied to the aqueous liquid composition. The prolonged exposure to heat in a liquid state under shear stress conditions has previously been considered unsuitable for producing solid bioactive protein formulations such as the agglomerates of this invention. Production of agglomerates using the methods described herein was expected to lead to loss of biological activity due to chemical and physical instability. It has been previously shown that an immunoglobulin single variable domain or VHH can remain stable up to a certain temperature of the fluid bed (up to 56° C.) and during relatively short processing times (see WO2012130872) in a coating/aggregation process where a liquid composition containing an immunoglobulin single variable domain or VHH is coated onto a solid carrier composed of mannitol.

In one embodiment, the temperature of the fluidized bed is kept at a temperature in the range of 40° C. and 100° C. In a preferred embodiment, the temperature of the fluidized bed is kept at a temperature in the range of 40° C. and 80° C. In a preferred embodiment, the temperature of the fluidized bed is kept at a temperature in the range of 45° C. and 75° C. In a preferred embodiment, the temperature of the fluidized bed is kept at a temperature in the range of 45° C. and 65° C. In a preferred embodiment, the temperature of the fluidized bed is kept at a temperature in the range of 50° C. and 70° C. In a preferred embodiment, the temperature of the fluidized bed is kept at a temperature in the range of 55° C. and 65° C. In a preferred embodiment, the temperature of the fluidized bed is kept at a temperature in the range of 58° C. and 63° C.

As would be apparent to the skilled person, the maximum temperature of the fluidized bed is also dictated by the melting temperature of the active ingredient. Where the active ingredient is a bioactive protein the melting temperature is the temperature at which 50% of the bioactive protein is unfolded. The activity of a bioactive protein may be negatively affected by unfolding. Unfolded bioactive protein is thus not desirable. Without wanting to be bound to theory, it being understood that the melting temperature can be different when the protein is in a purified form or when the bioactive protein is contained in a protective matrix, such as dry matter derived from a microbial fermentation product as described herein. That is to say, the presence of dry matter might lead to a protection of the protein of interest against unfolding under influence of temperature.

In one embodiment, the temperature of the heated gas stream immediately prior to entering the fluidized bed reactor is kept at a temperature in the range of 70° C. and 130° C. In a preferred embodiment the temperature of the heated gas stream immediately prior to entering the fluidized bed reactor is kept at a temperature in the range of 75° C. and 120° C. In a preferred embodiment the temperature of the heated gas stream immediately prior to entering the fluidized bed reactor is kept at a temperature in the range of 75° C. and 110° C. In a preferred embodiment the temperature of the heated gas stream immediately prior to entering the fluidized bed reactor is kept at a temperature in the range of 80° C. and 105° C. In a preferred embodiment the temperature of the heated gas stream immediately prior to entering the fluidized bed reactor is kept at a temperature in the range of 90° C. and 100° C. Alternatively, in some embodiments the heated gas stream is kept at a temperature of in the range of 100° C. and 110° C. immediately prior to entering the fluidized bed reactor. The skilled person will understand that in order to keep the temperature of the fluid bed at a certain desired temperature, the temperature of the heated gas stream can be adjusted. For example, when the spray rate is increased, the fluid bed temperature would cool down. This can be anticipated by increasing the temperature of the heated gas stream. The temperature of the heated gas stream is thus adapted as a function of the temperature of the fluidized bed.

The flow rate of the heated gas stream can vary strongly depending on the size of the vessel wherein the spray drying and agglomeration takes place. For example, a small pilot set-up may have a flowrate of heated gas of in the range of 45 and 60 m³/h. A larger vessel will need flow rates of up to 1200 m³/h. A fully industrial sized vessel for spray drying and agglomeration may have flow rates of heated gas of 5000 to 6000 m³/h or even higher. The skilled person will know that the larger the vessel, the larger the volume of liquid composition that is applied and thus the higher the flow rate of heated gas needed to maintain the fluidized bed and maintain a constant temperature in the fluidized bed, as well as to provide sufficient heated gas to evaporate water from the sprayed liquid composition.

The spray rate is understood to be the rate at which the liquid composition is passed through a spraying nozzle and enters the vessel. The spray rate is often provided as a measure of liters of liquid composition per hour. Alternatively the measurement is given in kg per hour or kg per minute. In one embodiment the spray rate is 1 l/h or more. In a preferred embodiment the spray rate is 2 l/h or more. In a preferred embodiment the spray rate is 3 l/h or more. In a preferred embodiment the spray rate is 4 l/h or more. In a preferred embodiment the spray rate is 5 l/h or more. In a preferred embodiment the spray rate is 6 l/h or more. In a preferred embodiment the spray rate is 7 l/h or more. In a preferred embodiment the spray rate is 8 l/h or more. In a preferred embodiment the spray rate is 9 l/h or more. In a preferred embodiment the spray rate is 10 l/h or more. In a preferred embodiment the spray rate is 11 l/h or more. In a preferred embodiment the spray rate is 12 l/h or more. In a preferred embodiment the spray rate is 13 l/h or more. In a preferred embodiment the spray rate is 14 l/h or more. In a more preferred embodiment, the spray rate is 15 l/h or more. In a preferred embodiment, the spray rate is in the range of 15 l/h and 24 l/h. In a more preferred embodiment, the spray rate is in the range of 20 l/h and 24 l/h. In an even more preferred embodiment, the spray rate is in the range of 22 l/h and 24 l/h. On an industrial scale the spray rate can be increased even further. In some embodiments the spray rate is 50 l/h or more. In a more preferred embodiment the spray rate is 100 l/h or more. In a most preferred embodiment, the spray rate is 150 l/h or more. These spray-rates can be achieved using one single nozzle but may achieved using a plurality of nozzles. For example, 2, 3, 4 or more spray nozzles can be used in different orientation in the vessel. The skilled person will know that adjusting the spray rate is one of the parameters of the agglomeration process that can influence the agglomeration process. Interestingly, the aqueous liquid composition of this invention is specifically suitable for the agglomeration process and high spray rates can be achieved while maintaining preferred agglomerate size and shape. Without being bound by theory, it is considered that the presence of dry matter stabilises the bioactive protein which allows the protein to withstand higher temperatures. At higher temperatures the liquid composition can be added at a higher rate because the drying rate increases thereby increasing the agglomerate production rate.

The term “spraying” or “sprayed” is the process of passing a liquid composition under pressure through a fine opening or nozzle. Many different nozzles and spray patterns exist, and the skilled person will be well aware of the combination of nozzles and pressures that are suitable for obtaining high spray rates while maintaining appropriately sized droplets. When a liquid composition is sprayed, the liquid jet is broken into very fine droplets. Sometimes referred to as “atomization” or “liquid atomization”. The size of the droplets will influence the speed at which the water evaporates from the aqueous liquid composition and will thus influence the agglomeration process. In a preferred embodiment the aqueous liquid composition is sprayed through a pressurized or pneumatic nozzle where along with the liquid composition gas is injected in the nozzle together with the liquid composition. Preferably, the gas is air. The air that is introduced is often referred to as atomization air and the pressure at which the atomization air is introduced into the nozzle system is the atomization pressure. In one embodiment the atomization pressure is in the range of 1 and 5 bar. In general, higher atomization pressures may lead to smaller sized droplets. Since, smaller droplets dry more quickly, in some embodiments an initial high pressure is used to accelerate the formation of a fluidized bed, after which the atomization pressure can be reduced. The skilled person will know what the suitable air pressure is for a specific type of nozzle at a specific spray rate. The manufacturer's instructions for the specific nozzle will also guide the skilled person. In a preferred embodiment a pneumatic nozzle is used to spray the aqueous liquid composition such as for example a binary nozzle. Pneumatic nozzles lead to the formation of very small droplets. This process is known as pneumatic atomization. For example, droplets of approximately 20 μm can be formed using pneumatic atomization.

The inventors have developed a method for obtaining irregularly shaped agglomerates, for instance non-uniform agglomerates, or raspberry-like shaped agglomerates. The agglomerates may also be an aggregated drupelet shape. The inventors have found that optimizing the rate at which water evaporates from the sprayed liquid composition may have an important impact on the optimization of the formation of irregularly shaped agglomerates. Evaporation of water may be controlled by the process temperature, with higher temperatures increasing the evaporation rate of water. Additionally, increasing the flux of gas, for instance air, may also increase the evaporation rate of water.

The inventors have developed a process which allows for the formation irregularly shaped agglomerates from an aqueous liquid composition comprising bioactive proteins such as an immunoglobulin single variable domains or VHH. The process may be used to produce agglomerates from an aqueous liquid composition comprising bioactive protein such as an immunoglobulin single variable domain or VHH on a large scale, for instance a scale suitable for an agricultural setting and applying said agglomerates in an agricultural setting.

The inventors have found that by increasing the temperature of the fluid bed in the spray drying process, as well as the gas flow, the flux of liquid composition comprising bioactive protein such as immunoglobulin single variable domains or VHH can be increased compared to the processes described in the prior art, without losing functionality nor physical or chemical stability of the bioactive protein. Furthermore, it was found that by increasing the temperature, a more irregular shaped agglomerate could be formed.

An alternative method to control the evaporation of water from the sprayed liquid composition may be to introduce specific compounds to the liquid composition to alter the properties of the water and change the rate at which water evaporates. The additional compound may increase or decrease the rate of evaporation.

### [Liquid Composition of the Invention]

The liquid composition fed into the vessel for spray drying and agglomeration comprises (i) a microbial fermentation broth derived from a microbial fermentation reaction, where the broth contains dry matter in which the bioactive protein is contained and optionally (ii) co-formulants such as, but not limited thereto, surfactants, filler agents, antifoams, preservatives, buffering agents, anti-caking agents and/or stickers. The totality of dry matter derived from a fermentation reaction and additional compounds that may be added to the liquid composition constitute the solid material that will remain after the water from the liquid composition is removed. In fact, the dry matter derived from the microbial fermentation will provide a significant portion of the solid material that builds up the agglomerates of this invention.

The term “liquid composition” and “aqueous liquid composition” are used herein interchangeably.

In a preferred embodiment the dry matter present in the aqueous liquid composition comprises a bioactive protein. In a preferred embodiment the bioactive protein is an immunoglobulin single variable domain or VHH. Bioactive proteins contribute to or are responsible for the biological effects of the formulation, e.g. pesticidal effects in an agricultural composition. Bioactive proteins are distinct from auxiliary compounds, fillers, humectants, buffering agents, etc., which do not necessarily have biological effects themselves. The invention, however, does not exclude the presence of further agents having biological effects in their own right. At the same time, formulations which comprise more than one active agent, which may or may not be a bioactive protein, are also encompassed by the invention. Such combinations of active agents, however, always comprise at least one active agent comprising or consisting of a bioactive protein.

Bioactive proteins may have the effect of actively killing microbial organisms such as bacteria or fungi. Additionally bioactive proteins may have the effect of actively killing insects. In some instances, the effect of the bioactive protein is that it inhibits or stops the growth of the microbial organism or insect. In some instance the bioactive protein can inhibit essential communication systems and in so doing disrupt the successful propagation of microbial organisms or insects. Examples of the latter would be inhibition of quorum sensing in bacteria or pheromone signaling in insects. In other examples the bioactive protein can prevent the microbial organism or insect to exert its pathogenicity traits without necessarily killing or impairing the microbial organism or insect. As such a bioactive protein may be fungistatic or fungicidal, bacteriostatic or bactericidal, insecticidal or insect static, or have pathogenicity inhibiting properties.

In some embodiments the bioactive protein may be a small peptide with anti-microbial properties such as an antimicrobial peptide or AMP. AMPs usually have a length of in the range of 10 to 50 amino acids. AMPs are commonly anionic or cationic and can be subdivided in 4 classes: (i) anionic peptides which are rich in glutamic and aspartic acids, (ii) linear cationic α-helical peptides, (iii) cationic peptides enriched for specific amino acid rich in proline, arginine, phenylalanine, glycine, tryptophan and (iv) anionic/cationic peptides forming disulfide bonds. More specific examples are plant derived AMPs with antimicrobial or antiviral activities such as peptides composed of at least two helical domains connected by a linker/turn such as plant-derived amphipathic helix or two helices engineered into a helix-turn-helix (HTH) format in which homologous or heterogeneous helices are connected by a peptide linker. For example, as described in WO2021202476, WO2020072535, WO2020176224 or WO2003000863.

Non-limiting examples of bioactive proteins that can be produced in a microbial fermentation reaction and are suitable for being formulated in the agglomerates of this invention may be the well-known Bt toxins, e.g., a Cry protein, a Cyt protein, or a Vip protein, or an 6-endotoxin (e.g., Crystal (Cry) toxins and/or cytolytic (Cyt) toxins); vegetative insecticidal proteins (Vips); secreted insecticidal protein (Sips); or Bin-like toxins. “Vip” or “VIP” or “Vegetative Insecticidal Proteins” refer to proteins discovered from screening the supernatant of vegetatively grown strains of Bt for possible insecticidal activity. Vips have little or no similarity to Cry proteins. Of particular use and preference for use with this document are what have been called VIP3 or Vip3 proteins, which have Lepidopteran activity. Vips are thought to have a similar mode of action as Bt cry peptides. Further examples may be polypeptides derived from spider venom such as venom from funnel-web spiders such as agatoxins or diguetoxins more specifically a Mu-diguetoxin-dc1a variant polypeptides or a U1-agatoxin-Ta1b variant polypeptide. Other examples are polypeptides derived from sea anemone, such as Av3 toxins. Such as described in WO2022067214 or WO2021216621 or WO2022212777.

In preferred embodiments, the bioactive protein that can be produced in a microbial fermentation reaction and are suitable for being formulated in the agglomerates of this invention is an antibody or a functional fragment thereof, a carbohydrate-binding domain, a heavy chain antibody or a functional fragment thereof, a single domain antibody, a heavy chain variable domain of an antibody or a functional fragment thereof, a heavy chain variable domain of a heavy chain antibody or a functional fragment thereof, a variable domain of camelid heavy chain antibody (VHH) or a functional fragment thereof, a variable domain of a new antigen receptor, a variable domain of shark new antigen receptor (vNAR) or a functional fragment thereof, a minibody, a nanobody, a nanoantibody, an affibody, an alphabody, a designed ankyrin-repeat domain, an anticalins, a knottins or an engineered CH2 domain.

In a more preferred embodiment the bioactive protein may comprise at least one camelized heavy chain variable domain of a conventional four-chain antibody (camelized VH), or a functional fragment thereof, at least one heavy chain variable domain of a heavy chain antibody (VHH), which is naturally devoid of light chains or a functional fragment thereof, such as but not limited to a heavy chain variable domain of a camelid heavy chain antibody (camelid VHH) or a functional fragment thereof. Where the at least one heavy chain variable domain of an antibody or a functional fragment thereof, does not have an amino acid sequence that is exactly the same as (i.e. as in a degree of sequence identity of 100% with) the amino acid sequence of a naturally occurring VH domain, such as the amino acid sequence of a naturally occurring VH domain from a mammal, and in particular from a human being.

In more specific embodiments, the VHH may be a VHH that binds a specific lipid fraction of the cell membrane of a fungal spore. Such VHHs may exhibit fungicidal activity through retardation of growth and/or lysis and explosion of spores, thus preventing mycelium formation. The VHH may therefore have fungicidal or fungistatic activity.

In some embodiments, the VHH may be a VHH that is capable of binding to a lipid-containing fraction of the plasma membrane of a fungus (for example Botrytis cinerea or other fungus). Said lipid-containing fraction may be obtainable by chromatography. For example, said lipid-containing fraction may be obtainable by a method comprising:
fractionating hyphae of a fungus (for example Botrytis cinerea or other fungus) by total lipid extract thin-layer chromatography and selecting the fraction with a Retention Factor (RD higher than the ceramide fraction and lower than the non-polar phospholipids fraction.

The invention also provides a bioactive protein in the form of a polypeptide, wherein at least one polypeptide is capable of binding to a lipid-containing fraction of the plasma membrane of a fungus (for example Botrytis cinerea or other fungus). Said lipid-containing fraction may be obtainable by chromatography. For example, said lipid-containing fraction may be obtainable by a method comprising:
fractionating hyphae of a fungus (for example Botrytis cinerea or other fungus) by total lipid extract thin-layer chromatography and selecting the fraction with a Retention Factor (RD higher than the ceramide fraction and lower than the non-polar phospholipids fraction.

The VHHs are generally capable of binding to a fungus. The VHH thereby causes retardation of growth of a spore of the said fungus and/or lysis of a spore of the said fungus. That is to say, binding of the VHH to a fungus results in retardation of growth of a spore of the said fungus and/or lysis of a spore of the said fungus.

The VHHs may (specifically) bind to a membrane of a fungus or a component of a membrane of a fugus. In some embodiments, the VHHs do not (specifically) bind to a cell wall or a component of a cell wall of a fungus. For example, in some embodiments, the VHHs do not (specifically) bind to a glucosylceramide of a fungus.

The VHHs may be capable of (specifically) binding to a lipid-containing fraction of the plasma membrane of a fungus, such as for example a lipid-containing fraction of Botrytis cinerea or other fungus. Said lipid-containing fraction (of Botrytis cinerea or otherwise) may be obtainable by chromatography. The chromatography may be performed on a crude lipid extract (also referred to herein as a total lipid extract, or TLE) obtained from fungal hyphae and/or conidia. The chromatography may be, for example, thin-layer chromatography or normal-phase flash chromatography. The chromatography (for example thin-layer chromatography) may be performed on a substrate, for example a glass plate coated with silica gel. The chromatography may be performed using a chloroform/methanol mixture (for example 85/15% v/v) as the eluent.

For example, said lipid-containing fraction may be obtainable by a method comprising:
fractionating hyphae and/or conidia of a fungus (for example Botrytis cinerea or other fungus) by total lipid extract thin-layer chromatography and selecting the fraction with a Retention Factor (RD higher than the ceramide fraction and lower than the non-polar phospholipids fraction.

In a more specific embodiment, the lipid-containing fraction may be obtainable by a method comprising:
fractionating hyphae and/or conidia of a fungus (for example Botrytis cinerea or other fungus) by total lipid extract thin-layer chromatography on a silica-coated glass slide using a chloroform/methanol mixture (for example 85/15% v/v) as the eluent and selecting the fraction with a Retention Factor (RD higher than the ceramide fraction and lower than the non-polar phospholipids fraction.

Alternatively, the fraction may be obtained using normal-phase flash chromatography. In such a method, the method may comprise:
fractionating hyphae and/or conidia of a fungus (for example Botrytis cinerea or other fungus) by total lipid extract normal-phase flash chromatography, and selecting the fraction with a Retention Factor (RD higher than the ceramide fraction and lower than the non-polar phospholipids fraction.

In a more specific embodiment, the lipid-containing fraction may be obtainable by a method comprising:
fractionating hyphae and/or conidia of a fungus (for example Botrytis cinerea or other fungus) by total lipid extract normal-phase flash chromatography comprising dissolving the TLE in dichloromethane (CH2Cl2) and MeOH and using CH2Cl2/MeOH (for example 85/15%, v/v) as the eluent, followed by filtration of the fractions through a filter.

In a more specific embodiment, the lipid-containing fraction may be obtainable by a method comprising:
fractionating hyphae and/or conidia of a fungus (for example Botrytis cinerea or other fungus) by total lipid extract normal-phase flash chromatography comprising dissolving the TLE in dichloromethane (CH2Cl2) and MeOH loading the TLE on to a phase flash cartridge (for example a flash cartridge with 15 μm particles), running the column with CH2Cl2/MeOH (85/15%, v/v) as the eluent, and filtering the fractions through a filter (for example a 0.45 μm syringe filter with a nylon membrane) and drying the fractions.

The fractions from the chromatography may be processed prior to testing of binding of the VHH to the fraction or of interaction with the fraction. For example, liposomes comprising the fractions may be prepared. Such a method may comprise the use of thin-film hydration. For example, in such a method, liposomes may be prepared using thin-film hydration with the addition of 1,6-diphenyl-1,3,5-hexatriene (DPH). Binding and/or disruption of the membranes by binding of the VHH may be measured by a change in fluorescence before and after polypeptide binding (or by reference to a suitable control).

Accordingly, in some embodiments, the VHHs may (specifically) bind to a lipid-containing chromatographic fraction of the plasma membrane of a fungus, optionally wherein the lipid-containing chromatographic fraction is prepared into liposomes prior to testing the binding of the polypeptide thereto.

Binding of the VHH to a lipid-containing fraction of a fungus may be confirmed by any suitable method, for example bio-layer interferometry. Specific interactions with the lipid-containing fractions may be tested. For example, it may be determined if the polypeptide is able to disrupt the lipid fraction when the fraction is prepared into liposomes, for example using thin-film hydration.

In methods involving chromatography, an extraction step may be performed prior to the step of chromatography. For example, fungal hyphae and/or conidia may be subjected to an extraction step to provide a crude lipid extract or total lipid extract on which the chromatography is performed. For example, in some embodiments, fungal hyphae and/or conidia (for example fungal hyphae and/or conidia of Fusarium oxysporum or Botrytis cinerea) may be extracted at room temperature, for example using chloroform:methanol at 2:1 and 1:2 (v/v) ratios. Extracts so prepared may be combined and dried to provide a crude lipid extract or TLE.

Accordingly, in some embodiments, the VHH may be capable of (specifically) binding to a lipid-containing fraction of the plasma membrane of a fungus (such as Fusarium oxysporum or Botrytis cinerea), wherein the lipid-containing fraction of the plasma membrane of the fungus is obtained or obtainable by chromatography. The chromatography may be normal-phase flash chromatography or thin-layer chromatography. Binding of the VHH to the lipid to the lipid-containing fraction may be determined according to bio-layer interferometry. In some embodiments, the chromatography step may be performed on a crude lipid fraction obtained or obtainable by a method comprising extracting lipids from fungal hyphae and/or conidia from a fungal sample. The extraction step may use chloroform:methanol at 2:1 and 1:2 (v/v) ratios to provide two extracts, and then combining the extracts.

In methods relating to thin-layer chromatography, the chromatography may comprise the steps of:
fractionating hyphae of the fungus by total lipid extract thin-layer chromatography and selecting the fraction with a Retention Factor (RD higher than the ceramide fraction and lower than the non-polar phospholipids fraction.

In some methods relating to thin-layer chromatography, the chromatography may comprise the steps of:
fractionating hyphae and/or conidia of a fungus (for example Botrytis cinerea or other fungus) by total lipid extract thin-layer chromatography on a silica-coated glass slide using a chloroform/methanol mixture (for example 85/15% v/v) as the eluent and selecting the fraction with a Retention Factor (RD higher than the ceramide fraction and lower than the non-polar phospholipids fraction.

In methods relating to normal-phase flash chromatography, the chromatography may comprise the steps of:
fractionating hyphae and/or conidia of a fungus (for example Botrytis cinerea or other fungus) by total lipid extract normal-phase flash chromatography, and selecting the fraction with a Retention Factor (RD higher than the ceramide fraction and lower than the non-polar phospholipids fraction.

In some methods relating to normal-phase flash chromatography, the chromatography may comprise the steps of:
fractionating hyphae and/or conidia of a fungus (for example Botrytis cinerea or other fungus) by total lipid extract normal-phase flash chromatography comprising dissolving the TLE in dichloromethane (CH2Cl2) and MeOH and using CH2Cl2/MeOH (for example 85/15%, v/v) as the eluent, followed by filtration of the fractions through a filter.

In some methods relating to normal-phase flash chromatography, the chromatography may comprise the steps of:
fractionating hyphae and/or conidia of a fungus (for example Botrytis cinerea or other fungus) by total lipid extract normal-phase flash chromatography comprising dissolving the TLE in dichloromethane (CH2Cl2) and MeOH loading the TLE on to a phase flash cartridge (for example a flash cartridge with 15 μm particles), running the column with CH2Cl2/MeOH (85/15%, v/v) as the eluent, and filtering the fractions through a filter (for example a 0.45 μm syringe filter with a nylon membrane) and drying the fractions.

In some embodiments, the bioactive protein is VHH-1, VHH-2 or VHH-3. For example, in some embodiments, the bioactive protein is a VHH comprising or consisting of a sequence selected from the group consisting of SEQ ID NOs: 1, 2, 6, 10, 14 and 15.

In some embodiments, the bioactive protein is a VHH comprising:
a CDR1 comprising or consisting of a sequence selected from the group consisting of SEQ ID NOs 3, 7 and 11;
a CDR2 comprising or consisting of a sequence selected from the group consisting of SEQ ID NOs: 4, 8 and 12; and
a CDR3 comprising or consisting of a sequence selected from the group consisting of SEQ ID NOs: 5, 9 and 13.

In some embodiments, the bioactive protein is a VHH comprising:
a CDR1 comprising or consisting of the sequence of SEQ ID NO: 3, a CDR2 comprising or consisting of the sequence of SEQ ID NO: 4 and a CDR3 comprising or consisting of the sequence of SEQ ID NO: 5;
a CDR1 comprising or consisting of the sequence of SEQ ID NO: 7, a CDR2 comprising or consisting of the sequence of SEQ ID NO: 8 and a CDR3 comprising or consisting of the sequence of SEQ ID NO: 9 or
a CDR1 comprising or consisting of the sequence of SEQ ID NO: 11, a CDR2 comprising or consisting of the sequence of SEQ ID NO: 12 and a CDR3 comprising or consisting of the sequence of SEQ ID NO: 13.

In some embodiments, the bioactive protein is a VHH comprising a CDR1 comprising or consisting of the sequence of SEQ ID NO: 3, a CDR2 comprising or consisting of the sequence of SEQ ID NO: 4 and a CDR3 comprising or consisting of the sequence of SEQ ID NO: 5.

In some embodiments, the bioactive protein is a VHH comprising SEQ ID NO: 1.

In some embodiments, the bioactive protein is a VHH comprising SEQ ID NO: 2.

In some embodiments, the bioactive protein is a VHH comprising any of SEQ ID NOs: 1, 2, 6, 10, or 14 to 99.

In some embodiments, the bioactive protein comprises a VHH disclosed in WO2014/177595 or WO2014/191146, the entire contents of which are incorporated herein by reference. More specifically the bioactive protein comprises a VHH comprising an amino acid sequence chosen from the group consisting of SEQ ID NO's: 1 to 84 from WO2014/177595 or WO2014/191146, which correspond to SEQ ID Nos 16-99 of the present application.

In some embodiments, the bioactive protein is a VHH comprising (a) the amino acid sequence provided in any one of SEQ ID NOs: 1, 2, 6, 10 or 14 to 99, or (b) an amino acid sequence that is at least 80%, preferably at least 90%, identical to any one of SEQ ID NOs: 1, 2, 6, 10 or 14 to 99.

In some embodiments, the VHHs are fused to a carrier peptide.

As used herein, the term “monoclonal antibody” refers to an antibody composition having a homogeneous antibody population. The term is not limited regarding the species or source of the antibody, nor is it intended to be limited by the manner in which it is made. The term encompasses whole immunoglobulins as well as fragments such as Fab, F(ab)2, Fv, and others that retain the antigen binding function of the antibody. Monoclonal antibodies of any mammalian species can be used in this invention. In practice, however, the antibodies will typically be of rat or murine origin because of the availability of rat or murine cell lines for use in making the required hybrid cell lines or hybridomas to produce monoclonal antibodies. As used herein, the term “polyclonal antibody” refers to an antibody composition having a heterogeneous antibody population. Polyclonal antibodies are often derived from the pooled serum from immunized animals or from selected humans.

“Heavy chain variable domain of an antibody or a functional fragment thereof” (also indicated hereafter as VHH), as used herein, means (i) the variable domain of the heavy chain of a heavy chain antibody, which is naturally devoid of light chains, including but not limited to the variable domain of the heavy chain of heavy chain antibodies of camelids or sharks or (ii) the variable domain of the heavy chain of a conventional four-chain antibody (also indicated hereafter as VH), including but not limited to a camelized (as further defined herein) variable domain of the heavy chain of a conventional four-chain antibody (also indicated hereafter as camelized VH).

As used herein, the terms “complementarity determining region” or “CDR” within the context of antibodies refer to variable regions of either the H (heavy) or the L (light) chains (also abbreviated as VH and VL, respectively) and contain the amino acid sequences capable of specifically binding to antigenic targets. These CDR regions account for the basic specificity of the antibody for a particular antigenic determinant structure. Such regions are also referred to as “hypervariable regions.” The CDRs represent non-contiguous stretches of amino acids within the variable regions but, regardless of species, the positional locations of these critical amino acid sequences within the variable heavy and light chain regions have been found to have similar locations within the amino acid sequences of the variable chains. The variable heavy and light chains of all canonical antibodies each have 3 CDR regions, each non-contiguous with the others (termed L1, L2, L3, H1, H2, H3) for the respective light (L) and heavy (H) chains.

As further described hereinbelow, the amino acid sequence and structure of a heavy chain variable domain of an antibody can be considered, without however being limited thereto, to be comprised of four framework regions or “FR's”, which are referred to in the art and hereinbelow as “framework region 1” or “FR1”; as “framework region 2” or “FR2”; as “framework region 3” or “FR3”; and as “framework region 4” or “FR4”, respectively, which framework regions are interrupted by three complementary determining regions or “CDR's”, which are referred to in the art as “complementarity determining region 1” or “CDR1”; as “complementarity determining region 2” or “CDR2”; and as “complementarity determining region 3” or “CDR3”, respectively.

As also further described hereinbelow, the total number of amino acid residues in a heavy chain variable domain of an antibody (including a VHH or a VH) can be in the region of 110-130, is preferably 112-115, and is most preferably 113. It should however be noted that parts, fragments or analogs of a heavy chain variable domain of an antibody are not particularly limited as to their length and/or size, as long as such parts, fragments or analogs retain (at least part of) the functional activity, such as the pesticidal, biocidal, biostatic activity, insecticidal, insect static, fungicidal or fungistatic activity (as defined herein) and/or retain (at least part of) the binding specificity of the original a heavy chain variable domain of an antibody from which these parts, fragments or analogs are derived from. Parts, fragments or analogs retaining (at least part of) the functional activity, such as the pesticidal, biocidal, biostatic activity, fungicidal or fungistatic activity (as defined herein) and/or retaining (at least part of) the binding specificity of the original heavy chain variable domain of an antibody from which these parts, fragments or analogs are derived from are also further referred to herein as “functional fragments” of a heavy chain variable domain.

A method for numbering the amino acid residues of heavy chain variable domains is the method described by Chothia et al. (Nature 342, 877-883 (1989)), the so-called “AbM definition” and the so-called “contact definition”. Herein, this is the numbering system adopted.

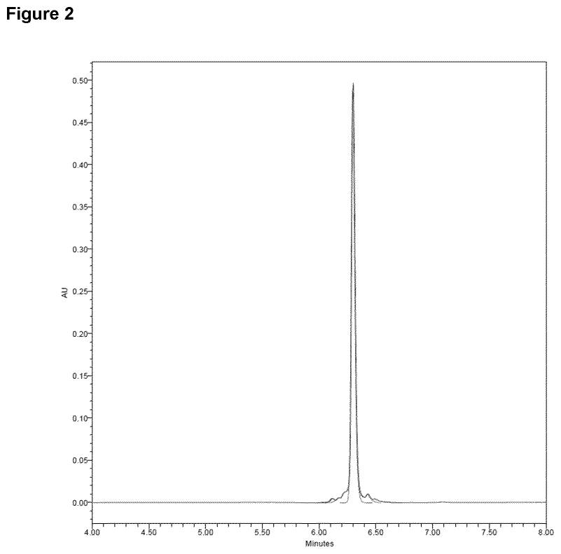

Alternatively, the amino acid residues of a variable domain of a heavy chain variable domain of an antibody (including a VHH or a VH) may be numbered according to the general numbering for heavy chain variable domains given by Kabat et al. (“Sequence of proteins of immunological interest”, US Public Health Services, NIH Bethesda, Md., Publication No. 91), as applied to VHH domains from Camelids in the article of Riechmann and Muyldermans, referred to above (see for example FIG. 2 of said reference).

For a general description of heavy chain antibodies and the variable domains thereof, reference is inter alia made to the following references, which are mentioned as general background art: WO 94/04678, WO 95/04079 and WO 96/34103 of the Vrije Universiteit Brussel; WO 94/25591, WO 99/37681, WO 00/40968, WO 00/43507, WO 00/65057, WO 01/40310, WO 01/44301, EP 1134231 and WO 02/48193 of Unilever; WO 97/49805, WO 01/21817, WO 03/035694, WO 03/054016 and WO 03/055527 of the Vlaams Instituut voor Biotechnologie (VIB); WO 03/050531 of Algonomics N.V. and Ablynx NV; WO 01/90190 by the National Research Council of Canada; WO 03/025020 (=EP 1 433 793) by the Institute of Antibodies; as well as WO 04/041867, WO 04/041862, WO 04/041865, WO 04/041863, WO 04/062551 by Ablynx; Hamers-Casterman et al., Nature 1993 Jun. 3; 363 (6428): 446-8.

Generally, it should be noted that the term “heavy chain single variable domain” as used herein in its broadest sense is not limited to a specific biological source or to a specific method of preparation. For example, as will be discussed in more detail below, the heavy chain variable domains of the invention can be obtained (1) by isolating the VHH domain of a naturally occurring heavy chain antibody; (2) by isolating the VH domain of a naturally occurring four-chain antibody (3) by expression of a nucleotide sequence encoding a naturally occurring VHH domain; (4) by expression of a nucleotide sequence encoding a naturally occurring VH domain (5) by “camelization” (as described below) of a naturally occurring VH domain from any animal species, in particular a species of mammal, such as from a human being, or by expression of a nucleic acid encoding such a camelized VH domain; (6) by “camelisation” of a “domain antibody” or “Dab” as described by Ward et al (supra), or by expression of a nucleic acid encoding such a camelized VH domain (7) using synthetic or semi-synthetic techniques for preparing proteins, polypeptides or other amino acid sequences; (8) by preparing a nucleic acid encoding a VHH or a VH using techniques for nucleic acid synthesis, followed by expression of the nucleic acid thus obtained; and/or (9) by any combination of the foregoing. Suitable methods and techniques for performing the foregoing will be clear to the skilled person based on the disclosure herein and for example include the methods and techniques described in more detail hereinbelow.

However, according to a specific embodiment, the heavy chain variable domains as disclosed herein do not have an amino acid sequence that is exactly the same as (i.e. as a degree of sequence identity of 100% with) the amino acid sequence of a naturally occurring VH domain, such as the amino acid sequence of a naturally occurring VH domain from a mammal, and in particular from a human being.

In some embodiments the aqueous liquid composition comprises one or more of a filler agent, a preservative, an antifoam agent, a buffer agent, an anti-caking agent, a sticker, a humectant and/or a surfactant, or any combination thereof.

In some embodiments the aqueous liquid composition further comprises a humectant. Humectants may help decrease water evaporation from spray droplets. A specific example of a humectant is attapulgite clay powder also known as Palygorskite and more specifically magnesium aluminium phyllosilicate. A commercially available example of attapulgite clay powder is Attagel 50 available from BASF SE. In a preferred embodiment the aqueous liquid composition comprises an attapulgite clay powder such as Attagel 50.

In some embodiments the aqueous liquid composition further comprises a “surfactant” also referred to as a “wetting agent”, and used herein interchangeably. Surfactants are compounds that lower the surface tension between two liquids, or between a liquid and a solid. A surfactant is usually an organic amphiphilic compound, meaning that it contains both water soluble (hydrophilic) and water insoluble (hydrophobic) components. An example of a surfactant is Tween. Tween surfactants contain hydrophilic ethylene glycol head groups and a hydrophobic alkyl tail. Different Tween molecules have the same hydrophilic head group, but a variable alkyl tail length for instance Tween 20 has a dodecyl tail and Tween 40 a longer octadecyl tail. In a preferred embodiment, the liquid composition comprises the surfactant Tween 20 or polyoxyethylene sorbitan monolaurate. Tween 20 variants Tween 22, Tween 23 and Tween 24 are for instance available from commercial provider Croda International Plc. In a preferred embodiment the liquid composition further comprises the surfactant Tween 23. Another example of a surfactant are organomodified siloxanes or more specifically polyether siloxanes. An example of such polyether siloxanes is the Break-Thru series of products available from Evonik Operations GmbH. In a preferred embodiment the liquid composition comprises the surfactant biodegradable polyether siloxane known with its commercial name Break-Thru S301. Another suitable composition from Evonik Operations GmbH is the polyether siloxane known as Break-Thru S240. Other examples of surfactants that can be added in varying concentrations are C8-10 alkyl polyglucoside available from BASF SE with its commercial name Agnique PG8107, polyalkyleneoxide Modified heptamethyltrisiloxane available from De Sangosse or Momentive with its commercial name Silwet L-77, polyoxyethylene (20) oleyl ether available from Croda Internation Plc with its commercial name Brij 020, polyethoxylated Alcohol available from Croda International Plc with its commercial name Brij C20, alkyl polyethylene glycol ether available from BASF SE with its commercial name Lutensol ON 60, fatty alcohol polyglycolether available from Clariant AG with its commercial name Genapol O 230, Alcohol ethoxylate more specifically Ethylene Oxide/Propylene Oxide Block Copolymers such as those available from Dow Inc with commercial name Tergitol XD, or specific mixtures such as Geropon L Wet Max available from Solvay SA.

In some embodiments the aqueous liquid composition further comprises a “filler agent”, also referred to as an “inert ingredient”, and used herein interchangeably. Filler agents are compounds that in general are considered not to have a biological activity, i.e. they do not improve or decrease efficacy of a product in which they are used. Filler agents are also considered safe for use in for instance foodstuff or for agricultural use. As an example, the InertFinder database of the U.S. Environmental Protection Agency—EPA, provides an overview of all compounds that are considered inert, and can be used as a filler agent. Filler agents may, for instance, be used to increase the volume of a product. Since active ingredients in crop protection products may be present in a low concentration, adding filler agents may improve for instance handling of the product. In other embodiments filler agents may be added to assure a constant concentration of active ingredient. For example, when an active ingredient is derived from a microbiological fermentation which are inherently variable in output concentration of the active ingredient, filler agents are added to achieve a standard concentration in the final product. The skilled person will know that the amount of filler agent may be calculated based on for instance the concentration of the active ingredient in the liquid composition in order to achieve a set concentration in the final product, where the final product may for instance be spray-dried or agglomerated. Some non-limiting examples of filler agents are Trisodium citrate dihydrate commonly available, and for example available from Citribel NV, Silicon dioxides such as Aerosil 200 and Sipernat 50s available from Evonik Operations GmbH. In a preferred embodiment the liquid composition further comprises the filler agent Sipernat 50S.

In some embodiments the aqueous liquid composition further comprises an antifoam agent. Antifoam agents used in for example a crop protection product may help to prevent the formation of foam in the spray tank when filling a spray tank by mixing a concentrated composition or an agglomerate in a larger volume of water. Common examples of antifoam agents are silicone fluids such as polydimethylsiloxane also known as dimethicone also known with its tradename Xiameter AFE 1530 a commercial product sold by DOW Inc., tertiary amine oxides such as decyldimethyl-aminoxide also known as decalmine oxide also known with its tradename Tegotens DO a commercial product sold by Evonik and silicone emulsions such as those disclosed in WO2007058985A1 and for example the silicone emulsion SAG 471 a commercial product sold by Momentive. In a preferred embodiment the liquid composition further comprises the antifoam agent Xiameter AFE 1530.

In some embodiments the aqueous liquid composition further comprises an Anti-caking agent. Anti-caking agents are anhydrous compounds that are added in small amounts to dry foods to prevent particles from caking together or to the walls of the vessel of a spray agglomeration apparatus. An example of compounds that can serve as anti-caking agents are silicon dioxides, for example available from Evonik Operations GmbH with commercial name Sipernat 50s. In a preferred embodiment the liquid composition further comprises the filler agent Sipernat 50S. The current inventors have surprisingly found that using silicon dioxides or hydrated silica such as Sipernat 50S as an anti-caking agent, greatly improved the dissolution and wettability of the agglomerates according to the invention. In some embodiments addition of Sipernat 50S as an anti-caking agent to the liquid composition is combined with the removal of a humectant such as the humectant Attagel 50 from the liquid composition.

In some embodiments the liquid composition further comprises a Sticker. Stickers prevent bioactive compounds from washing off leaves or other plant materials when sprayed, thereby increasing retention time on leaf surface, resulting in better overall spray efficacy. Non limiting examples of stickers are hydroxyethyl cellulose polymers such as available from Dow Inc. under its commercial name Cellosize Hydroxyethyl Cellulose QP300 and guar gum or products based thereon available from Solvay under its commercial name AgRHEA SticGuard.

In some embodiments the aqueous liquid composition further comprises a preservative. The preservative may be selected from a sorbate salt such as potassium sorbate, or an acid such as citric acid monohydrate.

In some embodiments the aqueous liquid composition further comprises a buffer agent. The buffer agent may be selected from a citrate salt, such as citric acid monophosphate, or a phosphate buffer, or a HEPES buffer.

The skilled person will know that certain compounds can have different functions in a formulation. For example, Sipernat 50s may be used as a filler, but additionally Sipernat 50s is also known for its role as an anti-caking agent. Brij 020 and Brij C20 can both be utilized as a wetting agent and serve as a dispersant.

The different ingredients or additives or co-formulants as described above may be mixed into the fermentation broth in various orders. The skilled person will know that some ingredients should be added first or last, depending on the specific properties of that ingredient. This is often derived by trial and error, for instance addition of an ingredient could lead to it's precipitation if another ingredient is already present. Inverting the order of mixing could alleviate such a problem. That being said, for most ingredients no specific order will be required. Thus, most ingredients can be added at the same time or in any given order. Other ingredients might need heating in order to be incorporated into the fermentation broth. Mixing of the ingredients can be achieved by any suitable mixing means, such as a 4-bladed propeller, a mixing rod, a bead mil a blender or any other means that can mix liquids. Mixing at small laboratory scale can be achieved by common appliances such as a blender, whereas mixing at pilot scale or at industrial scale would require more robust industrial grade mixer such as a heavy duty 4-bladed propeller mixer. In some set-ups the final liquid composition can be continuously mixed in a receptacle and directly fed into the spray agglomeration apparatus vessel. This is especially useful in a large-scale continuous spray agglomeration system. This set-up assures the liquid composition stays homogenous throughout the entire process and new batches of liquid composition can be continuously added thereto assuring that a continuous process can run for extended periods of times (such as multiple days, weeks or even months). In other set-ups the mixing of the liquid composition may be achieved in a separate receptacle and then transferred into the spray agglomeration apparatus by for example a pump.

### [Spray Dried Powder]

The agglomeration process of this invention involves a first spray drying step of the aqueous liquid composition. The spray dried powder is an intermediate product and may be produced without continuing into an agglomerate. The spray dried powder may be used to initiate the fluidized bed. The spray dried powder can be formed in a separate reaction and introduced into the fluidized bed to initiate the agglomeration process. In a preferred embodiment, the spray dried powder is first formed to build up the fluidized bed and in the same process, agglomerates are produced. The spray dried powder particles can be characterized by their size distributions, which can be determined, for example, by dynamic light scattering methods. The D50 value for the particles in the instant case is typically up to 200 μm, preferably up to 150 μm, more preferably up to 100 μm, most preferably up to 50 μm, and especially preferably up to 25 μm. In some preferred embodiments the spray dried product may contain particles with a D50 value below 25 μm.

### [the Agglomerates of the Invention]

The inventors have found a process to produce agglomerates containing a bioactive protein such as an immunoglobulin single variable domain or VHH. The agglomerate according to this invention is essentially homogenous in its composition. Put differently, a cross section of an agglomerate according to this invention will have the same general composition throughout. This is in contrast with an agglomerate produced by methods of the prior art, where a solid carrier is added. The solid carrier is composed of different compounds to those present in the liquid composition and is added during or before the agglomeration process and the liquid composition is sprayed onto the solid carrier. In this way, the carrier is added to the fluidized bed reactor, the heated fluidized bed is formed by starting the heated gas stream and hereafter the liquid composition is sprayed into the fluidized bed. Such an agglomerate will have a heterogeneous composition because it has been produced using a solid carrier. However, the term “heterogenous”, in relation to an agglomerate, does not include agglomerates that are for instance provided with a coating during an additional step or additional stage of the process after agglomeration. Such agglomerates still have a core formed by agglomeration that consist of the solid components in the spray dried liquid composition.

Given the heterogeneous nature of a fluidized bed, the size of the agglomerates extracted will vary around an average size, known as Particle Size Distribution, which is commonly quantified by a d50 value. For example, an agglomerate sample with d50 of 300 μm, means that 50% of particles are larger than 300 μm and 50% particles are smaller than 300 μm. Size of agglomerates and distribution of agglomerates can be determined using standard techniques well known by the skilled person. For example, by sieving a sample using sieves with varies mesh sizes. Alternatively or additionally, microscopy images can be taken from a sample of agglomerates to measure the size of the agglomerates using for example standard image analysis software. In some embodiments, the d50 value of the agglomerates of the invention is in the range of 100 μm and 900 μm. In more preferred embodiments, the d50 value of the agglomerates of the invention is in the range of 150 μm and 800 μm. In even more preferred embodiments, the d50 value of the agglomerates of the invention is in the range of 200 μm and 700 μm. In even more preferred embodiments, the d50 value of the agglomerates of the invention is in the range of 200 μm and 600 μm. In even more preferred embodiments, the d50 value of the agglomerates of the invention is in the range of 200 μm and 500 μm. In a most preferred embodiment, the d50 value of the agglomerates of the invention is in the range of 200 μm and 400 μm. The skilled person will know these values are estimates of the average of an entire population of agglomerates and have an inherent variation, for instance a standard variation on the d50 value of for example plus or minus 80 μm are common.

Imaging the agglomerates also allows for a measure of the irregularity to be determined. For example, the sphericity or SPHT3 value may be determined by image analysis according to the standard “DIN 66141—Representation of particle size distributions and/or ISO 9276-6:2008 Representation of results of particle size analysis—Part 6: Descriptive and quantitative representation of particle shape and morphology”. For a perfect sphere, the SPHT3 value is expected to be 1. Otherwise, the SPHT3 value is smaller than 1. In a preferred embodiment the agglomerates of the invention have an SPHT3 value lower than 1, preferably an SPHT3 value lower than 0.95, preferably an SPHT3 value lower than 0.90, more preferably an SPHT3 value lower than 0.88, more preferably an SPHT3 value lower than 0.85, more preferably an SPHT3 value below 0.83, more preferably an SPHT3 value below 0.80. In one preferred embodiment, the SPHT3 value is in the range of 0.75 and 0.90. In another preferred embodiment the SPHT3 is in the range of 0.80 and 0.89. In the most preferred embodiment, the SPHT3 value is from 0.81 to 0.88. In the present invention, a lower SPHT3 value is preferred over a higher more spherical SPHT3 value. The skilled person will know these values are estimates of the average of an entire population of agglomerates and have an inherent variation, for instance a standard deviation on the SPHT3 value of for example plus or minus 0.05 is common.

Dissolution is the ability of solute to dissolve while solubility is the rate at which solute dissolves in a solution. Dissolution of a solid formulation is the ability with which the solid dissolves in a liquid. The dissolution is commonly assessed by measuring the amount of residue (non-dissolved solute) that remains after a certain amount of time. A dissolution of 0% is an ideal dissolution where all the solute was dissolved within the set time. Herein dissolution is understood to be the extent to which the agglomerates dissolve when mixed in, for example, a larger volume of water (for instance the water in a spray tank for agricultural use). Ideally, complete dissolution is preferred to ensure a satisfying end user experience. It is an objective of the current invention to provide agglomerates with a high dissolution. The dissolution of a solid formulation can be determined by for example the CIPAC method MT 179.1 Degree of Dissolution and Solution Stability. Alternatively, the dissolution can be measured by adding 5 g of the agglomerate sample into 100 mL of pure water that is agitated by stirring the solution at 400 rpm using a stir bar. Dissolution rate is the rate of dissolution of a solid formulation at which the solid dissolves in a liquid. Therefore the term “dissolution rate” may be used interchangeably with “solubility”.

A preferred solubility of an agglomerate according to the invention is an agglomerate that dissolves with mixing in less than 60 seconds and no clumping occurs. As with the dissolution, a good solubility is preferred to ensure a satisfying end user experience.

The compaction rate or tap density describes the amount of agglomerates (in weight units) that can be packed or stored in a given volume. This measure is dependent on both the size (max diameter) and shape (SPHT3 value) of the agglomerates. Tap density can be measured according to CIPAC method MT 33—Tap density. In a preferred embodiment the tap density of the agglomerates is below 800 g/I.

The wettability of the agglomerates is the rate at which the agglomerate disperse and sink in a column of water without stirring. The wettability can be determined by the CIPAC method MT 53.3 Wetting of wettable powders. The method as written describes the wetting of wettable powder preparations, but it is also applicable to water soluble powders, water soluble agglomerates and water dispersible agglomerates. In this method, 1 gram of agglomerates are dropped into 200 ml of water from a specified height and without stirring; the time to complete wetting is then determined. The wettability of an agglomerate is considered acceptable if there is complete wetting in 1 minute without swirling. It is noted that wettability may be a good indicator of the solubility rate of the agglomerates. That is to say, agglomerates with a low wettability rate (i.e. higher than 60 seconds) will tend to have a low solubility rate and vice versa.

One objective of this invention is to improve the shelf life of the formulation. A liquid formulation is prone to degradation of the bioactive protein due to, for example, oxidation reactions, proteolytical activity and so forth. Furthermore, liquid compositions can be contaminated with microorganisms, leading to the spoilage of the product and the degradation of the bioactive protein. The shelf life can be determined by storing vessels containing the product at a fixed temperature for extended periods of times whilst taking regular samples and assessing the physicochemical and bioactive status of the product. Shelf-life experiments can be accelerated by storage at higher temperatures. For example, CIPAC method MT 46.3—Accelerated storage procedure. In one embodiment, the agglomerates are stable for at least 6 months of storage at 2-8° C. In a preferred embodiment, the agglomerates are stable for at least 1 year of storage at 2-8° C. In a most preferred embodiment, the agglomerates are stable for at least two years of storage at 2-8° C. In one embodiment, the agglomerates are stable for at least 6 months of storage at 18-22° C. temperature. In a preferred embodiment, the agglomerates are stable for at least 1 year of storage at 18-22° C. temperature. In a most preferred embodiment, the agglomerates are stable for at least two years at 18-22° C. temperature. In one embodiment, the agglomerates are stable for at least 3 months of storage at stressed temperature conditions of 45° C. (i.e. temperatures subjecting the agglomerates to more extreme conditions not regularly observed in day to day practice). In a preferred embodiment, the agglomerates are stable for at least 6 months of storage at stressed temperature conditions of 45° C. In a most preferred embodiment, the agglomerates are stable for at least 1 year at stressed temperature conditions of 45° C. The skilled person will understand that storage stability is also dependent on the packages protecting agglomerates from for instance air, moisture, light and heat. For example, for good storage stability 3-layer packaging may be used, composed out of one layer of Polyethylene terephthalate, one layer of Aluminum and one layer of low-density polyethylene for example commercially available as Lamizip stazakken zilver, DaklaPack.

The agglomerates described herein may be obtained from, or produced by the methods described herein. The agglomerates described herein may be obtainable from the methods described herein. Therefore, the agglomerates of the present invention may be obtained from, obtainable by or produced by the method comprising the steps of a) spraying an aqueous liquid composition and concomitantly applying heat allowing water present in the aqueous liquid composition to evaporate resulting in a spray-dried powder and, b) agitating and heating the spray dried powder in a fluidized bed reactor, and c) spraying the aqueous liquid composition onto the spray dried powder in the fluidized bed allowing for the formation of agglomerates from the spray-dried powder, wherein the aqueous liquid composition is derived from a microbial fermentation comprising dry matter containing a bioactive protein.

### [Composition of the Agglomerate]

The agglomerate of the invention comprises dry matter, a bioactive protein such as a VHH, water and optionally one or more filler agent, one or more preservative, one or more antifoam, one or more buffer agent, one or more anti-caking agent, one or more sticker, one or more humectant or one or more surfactant.

The content of bioactive protein relative to total weight is sometimes referred to as “loading” or “load” of the bioactive protein. A higher load of bioactive protein is sometimes beneficial; however, the maximum load will strongly depend on the additional compounds added to the formulation for the formulation to perform optimally when for example applied to crops. Furthermore, since bioactive proteins are produced in microbial fermentation by for example Pichia pastoris, the maximum load will also depend on the concentration of the bioactive protein in the fermentation broth and the degree of purification of the bioactive protein. Microbial fermentation will contain dry matter which consists of non-relevant process-related components originating from the host cells (for example Pichia pastoris) such as host cell proteins, carbohydrates and lipids, from the culture medium and used process aids. In a typical fermentation reaction in Pichia pastoris producing a bioactive protein (such as an immunoglobulin single variable domain and where the immunoglobulin single variable domain), the fermentation broth was purified and concentrated using several filtration techniques, the resulting fermentation broth can contain over 5% w/w of dry matter. In a preferred embodiment the fermentation broth contains in the range of 5 and 10% w/w of dry matter. In some embodiments the dry matter content of the fermentation broth can be up to 10% w/w or more, or even 15% w/w or more. In another preferred embodiment the dry matter content of the fermentation broth can be up to 25% w/w or more. In another preferred embodiment, the dry matter content of the fermentation broth can be up to 40% w/w or more. In yet another preferred embodiment, the dry matter content of the fermentation broth may be around 50% w/w. The dry matter of the fermentation broth may include a bioactive protein as described herein.

It follows that the dry matter content of the agglomerate, comprising the bioactive protein may take up to or close to 100% w/w of the agglomerate where all the water had been removed and no additional compounds such as a filler agent are added. In theory, where the agglomerate has a load of close to 100% w/w of a bioactive protein, the agglomerate is produced using essentially pure bioactive protein i.e. the dry matter is almost completely composed of bioactive protein which is attainable by purifying the bioactive protein from rest of the dry matter content resulting from a fermentation reaction. In a more preferred embodiment however, the agglomerates of the current invention comprise dry matter in a concentration in the range of 5% and 95% w/w, more preferably from 10% to 90% w/w, even more preferably from 15% to 85% w/w, even more preferably from 20% to 80% w/w, even more preferably from 20% to 75% w/w, even more preferably from 20% to 65% w/w, most preferably between 25% w/w and 55% w/w. In a most preferred embodiment, said dry matter is derived from a Pichia pastoris fermentation reaction and comprises a bioactive protein and where said bioactive protein is a VHH.

In a preferred embodiment, the agglomerate contains in the range of 5% and 25% w/w of bioactive protein. In a preferred embodiments the agglomerates have a load of around 5% w/w. in another preferred embodiments the agglomerates have a load of around 10% w/w. In a most preferred embodiments the agglomerates of this invention have a load of around 15% w/w. In another preferred embodiments the agglomerates have a load of around 20% w/w. In another preferred embodiments the agglomerates have a load of around 25% w/w. In some embodiments the agglomerates have a load of around 30% w/w. In some embodiments the agglomerates have a load of around 40% w/w. In some embodiments the agglomerates have a load of around 50% w/w. In a preferred embodiment, the agglomerate comprises from 10% w/w to 20% w/w of a bioactive protein and where said bioactive protein is a VHH. The skilled person will know that the final minimum or maximum load of the bioactive protein in the agglomerates of this invention will depend on the weight/weight ratio of said bioactive protein and the dry matter in which it is contained and the amount of additional solid compounds that are added to the liquid composition.

In preferred embodiments, the water content of the agglomerates is lower than 15% w/w. In more preferred embodiments, the water content of the agglomerates is lower than 12% w/w. In more preferred embodiments, the water content of the agglomerates is lower than 10% w/w. In more preferred embodiments, the water content of the agglomerates is lower than 9% w/w. In more preferred embodiments, the water content of the agglomerates is lower than 8% w/w. In a more preferred embodiment, the water content of the agglomerates is lower than 7% w/w. In a more preferred embodiment, the water content of the agglomerates is lower than 6% w/w. In a more preferred embodiment, the water content of the agglomerates lower than 5% w/w. In a more preferred embodiment, the water content of the agglomerates is lower than 4% w/w. In an even more preferred embodiment, the water content of the agglomerates is lower than 3% w/w. In another preferred embodiment, the water content of the agglomerates is lower than 2% w/w. In yet another preferred embodiment, the water content of the agglomerates is lower than 1% w/w.

In some embodiments the agglomerate contains one or more of a filler agent. In a preferred embodiment the filler agent is selected from trisodium citrate dihydrate, or a silicon dioxide. The amount of filler agent to be added depends on the final required concentration of bioactive protein in the agglomerate and the final residual amount of water maintained in the agglomerate. The skilled person will understand that the concentration of dry matter and the therein contained bioactive protein can vary between microbial fermentation reactions. Therefore, a filler agent may be added to dilute the final concentration of the bioactive protein in the final agglomerate. It is said that the filler agent is added to complete the final dry solid formulation up to 100%, hereby considering the concentration of the bioactive protein in the dry matter, the residual amount of water anticipated at the end of the agglomeration process and other optionally added solids. The term “dry solids”, “dry solid content”, “DS” or “DS-content” as used herein indicates the total amount of dry material that is left after complete removal of water or other liquid components. Dry solids therefore include dry matter and other dry components such as a filler agent. In some embodiments, a filler agent is added to a quantity equal to 1 to 50% of the dry matter content. Typically, a filler agent is added to a quantity equal to 1 to 25% of the dry matter content. Therefore, in preferred embodiments, the agglomerates of this invention comprise from 1% to 40% of a filler agent, more preferably from 1% to 35%, more preferably from 1% and 25%.

In some embodiments the agglomerate contains one or more of a preservative. In a preferred embodiment the preservative is selected from a sorbate salt such as potassium sorbate, or an acid such as citric acid, for example citric acid monohydrate. In some embodiments the agglomerate contains 0.1 to 5% w/w of a preservative. In some preferred embodiments, the agglomerates comprise from 1 to 3% w/w of a preservative and where this preservative is citric acid monohydrate. In another preferred embodiment, the agglomerates comprises from 0.10% to 0.50% w/w of a preservative and where this preservative is potassium sorbate. In some embodiments the agglomerates of the current invention comprises more than 1 preservative. In a most preferred embodiment, the agglomerates comprise from 1% w/w to 3% w/w of citric acid monohydrate and from 0.10% to 0.50% w/w of potassium sorbate.

In some embodiments the agglomerate contains one or more of an antifoam agent. In a preferred embodiment the antifoam agent is selected from a silicone fluid such as polydimethylsiloxane, or a tertiary amine oxides such as decyldimethyl-aminoxide. For example, Xiameter AFE-1530 Antifoam Emulsion from DOW Chemical Company. In some embodiments the agglomerate contains 0.1 to 1.5% w/w antifoam agent.

In some embodiments the agglomerate contains one or more of a buffer agent. In a preferred embodiment the buffer agent is selected from a citrate salt, such as citric acid monophosphate, or a phosphate buffer, or a HEPES buffer. In some embodiments the agglomerate contains 0.1 to 1.5% w/w buffer agent.

In some embodiments the agglomerate contains one or more of an anti-caking agent. In a preferred embodiment the buffer agent is selected from an anhydrous compound. In some embodiments the agglomerate contains 0.1 to 25% w/w anti-caking agent. In a more preferred embodiment, the agglomerates comprise from 5.00% to 7.00% w/w of an anti-caking agent. In some embodiments said anti-caking agent is a hydrated silica such as the commercially available Sipernat 50S from Evonik Industries.

In some embodiments the agglomerate contains one or more of a sticker. In a preferred embodiment the sticker is selected from an anhydrous compound. In some embodiments the agglomerate contains 0.1 to 1% w/w sticker. In a more preferred embodiment, the agglomerate contains 0.30% w/w and 0.50% w/w of a sticker, optionally wherein said sticker is a hydroxyethyl cellulose polymer, such as the commercially available CELLOSIZE™ Hydroxyethyl Cellulose QP-300 from DOW Chemical Company.

In some embodiments the agglomerate contains one or more of a humectant. In a preferred embodiment the humectant is selected from an attapulgite clay powder, such as a magnesium aluminium phyllosilicate, or a silicon dioxide. In some embodiments the agglomerate contains 0.1 to 2.5% w/w humectant. In some embodiments the agglomerate contains from 1.20% w/w to 2.30% w/w of a humectant, preferably 2.03% w/w of a humectant and where in a preferred embodiment said humectant is an attapulgite clay such as the commercially available Attagel 50 from BASF.

In some embodiments the agglomerate contains one or more of a surfactant. In a preferred embodiment the surfactant is selected from an organic amphiphilic compound, such as Polyoxyethylene sorbitan monolaurate, or a polyether siloxane such as Polyoxyethylene (20) oleyl ether, or an alcohol ethoxylat such as Ethylene Oxide/Propylene Oxide Block Copolymers. In some embodiments the agglomerate contains 0.1 to 10% w/w surfactant. In a more preferred embodiment the agglomerates comprise from 5% to 7% w/w of a surfactant, and optionally wherein said surfactant may be a polyether siloxane such as the commercially available Break-Thru S301 from Alzchem Group. In another more preferred embodiment the agglomerates comprise from 4% to 6% w/w of a surfactant, and optionally wherein said surfactant may be a polyoxyethylene sorbitan monolaurate such as the commercially available Tween 23 from Croda Crop Care.

In a most preferred embodiment, the water soluble granule as described herein comprises from 12% w/w to 18% w/w of a bioactive protein, preferably 15.00% w/w of a bioactive protein and where in a preferred embodiment said bioactive protein is a VHH, and where said bioactive protein is contained in the dry matter; and further comprises from 1.3% w/w to 1.9% w/w of a preservative, preferably 1.64% w/w of a preservative and where in a preferred embodiment said preservative is citric acid monohydrate; and further comprises from 0.2% w/w to 0.4% w/w of an additional preservative, preferably 0.32% w/w of an additional preservative and where in a preferred embodiment said preservative is potassium sorbate; and further comprises from 41% w/w to 62% w/w of dry matter, preferably 51.41% w/w of dry matter (where said w/w percentage of dry matter is excluding the bioactive protein) and where in a preferred embodiment said dry matter is obtained from a Pichia pastoris fermentation; and further comprises from 4.00% w/w to 6.00% w/w of a wetting agent, preferably 5.00% w/w of a wetting agent and where in a preferred embodiment said wetting agent is Tween 23; and further comprises from 1.2% w/w to 2.3% w/w of a humectant, preferably 2.03% w/w of a humectant and where in a preferred embodiment said humectant is Attagel 50; and further comprises from 0.3% w/w to 0.5% w/w of a sticker agent, preferably 0.37% w/w of a sticker agent and where in a preferred embodiment said sticker agent is CELLOSIZE™ Hydroxyethyl Cellulose QP-300; and further comprises from 0.1% w/w to 0.2% w/w of an antifoam agent, preferably 0.13% w/w of an antifoam agent and where in a preferred embodiment said antifoam agent is Xiameter AFE-1530 Antifoam Emulsion; and further comprises from 1.00% w/w to 26.00% w/w of an additional filler agent, preferably 17.10% w/w of a filler agent and where in a preferred embodiment said filler agent is trisodium citrate dihydrate; and further comprises from 0% w/w to 7.00% w/w of water, preferably 7.00% w/w of water; and where said water soluble granule has an SPTH3 value of below 0.90, preferably a SPTH3 value of from 0.81 to 0.88, a wettability of below 60 seconds preferably below 10 seconds, even more preferably from 1 to 10 seconds and a storage stability of over 3 months at 45° C., even more preferably a storage stability of over 1 year at 45° C.

In another most preferred embodiment, the water soluble granule as described herein comprises from 12% w/w to 18% w/w of a bioactive protein, preferably 15.00% w/w of a bioactive protein and where in a preferred embodiment said bioactive protein is a VHH; and further comprises from 2.1% w/w to 2.60% w/w of a preservative, preferably 2.36% w/w of a preservative and where in a preferred embodiment said preservative is a citric acid monohydrate; and further comprises from 0.1% w/w to 0.3% w/w of an additional preservative, preferably 0.20% w/w of a preservative and where in a preferred embodiment said preservative is potassium sorbate; and further comprises from 22% w/w to 28% w/w of dry matter, preferably 25.30% w/w of dry matter (where said w/w percentage of dry matter is excluding the bioactive protein) and where in a preferred embodiment said dry matter is obtained from a Pichia pastoris fermentation; and further comprises from 5% w/w to 7% w/w of a wetting agent, preferably 6.00% w/w of a wetting agent and where in a preferred embodiment said wetting agent is Break-Thru S301; and further comprises from 5% w/w to 7% w/w of an anti-caking agent, preferably 6.00% w/w of an anti-caking agent and where in a preferred embodiment said anti-caking agent is Sipernat 50S; and further comprises from 0.90% w/w to 1.10% w/w of an antifoam agent, preferably 1.00% w/w of an antifoam agent and where in a preferred embodiment said antifoam agent is Xiameter AFE-1530 Antifoam Emulsion; and further comprises from 1.00% w/w to 35.00% w/w of a filler agent, preferably 33.10% w/w of a filler agent and where in a preferred embodiment said filler agent is trisodium citrate dihydrate; and further comprises from 0% w/w to 5.00% w/w of water, preferably 5.00% w/w of water; and where said water soluble granule has an SPTH3 value of below 0.90, preferably a SPTH3 value of from 0.81 to 0.88, a wettability of below 60 seconds preferably from 1 to 10 seconds and a storage stability of over 3 months at 45° C., even more preferably a storage stability of over 1 year at 45° C.

### [Physical Chemical Stability]

Apart from the stability in terms of activity of the bioactive protein, the agglomerates of the present invention also are characterized by integrity and stability of the bioactive protein in chemical and physical terms. Physical integrity can be ascertained e.g. by standard SDS-PAGE analysis or commonly used LabChip protein characterization system from PerkinElmer to check the integrity of the full sized bioactive proteins and if degradation occurs over time by monitoring decreased concentration of bioactive protein or the formation of degradation products by for example proteolytical degradation. Additionally, size-exclusion chromatography or SEC can be used to assess the formation of a dimer or higher order complex or the loss of structure e.g. by unfolding. Unfolding would affect the flow through properties of bioactive protein in this chromatographic method and would lead to clear alterations in the chromatogram as compared to the reference sample. Chemical stability of the bioactive protein can be assessed e.g. by reversed phase chromatography (abbreviated “RPC”). Chemical modifications of the polypeptide will affect the retention times and thus influence the chromatogram. The various peaks can be analyzed and compared to a reference value. The skilled person knows suitable chromatographic equipment and analysis software. Non-limiting examples include e.g. Agilent 1200 HPLC system equipped with ChemStation software (Agilent Technologies, Palo Alto, USA., Rev B); Dionex Ultimate 3000 HPLC system equipped with Chromeleon software (Dionex Corporation, Sunnyva CA, USA, V6.8); or ACQUITY UPLC® H-Class Bio System (Waters, Saint-Quentin, France). Such systems allow for the generation and analysis of chromatograms. Typically, a main peak comprising the bioactive protein may be flanked by so-called pre- or post-peaks, which represent chemical variants, e.g. oxidation products or for example chemical reactions occurring in or between amino acids structures of the bioactive protein (for example pyroglutamate formation or the formation of breakage of disulfide bridges). The peaks on the chromatogram can be compared, e.g. In terms of their area under the curve. This can be achieved by standard commercial software as exemplified above. Typically, the total area under the curve of all characteristic peaks in one chromatogram is set at 100% and is also referred to as “peak area”, and the distribution between different peaks of one chromatogram can be compared. For example, the main peak corresponding to the bioactive protein can be 95%, and a pre-peak, comprising e.g. an oxidation product can be 5% of the total peak area on the chromatogram. These patterns can be compared between a liquid reference and an agglomerate of the invention. Ideally, the proportion of the main peak versus the side peaks will not change significantly by the methods of the invention. Formulations of the present invention will only show very minor changes between the main peak and pre- or post-peaks caused by the formulation and agglomeration method. For example, the relative increases in pre- or post-peaks will be less than 15% for each individual peak, e.g. less than 14, 12, 10, 8, 6, 4, 2, or 1%. This means, for example, if in the reference sample a single pre-peak 1 amounts to 5% of the total area of peaks, this peak will amount to no more than 10% after preparing an agglomerate according to the methods of the present invention, and more particularly will remain at e.g. 10%. In other words, the immunoglobulin single variable domains will retain their chemical integrity without significant changes. This is also reflected in that the main peak corresponding to the bioactive protein will be more than 80%, preferably more than 85%, more preferably more than 90% of the total area under the curve even after the method of formulation of the present invention. It is noted that the total area under the curve of the main peak of an RPC chromatogram can also be used to monitor any physical changes in the protein as this would result in a sharp decrease of the total peak area without the formation of significant pre- or post-peaks. As such RPC can serve as a complementary method to standard SDS-PAGE or LabChip analysis. The above defined changes in peak pattern can also be considered as “minor changes” in the context of the present invention or considered as changes that will not have a significant effect on the bioactivity of the bioactive protein in for example an on planta treatment. Moreover, the peak pattern will be stable at storage, and will not differ significantly (as defined above) even after e.g. 6 months storage at an average temperature of 20° C. or more.

### [Obtaining a Microbial Fermentation Broth]

The liquid composition that can be spray dried and agglomerated according to the invention consists of water, dry matter and optionally additional additives such as described elsewhere herein. The dry matter present in the liquid composition is solely derived from a microbial fermentation reaction. A microbial fermentation reaction results in a microbial fermentation broth that may be defined as a liquid suspension obtained after the propagation of microbial cells in a suitable growth media. In some embodiments the microbial cell is essentially a wild-type organism not substantially modified using genetic modifications. In preferred embodiments the microbial cells may be genetically modified to express a bioactive protein. The bioactive protein may have a protective or curative effect against a plant pathogen when applied to said plant. Typically, a microbial cell is propagated in a nutrient rich broth providing the necessary nutrients, salts, minerals, oxygen etc., for the microbial cell to grow and multiply to reach a certain density of cells in the fermentation broth. Generally, the broth will comprise any and all nutrients required for the microbial organism to grow. The skilled person will be aware of the required components of the culture broth or fermentation broth, which may differ depending on the species of microbial cell being cultured. In some embodiments, the culture broth or fermentation broth may comprise a nitrogen source, such as ammonium or peptone. Where the microbial cell is modified to express a bioactive protein, the bioactive protein may be encoded by a nucleotide sequence that may be operably linked to an inducible promoter. In this case, the microbial fermentation may comprise a step of inducing the expression of the compound of interest by adding an inducing agent such as methanol or lactose. A common inducible promoter that may be used is the inducible cbh1 or cbh2 promoter, in which administration of lactose will initiate expression. Other possibilities are methanol inducible promoters such as the AOX1 or FMD promoters. Other inducible promoters could of course be used. If the sequence encoding the compound of interest is under the control of a constitutive promoter, no specific step of induction of expression may be required. Fermentation or culture of the microbial cells may occur in a solid fermentation or culture setting or a liquid fermentation or culture setting. Solid-state fermentation or culture may comprise seeding the microbial cell on a solid culture substrate, and methods of solid-state fermentation or culture are known the skilled person. Liquid fermentation or culture may comprise culturing the microbial cell in a liquid cell culture medium. Typically, a fermentation reaction is completed when the microbial organism reaches a saturating density inside the fermentation broth and when the polypeptide of interest is expressed in sufficiently high amounts. Of course, the skilled person will appreciate that many scenarios and methods exist to come to a fermentation broth that can be used in the current invention.

At the end of a fermentation reaction, the fermentation broths are optionally clarified by removing the cellular material and as such obtaining a microbial fermentation broth that is clarified. Clarification can be achieved in many ways such as commonly known filtration, centrifugation, or precipitation techniques. In some embodiments further downstream processing steps are applied to for instance further concentrate the protein content in the clarified broth. Where the fermentation broth contains a bioactive protein, the further downstream processing steps can be optimized to increase the concentration of said bioactive protein. Common downstream process steps for concentrating the protein content include filtration, chromatography steps or a combination thereof.

In one embodiment the microbial fermentation broth (optionally supplemented with co-formulants) is directly spray-dried and agglomerated without first being processed by for example centrifugation or filtration steps. In another embodiment the microbial fermentation broth is first clarified prior to being spray-dried and agglomerated. In yet another embodiment the microbial fermentation broth undergoes further concentration steps by for example filtration steps. In yet another embodiment the microbial fermentation broth undergoes one or more downstream process steps to increase the protein concentration and/or increase the protein purity of the bioactive protein of interest that may be contained in the microbial fermentation broth. In a preferred embodiment the microbial fermentation broth is first clarified and subsequently concentrated by one or more filtration steps prior to spray agglomeration process. In a most preferred embodiment co-formulants are added to the microbial fermentation broth to obtain an aqueous liquid composition that can be agglomerated according to the invention. For example, a microbial fermentation can be obtained from a Pichia pastoris culture grown under standard fermentation conditions and expressing for example a 15 kDA sized bioactive protein and where the nucleotide encoding the protein-based biocontrol is under the control of a methanol inducible AOX or FMD promoter. Standard methods can be used such as taught by Methods in Molecular Biology, vol. 389: Pichia Protocols, Second Edition Edited by: J. M. Cregg. At the end of the fermentation the Pichia pastoris cells are removed by for example a centrifugation after which the filtrate is passed over a high molecular weight filter to remove larger proteins and other molecules left behind after the centrifugation step. Thereafter the filtrate can be passed over a small molecular weight filter to increase the concentration of the protein of interest in the retentate. The retentate or concentrated broth can then be further processed as described herein. In any case the microbial fermentation broth will still contain dry matter such as defined herein and where the dry matter comprises a bioactive protein. Microbial fermentation reactions will invariably contain dry matter which consists of non-relevant process-related components originating from the host cells (for example Pichia pastoris) such as host cell proteins, carbohydrates and lipids, from the culture medium and used process aids. A typical fermentation reaction in Pichia pastoris producing a bioactive protein such as an immunoglobulin single variable domain and where the immunoglobulin single variable domain was purified and concentrated using several filtration techniques, the resulting microbial fermentation broth can contain over 5% w/w of dry matter. In some examples dry matter content of the microbial fermentation broth can be up to 10% w/w or more or even 15% w/w or more. In a preferred embodiment the dry matter content of the microbial fermentation broth can be up to 25% w/w or more. In an even more preferred embodiment, the dry matter content of the microbial fermentation broth can be up to 40% w/w or more. In a most preferred embodiment, the dry matter content of the microbial fermentation broth may be around 50% w/w.

It is understood that the microbial fermentation as set out above may be performed with any microbial cell. Preferably the microbial fermentation as set out above is performed with a microbial cell that may be genetically adapted to express a bioactive protein. In preferred embodiments the microbial fermentation reaction is performed using one or more of the species selected from Pichia pastoris, Trichoderma reesei, Aspergillus niger, Aspergillus nidulans, Myceliophthora thermophila, Myceliophthora heterothallica, Bacillus subtilis and Bacillus licheniformis. In a preferred embodiment the microbial host cell used to perform the microbial fermentation that is processed into the agglomerates according to the current invention is Pichia pastoris (aka Komagataella phaffii). In another preferred embodiment the microbial host cell used to perform the microbial fermentation that is processed into the agglomerates according to the current invention is a Trichoderma reesei. In another preferred embodiment the microbial host cell used to perform the microbial fermentation that is processed into the agglomerates according to the current invention is Bacillus licheniformis. In another preferred embodiment the microbial host cell used to perform the microbial fermentation that is processed into the agglomerates according to the current invention is Bacillus subtilis. To specify the microbial cell performing the microbial fermentation It is said that the microbial fermentation may be, for example, a Pichia pastoris fermentation, to indicate that the microbial fermentation is performed by Pichia pastoris microbial cells. Or, for example a Bacillus licheniformis fermentation, to indicate the microbial fermentation is performed by Bacillus licheniformis microbial cells. In more preferred embodiments, said microbial cells are modified to express a bioactive protein, such as a VHH and whereby the microbial fermentation results in the production of dry matter.

Additionally, the water content of the microbial fermentation broth or liquid composition can be decreased further by concentration through evaporation. In some embodiments the microbial fermentation broth or liquid composition can thus be further concentrated prior to being spray-dried, also referred to as a pre-concentration step or pre-concentrating or up concentration. When a microbial fermentation broth or liquid composition is concentrated, the concentration of solid components increases. This may be beneficial to the agglomeration process. In some embodiments the microbial fermentation broth or liquid composition is concentrated 2-fold. In more preferred embodiments the microbial fermentation broth or liquid composition is concentrated 4-fold. In other embodiments the microbial fermentation broth or liquid composition is concentrated to an even higher level, the skilled person will understand that the limit for concentration is also dependent on the viscosity of the microbial fermentation broth or liquid composition and its ability to be sprayed as well as that concentrating the microbial fermentation broth or liquid composition too much may in some cases lead to the precipitation of certain compounds in the microbial fermentation broth or liquid composition. In some embodiments the microbial fermentation broth or liquid composition is concentrated by heating in a vessel to allow evaporation of part of the water content. In some embodiments the microbial fermentation broth or liquid composition is heated to a temperature in the range of 50° C. and 120° C. In more preferred embodiments the microbial fermentation broth or liquid composition is concentrated by subjecting the vessel holding the microbial fermentation broth or liquid composition to a pressure lower than the atmospheric pressure. In some embodiments the pressure in the vessel holding the microbial fermentation broth or liquid composition is below 101325 Pa. In some embodiments the pressure in the vessel holding the microbial fermentation broth or liquid composition is in the range of 101325 pa and 100 Pa. In some embodiments the pressure in the vessel holding the microbial fermentation broth or liquid composition is in the range of 100 Pa and 0.1 Pa. In other embodiments the pressure in the vessel holding the microbial fermentation broth or liquid composition is below 0.1 Pa. In a preferred embodiment the pressure in the vessel holding the microbial fermentation broth or liquid composition is in the range of 5.000 and 50.000 Pa. In preferred embodiments the microbial fermentation broth or liquid composition is heated whilst being subjected to a lower pressure, allowing for a decreased temperature to be used. In some embodiments the microbial fermentation broth or liquid composition is heated to in the range of 20° C. and 80° C. and with a pressure in the vessel holding the microbial fermentation broth or liquid composition of below 101325 Pa. In a more preferred embodiment, the microbial fermentation broth or liquid composition is heated to in the range of 40° C. and 50° C. with a pressure in the vessel holding the microbial fermentation broth or composition in the range of 5.000 and 50.000 Pa. In some embodiments the concentration step is performed with the aqueous liquid composition i.e. after the addition of co-formulants to the microbial fermentation broth. In a more preferred embodiment concentration is performed before co-formulants are added to the microbial fermentation broth. In a most performed embodiment, the microbial fermentation broth or is further concentrated right after the fermentation and filtration steps.

Any methods comprising or requiring the culturing or fermentation of the modified microbial host cell comprise the culture or fermentation of the host cell in a suitable medium.

“Culturing”, “cell culture”, “fermentation”, “fermenting” or “microbial fermentation” as used herein includes suspending the microbial cell in a broth or growth medium, providing sufficient nutrients including but not limited to one or more suitable carbon source (including glucose, sucrose, fructose, lactose, Avicel®, xylose, galactose, ethanol, methanol, or more complex carbon sources such as molasses or wort), nitrogen source (such as yeast extract, peptone or beef extract), trace element (such as iron, copper, magnesium, manganese or calcium), amino acid or salt (such as sodium chloride, magnesium chloride or natrium sulfate) or a suitable buffer (such as phosphate buffer, succinate buffer, HEPES buffer, MOPS buffer or Tris buffer). Optionally it includes one or more inducing agents driving expression of the compound of interest or a compound involved in the production of the compound of interest (such as lactose, avicel, IPTG, ethanol, methanol, sophorose or sophorolipids). If can also further involve the agitation of the culture media via for example stirring of purging to allow for adequate mixing and aeration. It can further involve different operational strategies such as batch cultivation, semi-continuous cultivation or continuous cultivation and different starvation or induction regimes according to the requirements of the microbial cell and to allow for an efficient production of the compound of interest or a compound involved in the production of the compound of interest. Alternatively, the microbial cell is grown on a solid substrate in an operational strategy commonly known as solid state fermentation.

A microbial cell is defined here as a single cellular organism used during a fermentation process or during cell culture. Preferably, a microbial cell is selected from the kingdom Fungi. In particular, the fungus may be a filamentous fungus.

The fungi may preferably be from the division Ascomycota, subdivision Pezizomycotina. In some embodiments, the fungi may preferably from the Class Sordariomycetes, optionally the Subclass Hypocreomycetidae. In some embodiments, the fungi may be from an Order selected from the group consisting of Hypocreales, Microascales, Eurotiales, Onygenales and Sordariales. In some embodiments, the fungi may be from a Family selected from the group consisting of Hypocreaceae, Nectriaceae, Clavicipitaceae and Microascaceae. In some more specific embodiments, the fungus may be from a Genus selected from the group consisting of Trichoderma (anamorph of Hypocrea), Myceliophthora, Fusarium, Gibberella, Nectria, Stachybotrys, Claviceps, Metarhizium, Villosiclava, Ophiocordyceps, Cephalosporium, Rasamsonia, Neurospora, and Scedosporium. In some further and more specific embodiments, the fungi may be selected from the group consisting of Trichoderma reesei (Hypocrea jecorina), T. citrinoviridae, T. longibrachiatum, T. virens, T. harzianum, T. asperellum, T. atroviridae, T. parareesei, Fusarium oxysporum, F. gramineanum, F. pseudograminearum, F. venenatum, Gibberella fujikuroi, G. moniliformis, G. zeaea, Nectria (Haematonectria) haematococca, Stachybotrys chartarum, S. chlorohalonata, Claviceps purpurea, Metarhizium acridum, M. anisopliae, Villosiclava virens, Ophiocordyceps sinensis, Neurospora crassa, Rasamsonia emersonii, Acremonium (Cephalosporium) chrysogenum, Scedosporium apiospermum, Aspergillus niger, A. awamori, A. oryzae, Chrysosporium lucknowense, Myceliophthora thermophila, Myceliophthora heterothallica, Humicola insolens, and Humicola grisea, most preferably Trichoderma reesei. If the host cell is a Trichoderma reesei cell, it may be selected from the following group of Trichoderma reesei strains obtainable from public collections: QM6a, ATCC13631; RutC-30, ATCC56765; QM9414, ATCC26921, RL-P37 and derivatives thereof. If the host cell is a Myceliophthora heterothallica, it may be selected from the following group of Myceliophthora heterothallica or Thermothelomyces thermophilus strains: CBS 131.65, CBS 203.75, CBS 202.75, CBS 375.69, CBS 663.74 and derivatives thereof. If the host cell is a Myceliophthora thermophila it may be selected from the following group of Myceliophthora thermophila strains ATCC42464, ATCC26915, ATCC48104, ATCC34628, Thermothelomyces heterothallica C1, Thermothelomyces thermophilus M77 and derivatives thereof. If the host cell is an Aspergillus nidulans it may be selected from the following group of Aspergillus nidulans strains: FGSC A4 (Glasgow wild-type), GR5 (FGSC A773), TN02A3 (FGSC A1149), TN02A25, (FGSC A1147), ATCC 38163, ATCC 10074 and derivatives thereof.

In particular, the fungus may be a yeast cell. The yeast may be selected from the group consisting of Pichia (also known as Komagataella), Candida, Torulopsis, Arxula, Hansenula, Yarrowia, Kluyveromyces and Saccharomyces. The microbial cell may preferably be from the division Ascomycota. The microbial cell may be selected from the group consisting of Pichia (also known as Komagataella), Candida, Torulopsis, Arxula, Hansenula, Yarrowia, Kluyveromyces and Saccharomyces. More preferably, the microbial host cell may be from the Pichia genus (also known as Komagataella), such as P. pastoris, P. farinose, P. anomala, P. heedii, P. guilliermondii, P. kluyveri, P. membranifaciens, P. norvegensis, P. ohmeri, P. methanolica and P. subpelliculosa. Most preferably, the microbial cell may be Pichia Pastoris (also known as Komagataella phaffii).

In some embodiments the microbial cell is selected from the kingdom Bacteria. In particular, the Bacteria may be selected from the group consisting of Escherichia coli (E. coli) such as BL21, DH5a, and others, Bacillus species, Pseudomonas species, Corynebacterium species, Streptomyces species, Lactococcus species, Shigella species, Streptococcus species, Neisseria species, Geobacillus species, Bifidobacterium species, Azotobacter species, Bordetella species, Lactobacillus species, Staphylococcus species. The microbial cell may preferably be a bacillus species such as Bacillus alkalophilus, Bacillus circulans, Bacillus clausii, Bacillus coagulans, Bacillus firmus, Bacillus lautus, Bacillus lentus, Bacillus pumilus, Bacillus amyloliquefaciens, Bacillus thuringiensis, Bacillus megaterium, Bacillus halodurans or Bacillus stearothermophilus, Bacillus brevis, Bacillus subtilis or Bacillus licheniformis. In a more preferred aspect the bacterial species is a Bacillus subtilis or Bacillus licheniformis, for example but not limited to Bacillus subtilis 168, Bacillus subtilis 168 marburg (DSM 347), Bacillus subtilis WB800, Bacillus subtilis PY79, Bacillus subtilis CU1065, Bacillus subtilis ATCC 6633, Bacillus subtilis 168 W23, Bacillus subtilis 6051-HGW, Bacillus subtilis 3610, Bacillus licheniformis DSM 13 Bacillus licheniformis ATCC 14580, Bacillus licheniformis NRRL B-14393, Bacillus licheniformis DSM 8785, Bacillus licheniformis ATCC 9945A, Bacillus licheniformis ATCC 14875, Bacillus licheniformis SL-208 or Bacillus licheniformis T5.

In some embodiments the concentrated broth may be further supplemented with a preservative. Preservatives may be added to the liquid composition to prevent spoilage of the material due to microbiological contamination. Common examples of preservatives are the chemicals citric acid monohydrate, potassium sorbate and unbranched C3 to C10 alkanediol such as described in EP3824733A and commercially available from Minafin sprl under the commercial name Sovinol P740/0 and Sovinol P850. In preferred embodiments, the liquid composition further comprises the preservative Potassium Sorbate. In another preferred embodiment, the liquid composition further comprises the preservative citric acid monohydrate. The preservative is mainly needed for stability of the liquid composition during storage, the preservative has limited use in the agglomerates of this invention, since the low water content of the agglomerates will prevent microbial spoilage. Thus, in more preferred embodiments no preservative is added, but the concentrated broth is further processed into the liquid composition and spray dried or agglomerated according to this invention without intermittent storage

In some embodiments the concentrated broth further comprises a buffering agent. Buffering agents are used to stabilize the pH of solution such as a concentrated broth. They are typically composed of weak acids and bases mixed in an aqueous solution. Common examples of buffering agents are phosphate buffers or HEPES buffers. In a preferred embodiment citric acid monophosphate is used as a buffering agent. The buffering agents can be added during the concentration steps of the fermentation broth or during any step of the fermentation, concentration or preparation of the aqueous liquid composition for spray drying and agglomeration.

The skilled person will understand that compounds added during fermentation or any further steps after fermentation will also be present in the final agglomerate unless they are removed by for instance evaporation or a dialysis step.

### [Agrochemical Composition]

In a further aspect, the present invention provides the use of the agglomerates as disclosed herein as plant protection agent or anti-pest agent. In a further aspect, there is provided use of the agglomerates in a method of preventing or treating an infection of a plant or plant parts from with a plant pathogenic pest. More specifically the bioactive protein present in the agglomerates of this invention may serve as an active ingredient of the plant protection product. Therefore, the agglomerates of this invention may be used as a plant protection product. In particular embodiments, the anti-pest agent is a biostatic agent, a fungistatic agent, an insect static agent, a pesticidal agent, a fungicidal agent, and/or an insecticidal agent. In yet a further aspect, the present invention provides methods of inhibiting the growth of a plant pathogen or methods of killing a plant pathogen, the methods comprising at least the step of applying to a plant or to a part of the plant, the agglomerates as disclosed herein. The method may include dissolving the agglomerates in a suitable volume of water. Dissolving the agglomerates of this invention in a suitable volume of water leads to a composition suitable for use on plants or crops, such a composition is herein referred as an agrochemical composition. The agglomerates of the invention may be dissolved in water prior to being applied to a crop or plant or part thereof as an agrochemical composition. The agglomerates of the invention can be mixed with water at a rate such that a desired final concentration of the bioactive protein is achieved. The skilled person will know that this is dependent on the load of the agglomerates. An agrochemical composition may not be composed solely of the agglomerates of this invention dissolved in a suitable quantity of water. That is to say, tank additives may be added to the agrochemical composition which may improve the performance. In some embodiments of the invention the agglomerates are added to a suitable quantity of water in for example a receptacle such as spray tank. In another embodiment tank additives are added to a suitable quantity of water together with the agglomerates. In some embodiments the tank additives may be selected from, but are not limited to, one or more of adjuvants, fertilizers, biostimulants, and/or plant growth regulators. In some embodiments the agglomerates are added to a suitable quantity of water in a receptacle and where the dissolution is facilitated by mixing. Optionally, the agglomerates are first allowed to settle in the water before mixing is started. In some embodiments the receptacle, such as a spray tank. continuously mixes the agrochemical composition during application of the agrochemical composition on crops or plants or parts thereof.

In particular embodiments, the agrochemical compositions as disclosed herein are directly or indirectly applied to the plant or to a part of the plant by spraying, atomizing, foaming, fogging, culturing in hydroculture, culturing in hydroponics, coating, submerging, and/or encrusting, optionally post-harvest.

In particular embodiments, the methods for protecting or treating a plant or a part of a plant from an infection or other biological interaction with a plant pathogen as disclosed herein, comprises applying the agrochemical composition directly or indirectly to the plant or to a part of the plant either in a pre-harvest or in a post-harvest stage. According to specific embodiments, the harvested produce is a fruit, flower, nut or vegetable, a fruit or vegetable with inedible peel, preferably selected from avocados, bananas, plantains, lemons, grapefruits, melons, oranges, pineapples, kiwi fruits, guavas, mandarins, mangoes and pumpkin, and peaches, in particular bananas. According to further specific embodiments, the harvested produce is a cut flower from ornamental plants, preferably selected from Alstroemeria, Carnation, Chrysanthemum, Freesia, Gerbera, Gladiolus, baby's breath (Gypsophila spec), Helianthus, Hydrangea, Lilium, Lisianthus, roses and summer flowers. The plant species to which the agrochemical compositions as disclosed herein can be applied can for example be but are not limited to maize, soya bean, alfalfa, cotton, sunflower, Brassica oil seeds such as Brassica napus (e.g. canola, rape-seed), Brassica rapa, B. juncea (e.g. (field) mustard) and Brassica carinata, Arecaceae sp. (e.g. oilpalm, coconut), rice, wheat, sugar beet, sugar cane, oats, rye, barley, millet and sorghum, triticale, flax, nuts, grapes and vine and various fruit and vegetables from various botanic taxa, e.g. Rosaceae sp. (e.g. pome fruits such as apples and pears, but also stone fruits such as apricots, cherries, almonds, plums and peaches, and berry fruits such as strawberries, raspberries, red and black currant and gooseberry), Ribesioidae sp., Juglandaceae sp., Betulaceae sp., Anacardiaceae sp., Fagaceae sp., Moraceae sp., Oleaceae sp. (e.g. olive tree), Actinidaceae sp., Lauraceae sp. (e.g. avocado, cinnamon, camphor), Musaceae sp. (e.g. banana trees and plantations), Rubiaceae sp. (e.g. coffee), Theaceae sp. (e.g. tea), Sterculiceae sp., Rutaceae sp. (e.g. lemons, oranges, mandarins and grapefruit); Solanaceae sp. (e.g. tomatoes, potatoes, peppers, capsicum, aubergines, tobacco), Liliaceae sp., Compositae sp. (e.g. lettuce, artichokes and chicory including root chicory, endive or common chicory), Umbelliferae sp. (e.g. carrots, parsley, celery and celeriac), Curbitaceae sp. (e.g. cucumbers—including gherkins, pumpkins, watermelons, calabashes and melons), Alliaceae sp. (e.g. leeks and onions), Cruciferae sp. (e.g. white cabbage, red cabbage, broccoli, cauliflower, Brussels sprouts, pak choi, kohlrabi, radishes, horseradish, cress and Chinese cabbage), Leguminosae sp. (e.g. peanuts, peas, lentils and beans—e.g. common beans and broad beans), Chenopodiaceae sp. (e.g. Swiss chard, fodder beet, spinach, beetroot), Linaceae sp. (e.g. hemp), Cannabeacea sp. (e.g. cannabis), Malvaceae sp. (e.g. okra, cocoa), Papaveraceae (e.g. poppy), Asparagaceae (e.g. asparagus); useful plants and ornamental plants in the garden and woods including turf, lawn, grass and Stevia rebaudiana; and in each case genetically modified types of these plants.

In a preferred embodiment of the treatment methods with the agrochemical composition, the crop is selected from the group consisting of field crops, grasses, fruits and vegetables, lawns, trees and ornamental plants. In certain aspects, the present invention thus also provides post-harvest treatment methods for protecting or treating a harvested plant or a harvested part of the plant from an infection or other biological interaction with a plant pathogen, at least comprising the step of applying directly or indirectly to the harvested plant or to a harvested part of the plant, an agrochemical composition as disclosed herein, under conditions effective to protect or treat the harvested plant or a harvested part of the plant against the infection or biological interaction with the plant pathogen. According to specific embodiments, the harvested produce is a fruit, flower, nut or vegetable, a fruit or vegetable with inedible peel, preferably selected from avocados, bananas, plantains, lemons, grapefruits, melons, oranges, pineapples, kiwi fruits, guavas, mandarins, mangoes and pumpkin, and peaches. According to further specific embodiments, the harvested produce is a cut flower from ornamental plants, preferably selected from Alstroemeria, Carnation, Chrysanthemum, Freesia, Gerbera, Gladiolus, baby's breath (Gypsophila spec), Helianthus, Hydrangea, Lilium, Lisianthus, roses and summer flowers. According to further specific embodiments, the harvested produce is cut grass or wood. Post-harvest disorders are e.g. lenticel spots, scorch, senescent breakdown, bitter pit, scald, water core, browning, vascular breakdown, C02 injury, C02 or 02 deficiency, and softening. Fungal diseases may be caused for example by the following fungi: Mycosphaerella spp., Mycosphaerella musae, Mycosphaerella frag a ae, Mycosphaerella citri; Mucor spp., e.g. Mucor piriformis; Monilinia spp., e.g. Monilinia fructigena, Monilinia laxa; Phomopsis spp., Phomopsis natalensis; Colletotrichum spp., e.g. Colletotrichum musae, Colletotrichum gloeosporioides, Colletotrichum coccodes; Verticillium spp., e.g. Verticillium theobromae; Nigrospora spp.; Botrytis spp., e.g. Botrytis cinerea; Diplodia spp., e.g. Diplodia citri; Pezicula spp.; Alternaria spp., e.g. Alternaria citri, Alternaria alternata; Septoria spp., e.g. Septoria depressa; Venturia spp., e.g. Venturia inaequalis, Venturia pyrina; Rhizopus spp., e.g. Rhizopus stolonifer, Rhizopus oryzae; Glomerella spp., e.g. Glomerella cingulata; Sclerotinia spp., e.g. Sclerotinia fruiticola; Ceratocystis spp., e.g. Ceratocystis paradoxa; Fusarium spp., e.g. Fusarium semitectum, Fusarium moniliforme, Fusarium solani, Fusarium oxysporum; Cladosporium spp., e.g. Cladosporium fulvum, Cladosporium cladosporioides, Cladosporium cucumerinum, Cladosporium musae; Penicillium spp., e.g. Penicillium funiculosum, Penicillium expansum, Penicillium digitatum, Penicillium italicum; Phytophthora spp., e.g. Phytophthora citrophthora, Phytophthora fragariae, Phytophthora cactorum, Phytophthora parasitica; Phacydiopycnis spp., e.g. Phacydiopycnis malirum; Gloeosporium spp., e.g. Gloeosporium album, Gloeosporium perennans, Gloeosporium fructigenum, Gloeosporium singulata; Geotrichum spp., e.g. Geotrichum candidum; Phlyctaena spp., e.g. Phlyctaena vagabunda; Cylindrocarpon spp., e.g. Cylindrocarpon mail; Stemphyllium spp., e.g. Stemphyllium vesica um; Thielaviopsis spp., e.g. Thielaviopsis paradoxy; Aspergillus spp., e.g. Aspergillus niger, Aspergillus carbonarius; Nectria spp., e.g. Nectria galligena; Cercospora spp., e.g. Cercospora angreci, Cercospora apii, Cercospora atrofiliformis, Cercospora musae, Cercospora zeae-maydis. In further aspects, the present invention provides uses of the agrochemical compositions as disclosed herein as an anti-pest agent, such as for instance a biostatic agent or a pesticidal agent, including but not limited to, a fungistatic agent, an insect static agent, a pesticidal agent, a fungicidal agent, and/or an insecticidal agent “Crop” as used herein means a plant species or variety that is grown to be harvested as food, livestock fodder, fuel raw material, or for any other economic purpose. As a non-limiting example, said crops can be maize, cereals, such as wheat, rye, barley and oats, sorghum, rice, sugar beet and fodder beet, fruit, such as pome fruit (e.g. apples and pears), citrus fruit (e.g. oranges, lemons, limes, grapefruit, or mandarins), stone fruit (e. g. peaches, nectarines or plums), nuts (e.g. almonds or walnuts), soft fruit (e.g. cherries, strawberries, blackberries or raspberries), the plantain family or grapevines, leguminous crops, such as beans, lentils, peas and soya, oil crops, such as sunflower, safflower, rapeseed, canola, castor or olives, cucurbits, such as cucumbers, melons or pumpkins, fibre plants, such as cotton, flax or hemp, fuel crops, such as sugarcane, miscanthus or switchgrass, vegetables, such as potatoes, tomatoes, peppers, lettuce, spinach, onions, carrots, egg-plants, asparagus or cabbage, ornamentals, such as flowers (e.g. petunias, pelargoniums, roses, tulips, lilies, or chrysanthemums), shrubs, broad leaved trees (e.g. poplars or willows) and evergreens (e.g. conifers), grasses, such as lawn, turf or forage grass or other useful plants, such as coffee, tea, tobacco, hops, pepper, rubber or latex plants.

A “pest”, as used here, is an organism that is harmful to plants, animals, humans or human concerns, and includes, but is not limited to crop pests (as later defined), household pests, such as cockroaches, ants, etc., and disease vectors, such as malaria mosquitoes.

A “plant pest”, “plant pathogen” or “crop pest”, as used in the application interchangeably, refers to organisms that specifically cause damage to plants, plant parts or plant products, particularly plants, plant parts or plant products, used in agriculture. Note that the term “plant pest” or “crop pest” is used in the meaning that the pest targets and harms plants. Pests particularly belong to invertebrate animals (e.g. insects (including agricultural pest insects, insect pests of ornamental plants, insect pests of forests). Relevant crop pest examples include, but are not limited to, aphids, caterpillars, flies, wasps, and the like, nematodes (living freely in soil or particularly species that parasitize plant roots, such as root-knot nematode and cyst nematodes such as soybean cyst nematode and potato cyst nematode), mites (such as spider mites, thread-footed mites and gall mites) and gastropods (including slugs such as Deroceras spp., Milax spp., Tandonia sp., Limax spp., Arion spp. and Veronicella spp. and snails such as Helix spp., Cernuella spp., Theba spp., Cochlicella spp., Achatina spp., Succinea spp., Ovachlamys spp., Amphibulima spp., Zachrysia spp., Bradybaena spp., and Pomacea spp.), pathogenic fungi (including Ascomycetes (such as Fusarium spp., Thielaviopsis spp., Verticillium spp., Magnaporthe spp.), Basidiomycetes (such as Rhizoctonia spp., Phakospora spp., Puccinia spp.), and fungal-like Oomycetes (such as Pythium spp. and Phytophthora spp.), bacteria (such as Burkholderia spp. and Proteobacteria such as Xanthomonas spp. and Pseudomonas spp.), Phytoplasma, Spiroplasma, viruses (such as tobacco mosaic virus and cauliflower mosaic virus), and protozoa.

“Microbe”, as used herein, means bacterium, virus, fungus, yeast and the like and “microbial” means derived from a microbe.

“Fungus”, as used herein, means a eukaryotic organism, belonging to the group of Eumycota. The term fungus in the present invention also includes fungal-like organisms such as the Oomycota. Oomycota (or oomycetes) form a distinct phylogenetic lineage of fungus-like eukaryotic microorganisms. This group was originally classified among the fungi but modern insights support a relatively close relationship with the photosynthetic organisms such as brown algae and diatoms, within the group of heterokonts.

“Pest infection” or “pest disease” as used herein refers to any inflammatory condition, disease or disorder in a living organism, such as a plant, animal or human, which is caused by a pest.

“Fungal infection” or “fungal disease” as used herein refers to any inflammatory condition, disease or disorder in a living organism, such as a plant, animal or human, which is caused by a fungus. The plant pathogenic pest disclosed herein may be a fungus.

### EXAMPLES

The present invention will now be illustrated by way of the following non-limiting Examples.

Statements (features) and embodiments of the methods and compositions as disclosed herein are set out below. Each of the statements and embodiments as disclosed by the invention so defined may be combined with any other statement and/or embodiment unless clearly indicated to the contrary. In particular, any feature indicated as being preferred or advantageous may be combined with any other feature or features indicated as being preferred or advantageous.

### Example 1: Run 1

### 1.1: Immunoglobulin Single Variable Domain

As a specific example of an immunoglobulin single variable domain or VHH having the following sequence was used:

(SEQ ID NO: 1)
DVQLVESGGGLVQAGGSLRLSCAASRSIFSINAMDWYRQAPGKQREWVA
GITRGGTTKYADSVKGRFTISRDNAKKKVYLQMNSLKPEDTAVYYCNVL
RGEQPWTRDYWGQGTQVTVSS

### 1.2: Fermentation

The agricultural composition was prepared using standard microbial fermentation techniques using yeast such as Pichia pastoris for expression of a protein based bioactive (in this example a VHH with SEQ ID NO 1) under the control of a methanol inducible AOX 1 promoter. Guidance to performing standard microbial fermentations can be found in Methods in Molecular Biology, vol. 389: Pichia Protocols, Second Edition Edited by: J. M. Cregg. The resulting fermentation broth was then subjected to one or more filtration or centrifugation steps to remove large and intact cellular material or larger complexes from the broth. The resulting clarified broth was then further concentrated by filtration by using a filter having a cut-off size smaller than the protein based bioactive. During filtrating steps citrate buffer was used so that the pH of the resulting fermentation broth is stabilized in the range of pH 5-7. The resulting retentate containing the fermentation broth contained an amount of dry matter of approximately 8.49% w/w with a concentration of the bioactive protein of interest of approximately 3.12% w/w of VHH with SEQ ID NO 1.

### 1.3: Formulation of the Liquid Composition

In a large mixing receptacle Break-Thru S301 (at 126.3 gram per liter DI water or 12.6% w/w) and Brij 020 (at 126.3 gram per liter DI water or 12.6% w/w) were added to 9.40 liter of deionized (DI) water and stirred at 1000 rpm using a mixer with a mixing rod. Hereafter Antifoam AFE 1530 was added at 20.4 gram per liter DI water under continuous stirring at 1000 rpm. This mixture was added to 100 liter of fermentation broth as described in paragraph 1.2 while mixing at a low speed. Next, a further 42.0 g/l of buffer agent tri-sodium citrate dihydrate was added and mixed until fully dissolved. Finally, 10.2 g/l of Sipernat 50S was added and mixed until fully dissolved.

### 1.4: Agglomeration Process

The resulting liquid composition described in paragraph 1.3 was then spray-dried using a fluid bed granulator. During this step in the process, the liquid composition was continuously mixed at low speed to avoid sedimentation. The nozzle was mounted above the fluidized bed. Ambient air was used for fluidization at a flow rate of 1200 m³/h. Continuous extraction of agglomerates was realized by a horizontal screw conveyor which was mounted directly into the fluidized bed reactor. Airflow was started and air inlet temperature was slowly increased. The liquid pump started slower than the setpoint for the spray rate: 10-15 L/h, then gradually increased to 18 L/h. At the same time air inlet temperature was increased gradually until the target product bed temperature of max. 63° C. was reached. The product bed temperature did not decrease. This process continues until about 20 l/h spray rate was achieved. This can take up to 6 hours on large scale.

When the target spray rate was reached, the extraction screw was activated. Once the fluidized bed was stabilized, the process can continue without large changes to the parameters for the remainder of the production. The extraction screw was positioned at the bottom of the granulator, where the heaviest agglomerates reside. Heavy agglomerates were caught by the extraction screw and extracted from the vessel. The extraction rate was about equal to the amount of dry solids in the liquid composition that were sprayed into the granulator per unit of time. The discharged product was sieved at 150 μm and at 400 μm. The undersized fraction smaller than 150 μm was recycled into the granulator. The lighter particles are forced to the top of the fluidized bed, closer to the spray nozzle. Here additional liquid composition was sprayed onto the fluidized bed. The liquid composition contacts the lighter particles, making them heavier. At the end of the process, the remaining small particle dust can be collected and optionally re-used for another batch. The agglomerates (or oversized fraction) was collected in separate bags. The full parameters of this agglomeration run are listed in Table 1 below.

TABLE 1
process parameters of example 1.

| Parameter | Setpoint |
|---|---|
| Air inlet temperature (° C.) | 90-97 |
| Product bed temperature (° C.) | 58-63 |
| Inlet air flow (m³/h) | 1200 |
| Spray rate (l/h) | 20--24 h |
| Atomization air pressure (bar) | 2 |
| Extraction rate (kg/h) | 2 |
| Product residence time (h) | 2-3 |

### 1.5: Analysis of Agglomerates

The obtained agglomerates were analyzed using a Camsizer from Retsch GmbH. The agglomerates showed a raspberry shape with an average particle size diameter d50 of 396 μm and a SPHT3 value of 0.818. Dissolution was tested using the standard CIPAC MT 179 method as described. The agglomerates dissolved within 60 seconds leaving 1.36% of residue. The bulk density was measured by filling a 250 ml measuring cylinder with agglomerates up to the 100 mL mark and weighing the agglomerates and the cylinder. The weight of the cylinder was subtracted from the total weight. The bulk density is calculated by dividing the weighed mass of the agglomerate by the product volume within the cylinder. The bulk density of the agglomerates was 649 g/L in this run. The total amount of dry soluble matter was determined by weighing about 2 g of agglomerates in an infrared-dryer. Drying was performed at 105° C. for 15 minutes. The remaining mass after water evaporation was divided by the original mass, resulting in a relative dry solids-content (DS-content). The agglomerates in this run had a dry solids content of 95%. The wettability of the agglomerates was tested using the CIPAC MT 53.3 method as describe herein. The wettability stayed below 6 seconds. Finally, the integrity of the bioactive protein was analyzed. In this example, the bioactive protein was a VHH with SEQ ID NO:1, which was analyzed by Reverse Phase-HPLC. The main peak contributed 88.1% of the VHH content whereas a limited amount of post peaks (5.6%) and pre peaks (6.3%) were detected, see FIG. 2. Well within the specifications and indicates limited possible degradation of the bioactive protein during an industrial agglomeration process. The bioactive protein is stable in this formulation at 20° C. and 45° C. for at least 3 months. The parameters of analysis of the agglomerates in this example are summarized in Table 2.

TABLE 2
Parameters concerning the analysis of
the produced agglomerates in example 1.

| Parameter | Value | |
|---|---|---|
| Particle size diameter d50 | 396 | μm |
| SPHT3 (—) | 0.818 | |
| Dissolution (CIPAC MT 179) | 1.36% | |
| Bulk density | 649 | g/L |
| DS-content | 95% | |
| HPLC - VHH main peak | 88.1% | |
| HPLC - pre-peak | 6.3% | |
| HPLC - post-peak | 5.6% | |
| Wettability (CIPAC MT 53.3) | 6 | s |
| Stability at 20° C. | >3 | months |
| Stability at 45° C. | >3 | months |

### Example 2: Run 2

### 2.1: Immunoglobulin Single Variable Domain

As a specific example of an immunoglobulin single variable domain or VHH corresponding to SEQ ID NO: 1 was used

### 2.2: Fermentation

The fermentation and downstream purification steps were performed similarly to the protocol described in example 1.2. The resulting fermentation broth had a dry matter content of approximately 8.79% w/w with a concentration of the bioactive protein of interest of approximately 1.83% w/w of VHH with SEQ ID NO: 1.

### 2.3: Formulation of the Liquid Composition

In a large mixing receptacle Cellosize QP300 (at 8.75 gram per liter DI water or 0.87% w/w) and Attagel 50 (at 47.49 gram per liter DI water or 4.75% w/w) were added to 53 liter of Deionized water and stirred at 1000 rpm using a mixer with a mixing rod. Hereafter Tween 23 was added at 117.15 gram per liter DI water. Hereafter Antifoam AFE 1530 was added at 3.13 gram per liter DI water under continuous stirring at 1000 rpm. This mixture was added to 1000 liter of fermentation broth as described in paragraph 2.2 while mixing at a low speed. Next, a further 21.47 g/l of buffer agent tri-sodium citrate dihydrate was added and mixed until fully dissolved.

### 2.4: Agglomeration Process

The resulting liquid composition described in paragraph 2.3 was then spray-dried using a fluid bed granulator. The process was conducted similar to Example 1.4 with the full parameters of this agglomeration run listed in Table 3.

### 2.5: Rework of the Oversized Fraction

The oversized fraction resulting from the spray drying process described above in paragraph 2.4 can be recycled. The aqueous liquid composition was created by dissolving all oversized agglomerates in DI water at a 10% DS content. All components as described in paragraph 2.3 are present after full dissolution. If necessary, in this process step corrections with regard to active ingredient content can also be performed. After solubilization the agglomeration process was started and finished in a same manner as described in paragraph 2.4 with the process parameters described in Table 3.

TABLE 3
process parameters of example 2.

| Parameter | Setpoint |
|---|---|
| Air inlet temperature (° C.) | 90-95 |
| Product bed temperature (° C.) | 60-63 |
| Inlet air flow (m³/h) | 1200 |
| Spray rate (l/h) | 20-24 |
| Atomization air pressure (bar) | 4 |
| Extraction rate¹ (kg/h) | 2 |
| Product residence time (h) | 2-3 |

### 2.6: Analysis of Agglomerates

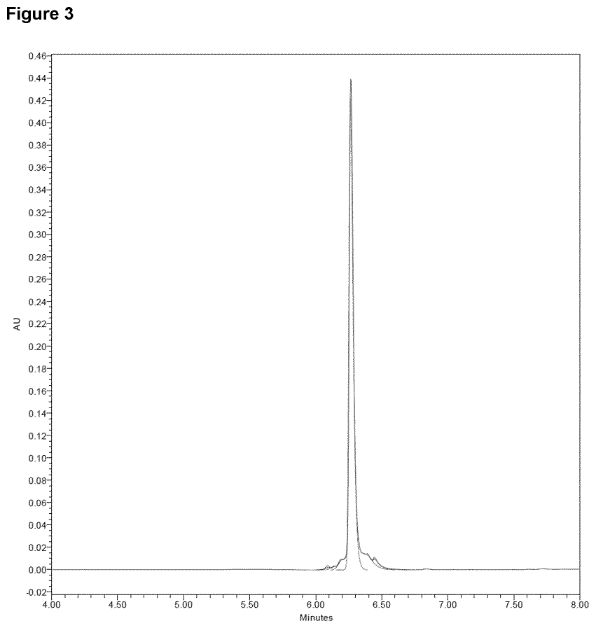

The obtained agglomerates were analysed using the same procedures as described in example 1.5. The resulting parameters of this analysis of the agglomerates of this example are summarized in Table 4. The chromatogram of the RPC analysis is shown in FIG. 3.

TABLE 4
Parameters for the analysis of the
agglomerates produced in example 2.

| Parameter | Value | |
|---|---|---|
| Particle size diameter d50 | 355 | μm |
| SPHT3 (—) | 0.842 | |
| Dissolution (CIPAC MT 179) | 0% | |
| Bulk density | 693 | g/L |
| DS-content | 96% | |
| HPLC - VHH main peak | 85.8% | |
| HPLC - pre-peak | 4.3% | |
| HPLC - post-peak | 9.9% | |
| Wettability (CIPAC MT 53.3) | 8 | s |
| Stability at 20° C. | >2 | years |
| Stability at 45° C. | >1 | year |

### Example 3: Run 3

### 3.1: Immunoglobulin Single Variable Domain

As a specific example of an immunoglobulin single variable domain or VHH corresponding to SEQ ID NO: 1 was used

### 3.2: Fermentation

The fermentation and downstream purification steps were performed similarly to the protocol described in example 1.2. The resulting fermentation broth contained an amount of dry matter of approximately 7.42% w/w with a concentration of the bioactive protein of interest of approximately 1.72% w/w of VHH with SEQ ID NO 1.

### 3.3: Formulation of the Liquid Composition

In a large mixing receptacle Cellosize QP300 (at 6.79 gram per liter DI water or 6.79% w/w) and Attagel 50 (at 37.74 gram per liter DI water or 3.77% w/w) were added to 0.265 liter of deionized water and stirred at 1000 rpm using a mixer with a mixing rod. Hereafter Tween 23 was added at 92.83 gram per liter DI water. Hereafter Antifoam AFE 1530 was added at 2.26 gram per liter DI water under continuous stirring at 1000 rpm. This mixture was added to 5 liter of fermentation broth as described in paragraph 3.2 while mixing at a low speed. Next, a further 6.60 g/l of buffer agent tri-sodium citrate dihydrate was added and mixed until fully dissolved. This mixture was prepared in 4 batches with the same recipe.

### 3.4: Agglomeration Process

The resulting aqueous liquid composition described in paragraph 3.3 was then spray-dried using a fluid bed granulator. During this step in the process, the aqueous liquid composition was continuously mixed at low speed to avoid sedimentation. The nozzle was mounted above the fluidized bed reactor. Ambient air was used for fluidization at a flow rate of 95-97 m³/h. Semi-continuous extraction of agglomerates was realized by manually operating the sample bore in the granulator which was mounted directly into the fluid bed. Airflow started and air inlet temperature was slowly increased. The pump started slower than the setpoint for the spray rate and increased gradually to 30 g/min. At the same time air inlet temperature was increased gradually until the target product bed temperature of the respective run was reached, see Table 5. This part of the process was shortened in run 3.4 by adding 100 g of agglomerates taken from a previous run and ground to a powder in the granulator. The agglomerates were extracted during the agglomeration process by manually operating the sample bore or at the end of the agglomeration process. The discharged product was sieved at 200 μm and 400 μm. The full parameters of these 4 agglomeration run are listed in Table 5.

TABLE 5
process parameters of the runs of example 3.

| Parameter | Run 3.1 | Run 3.2 | Run 3.3 | Run 3.4 |
|---|---|---|---|---|
| Air inlet temperature (° C.) | 93 | 106 | 110 | 99 |
| Product bed temperature (° C.) | 53 | 60 | 65 | 55 |
| Inlet air flow (m³/h) | 95 | 97 | 97 | 95 |
| Spray rate (l/h) | 1.8 | 1.8 | 1.8 | 1.8 |
| Atomization air pressure (bar) | 1.4 | 1.4 | 1.4 | 1.4 |

### 3.5: Analysis of Agglomerates

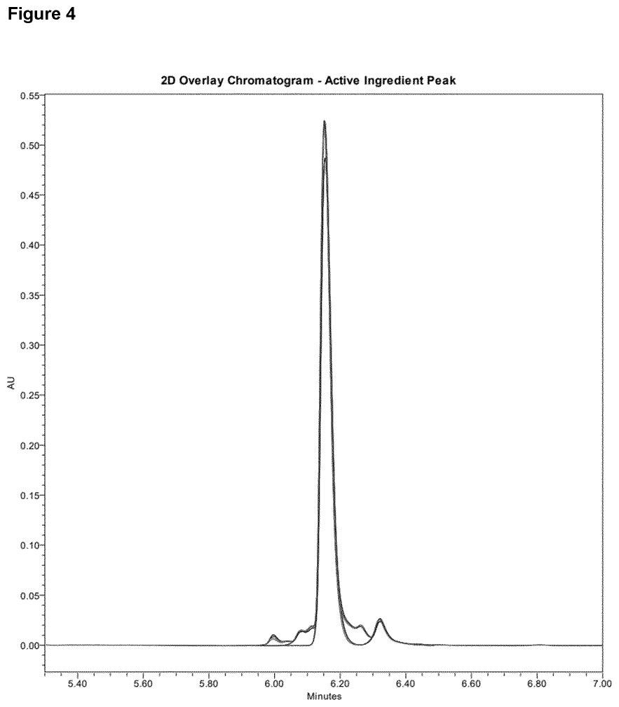

The obtained agglomerates were analysed using the same procedures as described in example 1.5. The resulting parameters of this analysis of the agglomerates of this example are summarized in Table 6 The chromatogram of the RPC analysis is shown in FIG. 4. The wettability parameter for these runs could be improved, although the created agglomerates are in practice still acceptable since the dissolution value is at 0% and since in practice stirring of agglomerates will occur wettability will be improved. Other factors may contribute to improving the wettability. For example here the inventors have found that in practice, removing the humectant based on an attapulgite clay (such as the here used Attagel 50) and adding an anti-caking agent based on a silicon dioxide (such as Sipernat 50s), greatly improves the overall wettability, solubility and dissolution of the agglomerates where the SPTH3 values are below 0.900 and the particle size diameter d50 is from 200 to 500 μm.

TABLE 6
Parameters for the analysis of the agglomerates
produced in the runs of example 3.

| Parameter | Run 3.1 | | Run 3.2 | | Run 3.3 | | Run 3.4 | |
|---|---|---|---|---|---|---|---|---|
| Particle size diameter d50 | 292 | | 266 | | 271 | | 335 | |
| SPHT3 (—) | 0.761 | | 0.785 | | 0.796 | | 0.829 | |
| Dissolution (CIPAC MT 179) | 0% | | 0% | | 0% | | 0% | |
| Bulk density | 630 | g/L | 640 | g/L | 670 | g/L | 690 | g/L |
| DS-content | 93% | | 94% | | 95% | | 93% | |
| HPLC - VHH main peak | 83.2% | | 83.0% | | 83.3% | | 83.1% | |
| HPLC - pre-peak | 5.4% | | 5.7% | | 5.8% | | 5.9% | |
| HPLC - post-peak | 11.4% | | 11.2% | | 11.0% | | 11.3% | |
| Wettability (CIPAC MT 53.3) | 85 | s | 68 | s | 94 | s | 94 | s |
| Stability at 20° C. | 2 | years | 2 | years | 2 | years | 2 | years |
| Stability at 45° C. | 1 | year | 1 | year | 1 | year | 1 | year |

### Example 4: Run 4

### 4.1: Immunoglobulin Single Variable Domain

As a specific example of an immunoglobulin single variable domain or VHH corresponding to SEQ ID NO: 1 was used

### 4.2: Fermentation

The fermentation and downstream purification steps were performed similarly to the protocol described in example 1.2. The resulting fermentation broth contained an amount of dry matter of approximately 8.49% w/w with a concentration of the bioactive protein of interest of approximately 3.18% w/w of VHH with SEQ ID NO 1.

### 4.3: Concentrating the Fermentation Broth Through Evaporation

One part of the obtained fermentation broth underwent an evaporation process step. In this setup, the dry solids content was increased from 8.49% to 22.23% after evaporation and addition of the co-formulants described in paragraph 4.4. Alternatively, co-formulants can first be added (already increasing the dry solids content) and then evaporation of excess water can be performed. Evaporation was performed in a heated vacuum container at 45° C. and a pressure in the vessel of 50-70 mbar. The concentrated broth was stirred continuously during evaporation. The final evaporation capacity was 1 kg water/hour. All parameters are summarized in Table 7.

TABLE 7
Summary of process parameters concerning evaporation
of excess liquid in the spray slurry within example 4

| Parameter | Setpoint | |
|---|---|---|
| Max. evaporation temperature | 45° | C. |
| Pressure inside the vessel | 50-70 | mbar |
| Evaporation capacity | 1 | kg water/h |

### 4.4: Formulation of the Liquid Composition

In a large mixing receptacle Break-Thru S301 (at 128.2 gram per liter DI water or 12.8% w/w) and Brij 020 (at 128.2 gram per liter DI water or 12.8% % w/w) were added to 1.88 liter of Deionized water and stirred at 1000 rpm using a mixer with a mixing rod. Hereafter Antifoam AFE 1530 was added at 20.7 gram per liter DI water under continuous stirring at 1000 rpm. This mixture was added to 20 liter of the fermentation broth as described in paragraph 4.2 while mixing at a low speed. Next, 55.5 g/l of buffer agent tri-sodium citrate dihydrate was added and mixed until fully dissolved. Finally, 16.5 g/l of Sipernat 50S was added and mixed until fully dissolved. For the fermentation broth processed as described in paragraph 4.3, the same ratios were added, but to 17.8 liter of the fermentation broth described in example 4.3.

### 4.5: Agglomeration Process

The resulting liquid compositions described in paragraph 4.4 were then spray-dried separately using a pilot scale fluid bed granulator. The liquid composition was stored in the spray tank of the fluid bed granulator. The nozzle was mounted above the fluidized bed. Ambient air was used for fluidization at a flow rate of 130 kg/h. Seeding material was provided in the form of ground agglomerates. Airflow was started and air inlet temperature was slowly increased. The pump feed rate was increased up to 20 g/min-25 g/min. The process ran in a batch-wise manner, resulting in long residence times (up to 8 hours) and so larger and more spherical agglomerates. This could not be avoided as there was no extraction method apart from manual extraction at the end of the process. The full parameters of this agglomeration run are listed in Table 8.

TABLE 8
process parameters of example 4.

| Parameter | Setpoint |
|---|---|
| Air inlet temperature (° C.) | 75-83 |
| Product bed temperature (° C.) | 55-60 |
| Inlet air flow (m³/h) | 130 |
| Spray rate (L/h) | 1.2-1.50 |
| Atomization air pressure (bar) | 1.2 |
| Extraction rate¹ (kg/h) | NA |
| Product residence time (h) | 8 |

### 4.6: Analysis of Agglomerates

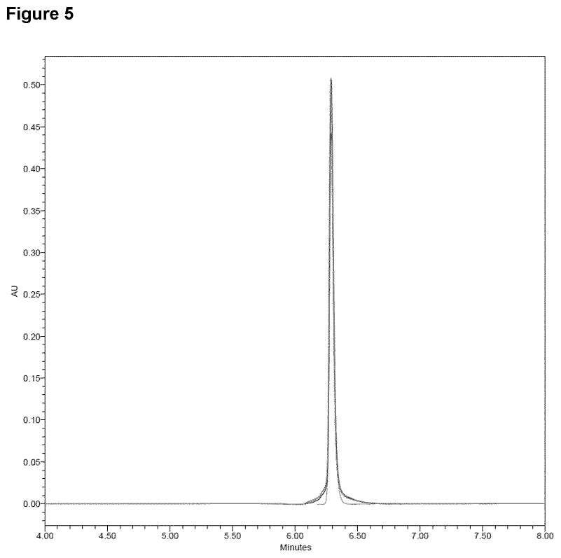

The obtained agglomerates were analysed using the same procedures as described in example 1.5. The resulting parameters of this analysis of the agglomerates of this example are summarized in The chromatogram of the RPC analysis is shown in FIG. 5.

Table 9. The chromatogram of the RPC analysis is shown in FIG. 5.

TABLE 9
Parameters for the analysis of the
agglomerates produced in example 4.

| Parameter | No evaporation | Evaporation |
|---|---|---|
| Particle size diameter d50 | 369 μm | 684 μm |
| SPHT3 (—) | 0.882 | 0.904 |
| Dissolution (CIPAC MT 179) | n.d. | n.d. |
| Bulk density | n.d. | n.d. |
| DS-content | 95% | 95% |
| HPLC - VHH main peak | 87.0% | 89.9% |
| HPLC - pre-peak | 6.2% | 5.1% |
| HPC - post-peak | 6.8% | 5.0% |
| Wettability (CIPAC MT 53.3) | n.d. | n.d. |

### Example 5: Run 5

### 5.1: Immunoglobulin Single Variable Domain

As a specific example of an immunoglobulin single variable domain or VHH corresponding to SEQ ID NO:1 was used.

### 5.2: Fermentation

The fermentation and downstream purification steps were performed similarly to the protocol described in example 1.2. The resulting fermentation broths contained a respective amount of dry matter of approximately 8.8% w/w, 9.7% w/w and 10.01% w/w respectively, with a concentration of the bioactive protein of interest of approximately 1.93% w/w, 1.86% w/w and 1.83% w/w respectively of VHH with SEQ ID NO.1.

### 5.3: Pooling of Fermentation Broths

The three batches described in paragraph 5.2 were pooled together in a large holding tank to create one larger batch of 2407 liter. The final specifications of this large batch were 9.3% w/w of dry matter and 1.89% w/w of VHH with SEQ ID NO.1.

### 5.4: Formulation of the Liquid Composition

In a large mixing receptacle Cellosize Hydroxyethyl Cellulose QP300 (at 7.48 gram per liter DI water or 0.75% w/w) and Attagel 50 (at 41.42 gram per liter DI water or 4.14% w/w) were added to 127 liter of deionized water and stirrer at 1000 rpm using a mixer with a mixing rod. Hereafter Tween 23 was added at 107.56 gram per liter DI water. Hereafter Antifoam AFE 1530 was added at 2.99 gram per liter DI water under continuous stirring at 1000 rpm. This mixture was added to 2407 liter of fermentation broth as described in paragraph 5.3 while mixing at low speed. Next, a further 14.02 g/L of buffer agent trisodium citrate dihydrate and mixed until fully dissolved.

### 5.5: Agglomeration Process

The resulting liquid compositions described in paragraph 5.4 were then spray-dried separately using a fluid bed granulator. The liquid composition was stored in a holding tank, which was connected to the spray tank of the fluid bed granulator. The nozzle was mounted above the fluidized bed. Ambient air was used for fluidization at a flow rate of 6000 m³/h. Seeding material was provided in the form of remainder material from a previous production. This remainder material are small granules and fines. Airflow was started and air inlet temperature was slowly increased until a stable product bed temperature of 63° C. The pump feed rate was increased up to 2-2.2 kg/h. Semi-continuous extraction of agglomerates was realized by manually operating the sample bore in the granulator which was mounted directly into the fluid bed. The extracted product was discharged into a sieving system, in which it was sieved between an upper sieve of 800 μm mesh size and a lower sieve of 180 μm mesh size. As this agglomeration was performed in a continuous system with active extraction of formed agglomerates, the average residence time of the product will vary but was estimated to be from 1 to 24 hours

TABLE 10
process parameters of example 5.

| Parameter | Setpoint |
|---|---|
| Air inlet temperature (° C.) | 81-90 |
| Air outlet temperature (° C.) | 41 |
| Product bed temperature (° C.) | 63 |
| Inlet air flow (m³/h) | 6000 |
| Spray rate (kg/min) | 2-2.2 |
| Atomization air pressure (bar) | 4 |
| Extraction rate (kg/h) | 12 |

### 5.6: Analysis of Agglomerates

The obtained agglomerates were analysed using the same procedures as described in example 1.5. The resulting parameters of this analysis of the agglomerates of this example are summarized in table 11 below.

TABLE 11
Parameters for the analysis of the
agglomerates produced in example 5.

| Parameter | Value | |
|---|---|---|
| Particle size diameter d50 | 418 | μm |
| SPHT3 (—) | 0.87 | |
| Dissolution (CIPAC MT 179) | 0% | |
| Bulk density | 690 | g/L |
| DS-content | 96.3% | |
| HPLC - VHH main peak | 87.6% | |
| HPLC - pre-peak | 3.3% | |
| HPLC - post-peak | 9.2% | |
| Wettability (CIPAC MT 53.3) | 1 | s |
| Stability 20° C. | >3 | months |
| Stability 45° C. | >3 | months |

### EMBODIMENTS

The present invention provides at least the following numbered statements of invention

1. A method of producing agglomerates from an aqueous liquid composition, the method comprising
a. spraying the aqueous liquid composition and concomitantly applying heat allowing water present in the aqueous liquid composition to evaporate resulting in a spray-dried powder and,
b. agitating and heating the spray dried powder in a fluidized bed reactor, and
c. spraying the aqueous liquid composition onto the spray-dried powder in the fluidized bed allowing for the formation of agglomerates from the spray-dried powder,
   wherein the aqueous liquid composition is derived from a microbial fermentation comprising dry matter containing a bioactive protein.

2. The method of statement 1, wherein the agglomerates are extracted, optionally during the agglomeration process of step c.

3. The method according to statement 1 or statement 2, wherein the fluidized bed is initiated by introducing spray-dried powder, ground agglomerates, small agglomerates, or agglomerates at or before spraying the aqueous liquid composition.

4. The method according to any preceding statement, wherein the bioactive protein is an antibody, an antibody fragment or a VHH.

5. The method according to statement 4, wherein the bioactive protein is a VHH.

6. The method according to any of statements 1 to 3, wherein the bioactive protein is a toxin such as a Bacillus thuringiensis (Bt) toxin, a crystal (Cry) toxin, a cytolytic (Cyt) toxin, a vegetative insecticidal protein (Vip), a secreted insecticidal protein (Sip), a Bin-like toxin or a spider toxin such as an agatoxin or a diguetoxin.

7. The method according to any of statements 1 to 3, wherein the bioactive protein is an antimicrobial peptide.

8. The method according to any preceding statement, wherein the aqueous liquid composition further comprises one or more of a filler agent, a preservative, an antifoam agent, a buffer agent, an anti-caking agent, a sticker, a humectant and/or a surfactant.

9. The method according to any preceding statement, wherein the aqueous liquid composition further comprises one or more of:
a. a filler agent which is selected from trisodium citrate dihydrate, or a silicon dioxide;
b. a preservative which is selected from a sorbate salt such as potassium sorbate, or an acid such as citric acid, for example citric acid monohydrate;
c. an antifoam agent which is selected from a silicone fluid such as polydimethylsiloxane, or a tertiary amine oxides such as decyldimethyl-aminoxide;
d. a buffer agent which is selected from a citrate salt, such as citric acid monophosphate, or a phosphate buffer, or a HEPES buffer;
e. an anti-caking agent which is an anhydrous compound;
f. a sticker which is selected from a hydroxyethyl cellulose polymer, or guar gum or products based thereon,
g. a humectant which is selected from an attapulgite clay powder, such as magnesium aluminium phyllosilicate, or a silicon dioxide or hydrated silica; and/or
h. a surfactant which is selected from an organic amphiphilic compound, such as Polyoxyethylene sorbitan monolaurate, or a polyether siloxane such as Polyoxyethylene (20) oleyl ether, or an alcohol ethoxylat such as Ethylene Oxide/Propylene Oxide Block Copolymers.

11. The method according to any preceding statement, wherein no solid carriers, different than spray-dried powder derived from the liquid composition, are added to initiate the formation of agglomerates.

12. The method according to any preceding statement, wherein the method is a continuous process wherein the agglomerates are extracted during the agglomeration process.

13. The method according to any preceding statement, wherein the aqueous liquid composition and spray-dried powder are heated by contact with a heated gas stream.

14. The method of statement 13, wherein the heated gas stream has a temperature in the range of 70° C. and 130° C. immediately prior to entering the fluidized bed reactor.

15. The method of statement 14, wherein the heated gas stream has a temperature in the range of 75° C. and 120° C., preferably in the range of 75° C. and 110° C., more preferably in the range of 80° C. and 105° C., even more preferably in the range of 90° C. and 100° C. immediately prior to entering the fluidized bed reactor

16. The method of any preceding statement, wherein the fluidized bed is kept at a temperature in the range of 40° C. and 100° C.

17. The method of statement 16, wherein the fluidized bed is kept at a temperature in the range of 40° C. and 80° C., preferably in the range of 45° C. and 75° C., more preferably in the range of 45° C. and 65° C., even more preferably in the range of 50° C. and 70° C. even more preferably in the range of 55° C. and 65° cand most preferably a temperature in the range of 58° C. and 63° C.

18. An agglomerate obtainable by the method of any preceding statement.

19. An agglomerate comprising dry matter derived from a microbial fermentation, wherein the dry matter comprises a bioactive protein.

20. The agglomerate of statement 19, wherein the dry matter is present in a concentration in the range of 10% and 90% w/w, preferably from 20% to 60% w/w, and wherein the bioactive protein, contained in the dry matter, is present in a concentration in the range of 5 and 25% w/w of the agglomerate.

21 The agglomerate of any of statement 19 or 20, wherein the bioactive protein is an antibody, an antibody fragment or a VHH.

22. The agglomerate of any of statements 19 to 21, wherein the bioactive protein is a VHH.

23. The agglomerate of statement 19 or 20, wherein the bioactive protein is a toxin such as a Bacillus thuringiensis (Bt) toxin, a crystal (Cry) toxin, a cytolytic (Cyt) toxin, a vegetative insecticidal protein (Vip), a secreted insecticidal protein (Sip), a Bin-like toxin or a spider toxin such as an agatoxin or a diguetoxin.

24. The agglomerate of statement 19 or 20, wherein the bioactive protein is an antimicrobial peptide.

25. The agglomerate of any of statements 18 to 24, wherein the agglomerate has a homogenous composition.

26. The agglomerate of any one of statements 18 to 25, where the agglomerate further comprises one or more of a filler agent, a preservative, an antifoam agent, a buffer agent, a humectant and/or a surfactant.

27. The agglomerate of any one of statements 18 to 26, wherein the agglomerate further comprises one or more of:
a. a filler agent which is selected from trisodium citrate dihydrate, or a silicon dioxide;
b. a preservative which is selected from a sorbate salt such as potassium sorbate, or an acid such as citric acid., for example citric acid monohydrate;
c. an antifoam agent which is selected from a silicone fluid such as polydimethylsiloxane, or a tertiary amine oxides such as decyldimethyl-aminoxide;
d. a buffer agent which is selected from a citrate salt, such as citric acid monophosphate, or a phosphate buffer, or a HEPES buffer;
e. an anti-caking agent which is an anhydrous compound;
f. a sticker which is selected from a hydroxyethyl cellulose polymer, or guar gum or products based thereon,
g. a humectant which is selected from an attapulgite clay powder, such as magnesium aluminium phyllosilicate, or a silicon dioxide or hydrated silica; and/or
h. a surfactant which is selected from an organic amphiphilic compound, such as Polyoxyethylene sorbitan monolaurate, or a polyether siloxane such as Polyoxyethylene (20) oleyl ether, or an alcohol ethoxylat such as Ethylene Oxide/Propylene Oxide Block Copolymers.

28. The agglomerate of statement 27 wherein
a. The filler agent is present in a concentration in the range of 1 and 40% w/w,
b. The preservative is present in a concentration in the range of 0.1 and 5% w/w,
c. The antifoam agent is present in a concentration in the range of 0.1 and 1.5% w/w,
d. The buffer agent is present in a concentration in the range of 0.1 and 4.5% w/w,
e. The anti-caking agent is present in a concentration in the range of 0.1 to 25% w/w,
f. The sticker is present in a concentration in the range of 0.1 and 1% w/w,
g. The humectant is present in a concentration in the range of 0.1 to 2.5% w/w, and
h. The surfactant is present in a concentration in the range of 0.1 to 10% w/w.

29. The agglomerate according to any one of statements 18 to 28, further comprising in the range of 0% and 15% of water.

30. The agglomerate according to any one of statements 18 to 29, wherein the agglomerate has an irregular shape.

31. The agglomerate according to any one of statements 18 to 30, wherein the agglomerate has a SPHT3 value below 1.

32. The agglomerate according to statement 32, wherein the SPHT3 value is below 0.90.

33. The agglomerate according to statement 32, wherein the SPHT3 value is in the range of 0.80 and 0.89.

34. The agglomerate according to any one of statements 18 to 33, where the agglomerate has a raspberry shape.

35. The agglomerate according to any one of statements 18 to 34, where the agglomerate has an aggregate drupelet shape.

36. The agglomerate of any one of statements 18 to 35, where the agglomerate has a D50 value in the range of 100 μm and 900 μm.

37. The agglomerate of statement 36, wherein the agglomerate has a D50 value in the range of 200 μm and 500 μm.

38. Use of the agglomerate according to any one of statements 18 to 37 as a pest control product.

39. Use of the agglomerate according to any one of statements 18 to 37 in a method of preventing or treating an infection of a plant or plant parts from with a plant pathogenic pest.

40. A composition comprising agglomerates, wherein the agglomerates comprise dry matter derived from a microbial fermentation wherein the dry matter contains a bioactive protein, wherein the composition further comprises, water and optionally one or more of a filler agent, a preservative, an antifoam agent, a buffer agent, an anti-caking agent, a sticker, a humectant and/or a surfactant.

41. The composition of statement 40 wherein
a. the dry matter is present in a concentration in the range of 10% and 90% w/w,
b. the bioactive protein, contained in the dry matter, is present in a concentration in the range of 5 and 25% w/w of the composition,
c. water is present in a concentration in the range of 0% and 15% w/w,
d. optionally the filler agent is present in a concentration in the range of 1 and 40% w/w,
e. optionally the preservative is present in a concentration in the range of 0.1 and 5% w/w,
f. optionally the antifoam agent is present in a concentration in the range of 0.1 and 1.5% w/w,
g. optionally the buffer agent is present in a concentration in the range of 0.1 and 4.5% w/w,
h. optionally the anti-caking agent is present in a concentration in the range of 0.1 to 25% w/w,
i. optionally the sticker is present in a concentration in the range of 0.1 and 1% w/w,
j. optionally the humectant is present in a concentration in the range of 0.1 to 2.5% w/w, and/or
k. optionally the surfactant is present in a concentration in the range of 0.1 to 10% w/w

42. An agrochemical composition comprising the agglomerates according to any one of statements 18 to 37 dissolved in water, and optionally one or more tank mix additives.

43. A process of preparing an agrochemical composition comprising the steps of:
a. adding the agglomerates according to any one of statements 18 to 37 to a receptacle, such as a spray tank, containing water,
b. optionally allowing the agglomerates to settle, and
c. mixing the agglomerates and the water by agitation.

44. The process of statement 43, comprising step d) adding one or more tank mix additives.

45. A method for protecting or treating a plant or a part of the plant from an infection or other biological interaction with a plant pathogen, at least comprising the step of applying to the plant or to a part of the plant the agglomerate according to any one of statements 18 to 37, the composition according to statement 40 or 41, or the agrochemical composition according to statement 42, under conditions effective to protect or treat the plant or a part of the plant against the infection or biological interaction with the plant pathogen.

46. The method according to statement 45, wherein the agrochemical composition is applied to the plant or to a part of the plant by spraying, atomizing, foaming, fogging, culturing in hydroculture, culturing in hydroponics, coating, submerging, and/or encrusting.

47. The method according to any one of statements 45 or 46, wherein the agrochemical composition is applied to the plant or to a part of the plant, optionally wherein the application is postharvest.

48. A post-harvest treatment method for protecting or treating a harvested plant or a harvested part of the plant from an infection or other biological interaction with a plant pathogen, at least comprising the step of applying to the harvested plant or to a harvested part of the plant the agglomerate according to any one of statements 18 to 37, the composition according to statement 40 or 41 or the agrochemical composition according to statement 42, under conditions effective to protect or treat the harvested plant or a harvested part of the plant against the infection or biological interaction with the plant pathogen.

49. The method according to statements 1 to 17, the agglomerate according to statements 18 to 37 or the composition according to statements 40 and 41, where the microbial fermentation is a Pichia pastoris fermentation, a Trichoderma reesei fermentation, an Aspergillus niger fermentation, an Aspergillus nidulans fermentation, a Myceliophthora heterothallica fermentation, a Myceliophthora thermophilus fermentation, a Bacillus subtilis fermentation or a Bacillus licheniformis fermentation.

50. The method, the agglomerate or the composition according to statement 49, where the microbial fermentation is a Pichia pastoris fermentation.

51. The method, the agglomerate or the composition according to statement 49, where the microbial fermentation is a Trichoderma reesei fermentation.

52. The method, the agglomerate or the composition according to statement 49, where the microbial fermentation is a Bacillus subtilis fermentation.

53. The method, the agglomerate or the composition according to statement 49, where the microbial fermentation is a Bacillus licheniformis fermentation.

54. The method according to statement 5 or the agglomerate according to statement 22, where the VHH is a VHH with an amino acid sequence chosen from any one of SEQ ID NOs: 1, 2, 6, 10 or 14 to 99.

55. The method according to statement 5 or the agglomerate according to statement 22, where the VHH is a VHH with an amino acid sequence according to SEQ ID NO: 1.

56. The method according to statement 5 or the agglomerate according to statement 22, where the VHH is a VHH with an amino acid sequence according to SEQ ID NO: 2.

57. The method according to statement 5 or the agglomerate according to statement 22, where the VHH is a VHH with an amino acid sequence according to SEQ ID NO: 6.

58. The method according to statement 5 or the agglomerate according to statement 22, where the VHH is a VHH with an amino acid sequence according to SEQ ID NO: 10.

59. The method according to statement 5 or the agglomerate according to statement 22, where the VHH is a VHH with an amino acid sequence according to SEQ ID NO: 14.

60. The method according to statement 5 or the agglomerate according to statement 22, where the VHH is a VHH with an amino acid sequence according to SEQ ID NO: 15.

55. The method according to statement 5 or the agglomerate according to statement 22, where the VHH comprises the CDR 1, 2 and 3 regions according respectively to SEQ ID NOs: 3, 4 and 5.

56. The method according to statement 5 or the agglomerate according to statement 22, where the VHH comprises the CDR 1, 2 and 3 regions according respectively to SEQ ID NOs: 7, 8 and 9

57. The method according to statement 5 or the agglomerate according to statement 22, where the VHH comprises the CDR 1, 2 and 3 regions according respectively to SEQ ID NOs 11, 12 and 13.

58. The method according to statements 1 to 17 or the agglomerate according to statements 18 to 37 or the compositions according to statements 40 or 41, comprising a silicon dioxide or hydrated silica.

59. The method according to statement 58, where the agglomerate or the composition does not comprise an attapulgite clay powder.

1. A method of producing agglomerates from an aqueous liquid composition, the method comprising
a. spraying the aqueous liquid composition and concomitantly applying heat allowing water present in the aqueous liquid composition to evaporate resulting in a spray-dried powder and,
b. agitating and heating the spray dried powder in a fluidized bed reactor, and
c. spraying the aqueous liquid composition onto the spray-dried powder in the fluidized bed allowing for the formation of agglomerates from the spray-dried powder,
wherein the aqueous liquid composition is derived from a microbial fermentation comprising dry matter containing a bioactive protein.

2. The method of claim 1, wherein the agglomerates are extracted, optionally during the agglomeration process of step c; and/or wherein the fluidized bed is initiated by introducing the spray-dried powder, ground agglomerates, small agglomerates, or agglomerates at or before spraying the aqueous liquid composition.

3. The method according to any preceding claim, wherein the aqueous liquid composition further comprises one or more of a filler agent, a preservative, an antifoam agent, a buffer agent, an anti-caking agent, a sticker, a humectant and/or a surfactant.

4. The method according to any preceding claim, wherein no solid carriers, different than spray-dried powder derived from the liquid composition, are added to initiate the formation of agglomerates.

5. The method according to any preceding claim, wherein
a) the aqueous liquid composition and spray-dried powder are heated by contact with a heated gas stream, optionally wherein the heated gas stream has a temperature in the range of 70° C. and 130° C. immediately prior to entering the fluidized bed reactor and/or
b) the fluidized bed is kept at a temperature in the range of 40° C. and 100° C.

6. An agglomerate obtainable by the method of any preceding claim.

7. An agglomerate comprising dry matter derived from a microbial fermentation, wherein the dry matter comprises a bioactive protein.

8. The agglomerate of claim 7, wherein the dry matter is present in a concentration in the range of 10% and 90% and wherein the bioactive protein, contained in the dry matter, is present in a concentration in the range of 5 and 25% w/w of the agglomerate.

9. The agglomerate of any of claims 6 to 8, wherein the agglomerate has a homogenous composition.

10. The agglomerate according to any one of claims 6 to 9, further comprising in the range of 0% and 15% of water.

11. The agglomerate according to any one of claims 6 to 10, wherein the agglomerate has a SPHT3 value of below 0.90; and/or where the agglomerate has a D50 value in the range of 100 μm and 900 μm, optionally in the range of 200 μm and 400 μm.

12. The method according to any one of claims 1 to 5, or the agglomerate of any one of claims 6 to 11, wherein the bioactive protein is selected from:
a) an antibody, an antibody fragment or a VHH;
b) a toxin such as a Bacillus thuringiensis (Bt) toxin, a crystal (Cry) toxin, a cytolytic (Cyt) toxin, a vegetative insecticidal protein (Vip), a secreted insecticidal protein (Sip), a Bin-like toxin or a spider toxin such as an agatoxin or a diguetoxin; or
c) an antimicrobial peptide.

13. The method according to any one of claims 1 to 5, or the agglomerate of any one of claims 6 to 12, wherein the bioactive protein is a VHH.

14. Use of the agglomerate according to any one of claims 6 to 13 as a pest control product, and/or in a method of preventing or treating an infection of a plant or plant parts from with a plant pathogenic pest.

15. A composition comprising agglomerates comprising dry matter derived from a microbial fermentation wherein the dry matter contains a bioactive protein, wherein the composition further comprises, water and optionally one or more of a filler agent, a preservative, an antifoam, a buffer agent, an anti-caking agent, a sticker, a humectant and/or a surfactant.

16. An agrochemical composition comprising the agglomerates according to any one of claims 6 to 14 dissolved in water, and optionally one or more tank mix additives.

17. A process of preparing an agrochemical composition comprising the steps of:
a. adding the agglomerates according to any one of claims 6 to 13 to a receptacle, such as a spray tank, containing water,
b. optionally allowing the agglomerates to settle, and
c. mixing the agglomerates and the water by agitation optionally further comprising step d) adding one or more tank mix additives.

18. A method for protecting or treating a plant or a part of the plant from an infection or other biological interaction with a plant pathogen, at least comprising the step of applying to the plant or to a part of the plant the agglomerate according to any one of claims 6 to 13, the composition according to claim 15 or the agrochemical composition according to claim 16, under conditions effective to protect or treat the plant or a part of the plant against the infection or biological interaction with the plant pathogen.

19. A post-harvest treatment method for protecting or treating a harvested plant or a harvested part of the plant from an infection or other biological interaction with a plant pathogen, at least comprising the step of applying to the harvested plant or to a harvested part of the plant the agglomerate according to any one of claims 6 to 13, the composition according to claim 15 or the agrochemical composition according to claim 16, under conditions effective to protect or treat the harvested plant or a harvested part of the plant against the infection or biological interaction with the plant pathogen.


SEQUENCE LISTING (99 sequences)

SEQ ID NO: 1 - protein, 119 aa, synthetic construct
  REGION 1..119: note = Synthetic VHH sequence.
DVQLVESGGGLVQAGGSLRLSCAASRSIFSINAMDWYRQAPGKQREWVAGITRGGTTKYADSVKGRFTISRDNAKKKVYLQMNSLKPEDTAVYYCNVLRGEQPWTRDYWGQGTQVTVSS

SEQ ID NO: 2 - protein, 119 aa, synthetic construct
  REGION 1..119: note = Synthetic VHH sequence.
QVQLVESGGGLVQAGGSLRLSCAASRSIFSINAMDWYRQAPGKQREWVAGITRGGTTKYADSVKGRFTISRDNAKKKVYLQMNSLKPEDTAVYYCNVLRGEQPWTRDYWGQGTQVTVSS

SEQ ID NO: 3 - protein, 10 aa, synthetic construct
  REGION 1..10: note = Synthetic VHH sequence.
RSIFSINAMD

SEQ ID NO: 4 - protein, 9 aa, synthetic construct
  REGION 1..9: note = Synthetic VHH sequence.
GITRGGTTK

SEQ ID NO: 5 - protein, 11 aa, synthetic construct
  REGION 1..11: note = Synthetic VHH sequence.
LRGEQPWTRDY

SEQ ID NO: 6 - protein, 117 aa, synthetic construct
  REGION 1..117: note = Synthetic VHH sequence
QVQLQESGGGLVQAGGSLRLSCAASGTIFRPTAMGWYRQAPGKERELVATITTGGSTKYADSVKGRFTISRGNAKNTVYLQMSSLKPEDTAVYYCNAQWGVRTRDYWGQGTQVTVSS

SEQ ID NO: 7 - protein, 10 aa, synthetic construct
  REGION 1..10: note = Synthetic VHH sequence
GTIFRPTAMG

SEQ ID NO: 8 - protein, 9 aa, synthetic construct
  REGION 1..9: note = Synthetic VHH sequence.
TITTGGSTK

SEQ ID NO: 9 - protein, 9 aa, synthetic construct
  REGION 1..9: note = Synthetic VHH sequence.
QWGVRTRDY

SEQ ID NO: 10 - protein, 126 aa, synthetic construct
  REGION 1..126: note = Synthetic VHH sequence.
QVQLQESGGGLVQAGDSLRLSCAASISDRAFSRHVMGWFRQPPGKEREFVAAIGWTGRRTYYADSVKGRFTISRDNAMNTVYLQMNSLKPEDTAVYYCAASHFYSVSFEINDYDYWGQGTQVTVSS

SEQ ID NO: 11 - protein, 10 aa, synthetic construct
  REGION 1..10: note = Synthetic VHH sequence.
ISDRAFSRHV

SEQ ID NO: 12 - protein, 10 aa, synthetic construct
  REGION 1..10: note = Synthetic VHH sequence.
AIGWTGRRTY

SEQ ID NO: 13 - protein, 15 aa, synthetic construct
  REGION 1..15: note = Synthetic VHH sequence.
SHFYSVSFEINDYDY

SEQ ID NO: 14 - protein, 117 aa, synthetic construct
  REGION 1..117: note = Synthetic VHH sequence.
DVQLQESGGGLVQAGGSLRLSCAASGTIFRPTAMGWYRQAPGKERELVATITTGGSTKYADSVKGRFTISRGNAKNTVYLQMSSLKPEDTAVYYCNAQWGVRTRDYWGQGTQVTVSS

SEQ ID NO: 15 - protein, 126 aa, synthetic construct
  REGION 1..126: note = Synthetic VHH sequence.
DVQLQESGGGLVQAGDSLRLSCAASISDRAFSRHVMGWFRQPPGKEREFVAAIGWTGRRTYYADSVKGRFTISRDNAMNTVYLQMNSLKPEDTAVYYCAASHFYSVSFEINDYDYWGQGTQVTVSS

SEQ ID NO: 16 - protein, 118 aa, synthetic construct
  REGION 1..118: note = VHH sequence 40F07
QVQLQESGGGLVQAGGSLRLSCVASGTTFSSYTMGWYRQAPGKQRELLASIEGGGNTDYADSVKGRFTISRDNARNTVYLQMNSLKTEDTAVYYCNAARTWSIFRNYWGQGTQVTVSS

SEQ ID NO: 17 - protein, 115 aa, synthetic construct
  REGION 1..115: note = VHH sequence 41D01
QVQLQESGGGLVQAGGSLRLSCAASGRTFSRYGMGWFRQLPGKQRELVTSITRGGTTTYADSVKGRFTISRDNAKNTVYLQMNSLKPEDTAVYYCNARSIWRDYWGQGTQVTVSS

SEQ ID NO: 18 - protein, 116 aa, synthetic construct
  REGION 1..116: note = VHH sequence 41D06
QVQLQESGGGLVQAGGSLRLSCAASGGIFGINAMRWYRQAPGKQRELVASISSGGNTNYSESVKGRFTISRDDANYTVYLQMNSLKPEDTAVYYCNFVRLWFPDYWGQGTQVTVSS

SEQ ID NO: 19 - protein, 121 aa, synthetic construct
  REGION 1..121: note = VHH sequence 41G10
QVQLQESGGGLVQPGGSLTLSCAATKTGFSINAMGWYRQAPGKQREMVATITSGGTTNYADSVKGRFAISRDNAKNTVSLQMNTLKPEDTALYYCNTEARRYFTRASQVYWGQGTQVTVSS

SEQ ID NO: 20 - protein, 120 aa, synthetic construct
  REGION 1..120: note = VHH sequence 41H05
QVQLQESGGGLVQPGGSLRLSCAASGGIFSINAMGWYRQDPGKQREMVATITSGANTNYTDSVKGRFTISRDNAKNTVYLQMNSLKPEDTAVYYCNAVGRRWYGGYVELWGQGTQVTVSS

SEQ ID NO: 21 - protein, 119 aa, synthetic construct
  REGION 1..119: note = VHH sequence 42C11
QVQLQESGGGLVQPGGSLRLSCAASGSIFSTYVMGWYRQAIGKQRELVATITSSGKTNYAASVKGRFTVSRDITKNTMYLQMNSLKPEDTAVYYCGADRWVLTRWSNYWGQGTQVTVSS

SEQ ID NO: 22 - protein, 116 aa, synthetic construct
  REGION 1..116: note = VHH sequence 42C12
QVQLQESGGGLVQPGGSLRLSCAASGSISSLGWYRQAPGKQREFVASATSGGDTTYADSVKGRFTISRDNSKNTVYLQMNSLKPEDTAVYYCKGQRGVAWTRKEYWGQGTQVTVSS

SEQ ID NO: 23 - protein, 119 aa, synthetic construct
  REGION 1..119: note = VHH sequence 50D03
QVQLQESGGGLVQPGGSLRLSCAASGSIFSTYAMGWYRQAIGKQRELVATITSSGKTNYAASVKGRFTISRDITKNTMYLQMNSLKPEDTAVYYCGADRWVLTRWSNYWGQGTQVTVSS

SEQ ID NO: 24 - protein, 120 aa, synthetic construct
  REGION 1..120: note = VHH sequence 50D07
QVQLQESGGGLVQPGGSLRLSCTASGNIVNIRDMGWYRQVPGKQRELVATITSDQSTNYADSVKGRFTTTRDNAKKTVYLQMDSLKPEDTAGYYCNARVRTVLRGWRDYWGQGTQVTVSS

SEQ ID NO: 25 - protein, 119 aa, synthetic construct
  REGION 1..119: note = VHH sequence 50E02
QVQLQESGGGLVQPGGSLRLSCAASGSIFSINAMGWYRQAPGKQRELVAAITSDGSTNYADSVKGRFTISRDNAKNTAYLQMNSLKPEDTAVYYCNLRRRTFLKSSDYWGQGTQVTVSS

SEQ ID NO: 26 - protein, 123 aa, synthetic construct
  REGION 1..123: note = VHH sequence 51B08
QVQLQESGGGLVQAGDSLRLSCAASGRRFGSYAMGWFRQVPGKERELVAGISSGGSTKYADSVRGRFTISRDNAKNTVSLQMKSLKPEDTAVYYCNAKYGRWTYTGRPEYDSWGQGTQVTVSS

SEQ ID NO: 27 - protein, 116 aa, synthetic construct
  REGION 1..116: note = VHH sequence 51C06
QVQLQESGGGLVQPGGSLRLSCAASGSIFSSDTMGWYRRAPGKQRELVAAITTGGNTNYADSVKGRFTISRDNAKNTVYLQMNSLQPEDTAVYYCNCRRRWSRDFWGQGTQVTVSS

SEQ ID NO: 28 - protein, 119 aa, synthetic construct
  REGION 1..119: note = VHH sequence 51C08
QVQLQESGGGLVQPGGSLRLSCAASGTIFSIKTMGWYRQAPGKQRELVATISNGGSTNYADSVKGRFTISRDNAKNTVYLQMNSLKPEDTAVYYCNARQQFIGAPYEYWGQGTQVTVSS

SEQ ID NO: 29 - protein, 115 aa, synthetic construct
  REGION 1..115: note = VHH sequence 52A01
QVQLQESGGGLVQAGGSLRLSCTASGAITFSLGTMGWYRQAPGKQRELVASISTGSTNYADSVKGRFTISRDIIKNILYLQMNSLKPEDTAVYSCNARLLWSNYWGQGTQVTVSS

SEQ ID NO: 30 - protein, 117 aa, synthetic construct
  REGION 1..117: note = VHH sequence 52B01
QVQLQESGGGLVQAGESLRLSCAASGSTFSINVMGWYRQAPGEQRELVATISRGGSTNYADSVKGRFTISRDNAKVTVYLQMDSLKPEDTAVYYCNAAGWVGVTNYWGQGTQVTVSS

SEQ ID NO: 31 - protein, 117 aa, synthetic construct
  REGION 1..117: note = VHH sequence 52G05
QVQLQESGGGLVQAGGSLRLSCAASGSTGSISAMGWYRQAPGKQRELVASITRRGSTNYADSVKDRFTISRDNAWNTVYLQMNSLKPEDTAVYYCNARRYYTRNDYWGQGTQVTVSS

SEQ ID NO: 32 - protein, 114 aa, synthetic construct
  REGION 1..114: note = VHH sequence 53A01
QVQLQESGGGLGQAGGSLRLSCEVSGTTFSINTMGWHRQAPGKQRELVASISSGGWTNYADSVKGRFTISRDNAKKTVYLQMNNLKPEDTAVYYCRWGAIGNWYGQGTQVTVSS

SEQ ID NO: 33 - protein, 117 aa, synthetic construct
  REGION 1..117: note = VHH sequence 53F05
QVQLQESGGGLVQPGGSLRLSCAASVRIFGLNAMGWYRQGPGKQRELVASITTGGSTNYAEPVKGRFTISRDNANNTVYLQMNNLKPEDTAVYYCNAERRWGLPNYWGQGTQVTVSS

SEQ ID NO: 34 - protein, 126 aa, synthetic construct
  REGION 1..126: note = VHH sequence 54A02
QVQLQESGGGLVEAGGSLRLSCAASGRTFSRYGMGWFRQAPGKEREFVAANRWSGGSTYYADSVRGRFTISRDNAKNTVYLQMNSLKPEDTAVYYCAAYAHITAWGMRNDYEYDYWGQGTQVTVSS

SEQ ID NO: 35 - protein, 125 aa, synthetic construct
  REGION 1..125: note = VHH sequence 54B01
QVQLQESGGGLVQAGGSLRLSCAATGRTFSRYTMGWFRQAPGKERDFVAGITWTGGSTDYADSVKGRFTISRDNAKNTVYLQMNSLKPEDTAVYYCAAGNLLRLAGQLRRGYDSWGQGTQVTVSS

SEQ ID NO: 36 - protein, 129 aa, synthetic construct
  REGION 1..129: note = VHH sequence 54C01
QVQLQESGGGLVQAGGSLRLSCAASGRTGSRYAMGWFRQAPGKEREFVAAISWSGGSTYYADSVKDRFTISRDNAKNTVYLQMHSLKPEDTAVYYCATRNRAGPHYSRGYTAGQEYDYWGQGTQVTVSS

SEQ ID NO: 37 - protein, 121 aa, synthetic construct
  REGION 1..121: note = VHH sequence 54C04
QVQLQESGGGLVQPGGSLRLSCAASGRIFSINAMGWYRQGPGKERELVVDMTSGGSINYADSVSGRFTISRDNAKNTVYLQMNSLKPEDTAVYYCHANLRTAFWRNGNDYWGQGTQVTVSS

SEQ ID NO: 38 - protein, 115 aa, synthetic construct
  REGION 1..115: note = VHH sequence 54C08
QVQLQESGGGLVQPGGSLRLSCAASGSISSINAMGWYRQAPGKQRELVASITSGGSTNYADSVKGRFTISRDNAKNTVNLQMNSLKPEDTAVYYCSAGPWYRRSWGRGTQVTVSS

SEQ ID NO: 39 - protein, 116 aa, synthetic construct
  REGION 1..116: note = VHH sequence 54C10
QVQLQESGGGLVQPGESLRLSCAASASIFWVNDMGWYRQAPGKQRELVAQITRRGSTNYADSVKGRFTISRDNAKDEVYLQMNSLKPEDTAVYYCNADLAVRGRYWGQGTQVTVSS

SEQ ID NO: 40 - protein, 119 aa, synthetic construct
  REGION 1..119: note = VHH sequence 54C11
QVQLQESGGGLVQPGGSLRLSCAASGSFFPVNDMAWYRQALGNERELVANITRGGSTNYADSVKGRFTISRDNAKNTVYLQMNTLKPEDTAVYYCNVRIGFGWTAKAYWGQGTQVTVSS

SEQ ID NO: 41 - protein, 116 aa, synthetic construct
  REGION 1..116: note = VHH sequence 54D03
QVQLQESGGGLVQPGGSLRLSCAASGGIFGINAMRWYRQAPGKQRELVASISSGGNTNYSESVKGRFTISRDDANYTVYLQMNSLKPEDTAVYYCNFVRLWFPDYWGQGTQVTVSS

SEQ ID NO: 42 - protein, 116 aa, synthetic construct
  REGION 1..116: note = VHH sequence 54D06
QVQLQESGGGLVQPGGSLRLSCAASGSTIRINAMGWYRQAPGKQRELVATITRGGITNYADSVKGRFTISRDNAKFTVYLQMNSLKPEDTAVYYCNARSWVGPEYWGQGTQVTVSS

SEQ ID NO: 43 - protein, 120 aa, synthetic construct
  REGION 1..120: note = VHH sequence 54D10
QVQLQESGGGLVQPGGSLRLSCAASGMTYSIHAMGWYRQAPGKERELVAITSTSGTTDYTDSVKGRFTISRDGANNTVYLQMNSLKSEDTAVYYCHVKTRTWYNGKYDYWGQGTQVTVSS

SEQ ID NO: 44 - protein, 117 aa, synthetic construct
  REGION 1..117: note = VHH sequence 54E01
QVQLQESGGGLVQPGGSLRLSCTASGSIFSINPMGWYRQAPGKQRELVAAITSGGSTNYADYVKGRFTISRDNAKNVVYLQMNSLKPEDTAVYYCNGRSTLWRRDYWGQGTQVTVSS

SEQ ID NO: 45 - protein, 117 aa, synthetic construct
  REGION 1..117: note = VHH sequence 54E05
QVQLQESGGGLVQPGGSLRLSCAASGSIFSINTMGWYRQAPGKQRELVAAITNRGSTNYADFVKGRFTISRDNAKNTVYLQMNSLKPDDTAVYYCNAHRSWPRYDSWGQGTQVTVSS

SEQ ID NO: 46 - protein, 118 aa, synthetic construct
  REGION 1..118: note = VHH sequence 54E10
QVQLQESGGGLVQPGGSLRLSCAASGSIFSFNAMGWYRQAPGKQRELVAAITRGGSTNYADSVKGRFTISRDNANNTVYLQMNSLKPEDTAVYYCNAESRIFRRYDYWGPGTQVTVSS

SEQ ID NO: 47 - protein, 115 aa, synthetic construct
  REGION 1..115: note = VHH sequence 54F01
QVQLQESGGGLVQPGGSLRLSCVTSGSIFGLNLMGWYRQAPGKQRELVATITRGGSTNYADSVKGRFTISRDNAKKTVYLQMNSLKPEDTAVYYCNVDRGWSSYWGQGTQVTVSS

SEQ ID NO: 48 - protein, 119 aa, synthetic construct
  REGION 1..119: note = VHH sequence 54F02
QVQLQESGGGLVQPGGSLRLSCVTSGSIRSINTMGWYRQAPGNERELVATITSGGTTNYADSVKNRFTISRDNAKNTVYLQMNSLKPEDTAVYYCNLHQRAWARSYVYWGQGTQVTVSS

SEQ ID NO: 49 - protein, 117 aa, synthetic construct
  REGION 1..117: note = VHH sequence 54G01
QVQLQESGGGSVQPGGSLRLSCAASGSIFAVNAMGWYRQAPGHQRELVAIISSNSTSNYADSVKGRFTISRDNAKNTVYLQMNSLKPEDTAVYFCYAKRSWFSQEYWGQGTQVTVSS

SEQ ID NO: 50 - protein, 121 aa, synthetic construct
  REGION 1..121: note = VHH sequence 54G08
QVQLQESGGGLVQPGGSLRLSCAASGSIFSFNLMGWYRQAPGKQRELVAAITSSSNTNYADSVKGRFTISRDNAKNTVYLQMNSLKPEDTAVYYCNAQYTITPWGIKKDYWGQGTQVTVSS

SEQ ID NO: 51 - protein, 120 aa, synthetic construct
  REGION 1..120: note = VHH sequence 54G09
QVQLQESGGGLMQPGGSLRLSCTASGNIVNIRDMGWYRQVPGKQRELVATITSDQSTNYADSVKGRFTTTRDNAKKTVYLQMDSLKPEDTAGYYCNARVRTVLRGWRDYWGQGTQVTVSS

SEQ ID NO: 52 - protein, 117 aa, synthetic construct
  REGION 1..117: note = VHH sequence 55B02
QVQLQESGGGLVQPGESLRLSCVGSGSIFNINSMNWYRQASGKQRELVADMRSDGSTNYADSVKGRFTISRDNARKTVYLQMNSLKPEDTAVYYCHANSIFRSRDYWGQGTQVTVSS

SEQ ID NO: 53 - protein, 125 aa, synthetic construct
  REGION 1..125: note = VHH sequence 55B05
QVQLQESGGGVVQAGDSLRLSCAASGRTFGGYTVAWFRQAPGKEREFVARISWSGIMAYYAESVKGRFTISRDNAKNTVYLQMNSLKPEDTAVYYCASRSQIRSPWSSLDDYDRWGQGTQVTVSS

SEQ ID NO: 54 - protein, 116 aa, synthetic construct
  REGION 1..116: note = VHH sequence 55C05
QVQLQESGGGLVQPGGSLRLSCVVSGSISSMKAMGWHRQAPGKERELVAQITRGDSTNYADSVKGRFTISRDNAKNTVYLQMNSLKPDDTGVYYCNADRFFGRDYWGKGTQVTVSS

SEQ ID NO: 55 - protein, 120 aa, synthetic construct
  REGION 1..120: note = VHH sequence 55D08
QVQLQESGGGLVQPGGSLRLSCAASRSILSISAMGWYRQGPGKQREPVATITSAGSSNYSDSVKGRFTISRDNAKNTAYLQMNSLKPEDTAVYYCKTVYSRPLLGPLEVWGQGTQVTVSS

SEQ ID NO: 56 - protein, 115 aa, synthetic construct
  REGION 1..115: note = VHH sequence 55E02
QVQLQESGGGLVQTGGSLRLSCVASGSMFSSNAMAWYRQAPGKQRELVARILSGGSTNYADSVKGRFTISRGNAKNTVYLQMNSLKPEDTAVYYCNAVRYLVNYWGQGTQVTVSS

SEQ ID NO: 57 - protein, 121 aa, synthetic construct
  REGION 1..121: note = VHH sequence 55E07
QVQLQESGGGSVQVGDSLTLSCVASGRSLDIYGMGWFRQAPGKEREFVARITSGGSTYYADSVKGRFTLSRDNAKNTVYLQMNSLKPEDTAVYYCAAGVVVATSPKFYAYWGQGTQVTVSS

SEQ ID NO: 58 - protein, 116 aa, synthetic construct
  REGION 1..116: note = VHH sequence 55E09
QVQLQESGGGLVQAGGSLRLSCAASKRIFSTYTMGWFRQAPGKEREFVAAIIWSGGRTRYADSVKGRFTISRDNARNTVHLQMNSLEPEDTAVYYCYTRRLGTGYWGQGTQVTVSS

SEQ ID NO: 59 - protein, 115 aa, synthetic construct
  REGION 1..115: note = VHH sequence 55E10
QVQLQESGGGLVQAGGSLRLSCAASGSTFSIQTIGWYRQAPGKQRDRVATISSGGSTNYADSVKGRFTISRDNAKKTVYLQMNNLKPEDTAVYYCNLRYWFRDYWGQGTQVTVSS

SEQ ID NO: 60 - protein, 115 aa, synthetic construct
  REGION 1..115: note = VHH sequence 55F04
QVQLQESGGGLVQPGGSLRLSCAASGSTFSINVRGWYRQAPGKQRELVATITSDGSTNYADSVKGRFTISRDNAKNTAYLQMNSLKPEDTAVYYCNAVRLFRQYWGQGTQVTVSS

SEQ ID NO: 61 - protein, 125 aa, synthetic construct
QVQLQESGGGLVQPGGSLRLSCAASGSIFRLNAMGWYRQAPGKQRELVAAITPGGGNTTYADSVKGRFTISRDNALNTIYLQMNSLKPEDTAVYYCNAGGSSRWYSSRYYPGGYWGQGTQVTVSS

SEQ ID NO: 62 - protein, 126 aa, synthetic construct
  REGION 1..126: note = VHH sequence 55F10
QVQLQESGGGLVQAGGSLRLSCATSGGTFSRYAMGWFRQAPGKERELVATIRRSGSSTYYLDSTKGRFTISRDNAKNTVYLQMNSLKLEDTAVYYCAADSSARALVGGPGNRWDYWGQGTQVTVSS

SEQ ID NO: 63 - protein, 118 aa, synthetic construct
  REGION 1..118: note = VHH sequence 55G02
QVQLQESGGGLVQPGGSLRLSCAASGSIGSINVMGWYRQYPGKQRELVAFITSGGITNYTDSVKGRFAISRDNAQNTVYLQMNSLTPEDTAVYYCHLKNAKNVRPGYWGQGTQVTVSS

SEQ ID NO: 64 - protein, 116 aa, synthetic construct
  REGION 1..116: note = VHH sequence 55G08
QVQLQESGGGLVQPGGSLRLSCRASGGIFGINAMRWYRQAPGKQRELVASISSGGTTDYVESVKGRFTISRDNATNTVDLQMSALKPEDTAVYYCNFVRFWFPDYWGQGTQVTVSS

SEQ ID NO: 65 - protein, 116 aa, synthetic construct
  REGION 1..116: note = VHH sequence 56A05
QVQLQESGGGLVQAGGSLRLSCAASGITFMSNTMGWYRQAPGKQRELVASISSGGSTNYADSVKGRFTISRDNAKKTVYLQMNSLKPEDTAVYYCNARRNVFISSWGQGTQVTVSS

SEQ ID NO: 66 - protein, 114 aa, synthetic construct
  REGION 1..114: note = VHH sequence 56A06
QVQLQESGGGLVQPGGSLRLSCVASGSISVYGMGWYRQAPGKQRELVARITNIGTTNYADSVKGRFTISRDNAKNTVYLQMNSLQPEDTAVYYCNLRRLGRDYWGQGTQVTVSS

SEQ ID NO: 67 - protein, 118 aa, synthetic construct
QVQLQESGGGLVQPGGSLRLSCAASRTALRLNSMGWYRQAPGSQRELVATITRGGTTNYADSVKGRFTISREIGNNTVYLQMNSLEPEDTAVYYCNANFGILVGREYWGKGTQVTVSS

SEQ ID NO: 68 - protein, 116 aa, synthetic construct
  REGION 1..116: note = VHH sequence 56C09
QVQLQESGGGLVQAGGSLRLSCAVSGSIFSILSMAWYRQTPGKQRELVANITSVGSTNYADSVKGRFTISRDIAKKTLYLQMNNLKPEDTAIYYCNTRMPFLGDSWGQGTQVTVSS

SEQ ID NO: 69 - protein, 111 aa, synthetic construct
  REGION 1..111: note = VHH sequence 56C12
QVQLQESGGGLVQAGGSLRLSCAVSAFSFSNRAVSWYRQAPGKSREWVASISGIRITTYTNSVKGRFIISRDNAKKTVYLQMNDLRPEDTGVYRCYMNRYSGQGTQVTVSS

SEQ ID NO: 70 - protein, 117 aa, synthetic construct
  REGION 1..117: note = VHH sequence 56D06
QVQLQESGGGSVQPGGSLRLSCAASGTVFFSISAMGWYRQAPGKQRELVAGISRGGSTKYGDFVKGRFTISRDNGKKTIWLQMNNLQPEDTAIYYCRLTSITGTYLWGQGTQVTVSS

SEQ ID NO: 71 - protein, 114 aa, synthetic construct
  REGION 1..114: note = VHH sequence 56D07
QVQLQESGGGLVQPGGSLRLSCAASGSIFSMKVMGWYRQGPGKLRELVAVITSGGRTNYAESVKGRFTISRDNAKNTVSLQMNSLQPEDTAVYYCYYKTIRPYWGQGTQVTVSS

SEQ ID NO: 72 - protein, 120 aa, synthetic construct
  REGION 1..120: note = VHH sequence 56D10
QVQLQESGGGLVQAGGSLRLSCAASGITFRITTMGWYRQAPGKQRELVASSSSGGTTNYASSVKGRFTISRDNAKNTVYLQMNSLRPEDTAVYYCNARKFITTPWSTDYWGQGTQVTVSS

SEQ ID NO: 73 - protein, 116 aa, synthetic construct
  REGION 1..116: note = VHH sequence 56E04
QVQLQESGGGLVQPGDSLRLSCTPSGSIFNHKATGWYRQAPGSQRELVAKITTGGTTNYADSVKGRFTISRDNAKNTVYLQMSSLKPEDTAVYYCNAERYFATTLWGQGTQVTVSS

SEQ ID NO: 74 - protein, 119 aa, synthetic construct
  REGION 1..119: note = VHH sequence 56E05
QVQLQESGGGLVQAGGSLRLSCAASGITFSNNAGGWYRQAPGQQRELVARISSGGNTNYTDSVKGRFTISRDITKNTLSLQMNNLKPEDSAVYYCNAQRRVILGPRNYWGQGTQVTVSS

SEQ ID NO: 75 - protein, 121 aa, synthetic construct
  REGION 1..121: note = VHH sequence 56E08
QVQLQESGGGLVQAGGSLRLSCAASGNIFRINDMGWYRQAPGNQRELVATITSANITNYADSVKGRFTISRDNAKNTVYLQMNSLNPEDTAVYYCTAQAKKWRIGPWSDYWGQGTQVTVSS

SEQ ID NO: 76 - protein, 119 aa, synthetic construct
  REGION 1..119: note = VHH sequence 56F07
QVQLQESGGGLVQPGGSLRLSCAASGRIFSINDMAWYRQAPGKQRELVAIITNDDSTTYADSVKGRFTISRDNAKNTVYLQMNSLKPEDTAVYYCNADINTAIWRRKYWGQGTQVTVSS

SEQ ID NO: 77 - protein, 121 aa, synthetic construct
  REGION 1..121: note = VHH sequence 56F11
QVQLQESGGGLVQSGGSLRLSCVHSKTTFTRNAMGWYRQALGKERELVATITSGGTTNYADSVKGRFTISMDSAKNTVYLQMNSLKPEDTAVYYCNVNTRRIFGGTVREYWGQGTQVTVSS

SEQ ID NO: 78 - protein, 115 aa, synthetic construct
  REGION 1..115: note = VHH sequence 56G07
QVQLQESGGGLVQPGGSLRLSCAVSGSRIFIHDMGWHRQAPGEPRELVATITPFGRRNYSEYVKGRFTVSRDIARNTMSLQMSNLKAEDTGMYYCNVRVNGVDYWGQGTQVTVSS

SEQ ID NO: 79 - protein, 119 aa, synthetic construct
  REGION 1..119: note = VHH sequence 56G08
QVQLQESGGGLVQAGGSLRLSCAISGITFRRPFGISRMGWYRQAPGKERELVATLSRAGTSRYVDSVKGRFTISRDDAKNTLYLQMVSLNPEDTAVYYCYIAQLGTDYWGQGTQVTVSS

SEQ ID NO: 80 - protein, 117 aa, synthetic construct
  REGION 1..117: note = VHH sequence 56G10
QVQLQESGGGLVQAGGSLRLSCVASGITLRMYQVGWYRQAPGKQRELVAEISSRGTTMYADSVKGRFTISRDGAKNIVYLQMNSLEPEDTAVYYCNARAFAFGRNSWGQGTQVTVSS

SEQ ID NO: 81 - protein, 118 aa, synthetic construct
QVQLQESGGGSVQAGGSLRLSCAVSGGTFSNKAMGWYRQSSGKQRALVARISTVGTAHYADSVKGRFTVSKDNAGNTLYLQMNSLKPEDTAVYYCNAQAGRLYLRNYWGQGTQVTVSS

SEQ ID NO: 82 - protein, 119 aa, synthetic construct
  REGION 1..119: note = VHH sequence 56H05
QVQLQESGGGLVQPGESLRLSCVAAASTSITTFNTMAWYRQAPGKQRELVAQINNRDNTEYADSVKGRFIISRGNAKNTSNLQMNDLKSEDTGIYYCNAKRWSWSTGFWGQGTQVTVSS

SEQ ID NO: 83 - protein, 114 aa, synthetic construct
  REGION 1..114: note = VHH sequence 56H07
QVQLQESGGGLVQAGGSLRLSCTASGLTFALGTMGWYRQAPGKQRELVASISTGSTNYADSVKGRFTISRDIIKNILYLQMNSLKPEDTAVYSCNARLWWSNYWGQGTQVTVSS

SEQ ID NO: 84 - protein, 118 aa, synthetic construct
  REGION 1..118: note = VHH sequence 56H08
QVQLQESGGGLVQAGGSLRLSCTASGRTSSVNPMGWYRQAPGKQRELVAVISSDGSTNYADSVKGRFTVSRDNAKNTLYLQMNSLKPEDTAVYYCNANRRWSWGSEYWGQGTQVTVSS

SEQ ID NO: 85 - protein, 119 aa, synthetic construct
  REGION 1..119: note = VHH sequence 57A06
QVQLQESGGGLVQAGGSLRLSCAASGITFTNNAGGWYRQAPGQQRELVARISSGGNTNYTDSVKGRFTISRDITKNTLSLQMNNLKPEDSAVYYCNAQRRVILGPRNYWGQGTQVTVSS

SEQ ID NO: 86 - protein, 116 aa, synthetic construct
  REGION 1..116: note = VHH sequence 57B01
QVQLQESGGGLVQAGGSLRLSCEAPVSTFNINAMAWYRQAPGKSRELVARISSGGSTNYADSVKGRFTISRDNAKNTVYLQMNSLKPEDTAVYICYVNRHWGWDYWGQGTQVTVSS

SEQ ID NO: 87 - protein, 122 aa, synthetic construct
  REGION 1..122: note = VHH sequence 57B07
QVQLQESGGGLVQPGGTLRLSCVASGSFRSINAMGWYRQAPGKQRELVATVDSGGYTNYADSVKGRFTISRDNAKNTVYLQMSSLTPEDTAVYYCYAGIYKWPWSVDARDYWGQGTQVTVSS

SEQ ID NO: 88 - protein, 117 aa, synthetic construct
  REGION 1..117: note = VHH sequence 57B11
QVQLQESGGGLVQAGGSLRLSCAASGSSISMNSMGWYRQAPGKERERVALIRSSGGTYYADSVKGRFTISRDNAKNTVYLQMNNLKPEDTAVYYCQARRTWLSSESWGQGTQVTVSS

SEQ ID NO: 89 - protein, 122 aa, synthetic construct
  REGION 1..122: note = VHH sequence 57C07
QVQLQESGGGLVQAGGSLRLSCAVSGSTFGINTMGWYRQAPEKQRELVASISRGGMTNYADSVKGRFIISRDNAKNTVYLQMNSLKPEDTAVYVCNAGIRSRWYGGPITTYWGQGTQVTVSS

SEQ ID NO: 90 - protein, 121 aa, synthetic construct
  REGION 1..121: note = VHH sequence 57C09
QVQLQESGGGLVQAGGSLRLSCAASGSTGSINAMGWYRQGPGKQRDLVASISSGGATNYADSVKGRFTISRDNSKNTVYLQMSSLKPEDTAVYYCNAKKSRWSWSIVHDYWGQGTQVTVSS

SEQ ID NO: 91 - protein, 118 aa, synthetic construct
  REGION 1..118: note = VHH sequence 57D02
QVQLQESGGGSVQTGGSLTLSCTTSGSIFGRSDMGWYRQAPGKQRELVATITRRSRTNYAEFVKGRFTISRDSAKNLVTLQMNSLKPEDTNVYYCNARWGAGGIFSTWGQGTQVTVSS

SEQ ID NO: 92 - protein, 120 aa, synthetic construct
  REGION 1..120: note = VHH sequence 57D09
QVQLQESGGGLVQPGESLRLSCAASGSMSIDAMGWYRQAPGDQRELVASITTGGSTNYADSVKGRFTISRDNAKNTVWLQMNSLKPEDTAVYYCNAKVRLRWFRPPSDYWGQGTQVTVSS

SEQ ID NO: 93 - protein, 122 aa, synthetic construct
  REGION 1..122: note = VHH sequence 57D10
QVQLQESGGGLVQPGGSLRLSCAASGRLLSISTMGWYRRTPEDQREMVASITKDGTTNYADSVKGRLTISRDNAKNTVYLQMNSLKPDDTAVYVCNARATTWVPYRRDAEFWGQGTQVTVSS

SEQ ID NO: 94 - protein, 120 aa, synthetic construct
  REGION 1..120: note = VHH sequence 57E07
QVQLQESGGGLVQAGGSLRLSCAASGSIFGINDMGWYRQAPGKQRDLVADITRSGSTHYVDSVKGRFTISRDNAKNTVYLQMNSLKPEDTAVYYCNADSGSHWWNRRDYWGQGTQVTVSS

SEQ ID NO: 95 - protein, 118 aa, synthetic construct
  REGION 1..118: note = VHH sequence 57E11
QVQLQESGGGLVQPGGSLKLSCAASGFTFSINTMGWYRQAPGKQRELVARISRLRVTNYADSVKGRFTISRDNAKNTVYLQMNSLKPEDTAVYYCNAANWGLAGNEYWGQGTQVTVSS

SEQ ID NO: 96 - protein, 116 aa, synthetic construct
  REGION 1..116: note = VHH sequence 57G01
QVQLQESGGGLVQAGGSLRPSCTASGSTLLINSMGWYRQAPGKQRELVATISNSGTTNYVDAVKGRFAISRDNANHTVYLQMNSLEPEDTAVYYCNAQTFWRRNYWGQGTQVTVSS

SEQ ID NO: 97 - protein, 116 aa, synthetic construct
  REGION 1..116: note = VHH sequence 57G07
QVQLQESGGGLVQAGGSLRLSCAVSGSTSRINAMGWYRQAPGKKRESVATIRRGGNTKYADSVKGRFTISRDNANNTVYLQLNSLKPEDTAVYYCNAHSWLDYDYWGRGTQVTVSS

SEQ ID NO: 98 - protein, 114 aa, synthetic construct
  REGION 1..114: note = VHH sequence 57G08
QVQLQESGGGLVQAGGSLRLSCASRRRINGITMGWYRQAPGKQRELVATIDIHNSTKYADSVKGRFIISRDNGKSMLYLQMNSLKPEDTAVYYCNRIPTFGRYWGQGTQVTVSS

SEQ ID NO: 99 - protein, 118 aa, synthetic construct
  REGION 1..118: note = VHH sequence 57H08
QVQLQESGGGLVQAGGSLRLSCVASGSTFYTFSTKNVGWYRQAPGKQRELVAQQRYDGSTNYADSLQGRFTISRDNAKRTVYLQMNSLKPEDTAVYICNVNRGFISYWGQGTQVTVSS